(19) United States
(12) Patent Application Publication
(10) Pub. No.: US 2011/0320706 A1
(43) Pub. Date: Dec. 29, 2011

(54) STORAGE APPARATUS AND METHOD FOR CONTROLLING THE SAME

(75) Inventor: Akio Nakajima, Kawasaki (JP)

(73) Assignee: Hitachi, Ltd.

(21) Appl. No.: 12/527,413

(22) PCT Filed: Mar. 12, 2009
(86) PCT No.: PCT/JP09/55372

§ 371 Date: Aug. 14, 2009

(51) Int. Cl. G06F 12/00

(52) U.S. Cl. 711/114; 711/E12.001

(57) ABSTRACT

A storage apparatus capable of improving the reliability of a large-scale storage system, and a method for controlling such a storage apparatus are suggested. A storage apparatus including a storage device for storing data, and a multiplexer for multiplexing a port for the storage device, the multiplexer being connected to one or more host controllers, and a method for controlling such a storage apparatus, wherein the multiplexer judges whether a command sent from the host controller to the storage device is proper or not; and if the command is improper, the multiplexer discards the command without transferring it to the storage device, and sends an error response to the host controller.

### TECHNICAL FIELD

The present invention relates to a storage apparatus and a method for controlling the storage apparatus. The invention is ideal for use in, for example, a storage apparatus mounted on a disk array apparatus with a large-scale back-end topology.

### BACKGROUND ART

In a disk array apparatus, storage devices and components for connecting these storage devices are collectively called “back-end”. In a disk array apparatus, connecting as many storage devices as possible to the back-end is ideal in order to increase the capacity of the apparatus and to improve the performance. Also, reduction of the number of components for controllers in a disk array apparatus is also favorable in order to achieve a low price. Therefore, in recent years, the number of storage devices connected to one controller component of a disk array apparatus has been increasing dramatically.

In recent years, storage apparatuses that use a SAS (Serial Attached SCSI) interface as an interface with a drive connection unit have been commercialized. The SAS is a standard that defines networks and protocol layers where data transfer is possible via the same physical link according to both SSP (Serial SCSI Protocol) using SCSI (Small Computer System Interface) commands and STP (Serial ATA Tunneled Protocol) using SATA (Serial Advanced Technology Attachment) (see, for example, “1697D: AT Attachment-8-Serial Transport (ATA8-AST),” [online], [searched on Dec. 23, 2008], on the Internet at http://www.t13.org/Documents/UploadedDocuments/docs2005/d1697r0c-ATA8-AST.pdf) commands (see, for example, U.S. Patent Application No. 2006/0101171).

Generally, all components in a SAS-compliant disk array apparatus are made redundant. Since such a redundant configuration is employed, even when a failure occurs in any component, the disk array apparatus can continue to process I/O from a host (see, for example, U.S. Pat. No. 7,035,952).

Since the SATA is used on the premise that one hard disk device is connected to one host, a SATA HDD has only one port for connection to the host. Therefore, in order to connect the SATA HDD to a system with a redundant configuration, the standard for expanding one operation port and one standby port by means of a SATA port selector is suggested.

However, one of redundant devices according to the above-described standard is used as a standby device and the host cannot access the port for this standby device. Therefore, in the configuration wherein a SATA HDD is connected to the redundant configuration, a SATA port expansion device called a “SATA Active Multiplexer” having two ports, both of which can operate as operation ports, is being developed (see, for example, U.S. Patent Application No. 2004/0252716 and U.S. Patent Application No. 2005/0186832).

A SAS controller is connected to a SAS expander that is a device expansion switch for connection to a plurality of SAS controllers and a plurality of storage devices. SAS expanders can be connected to each other by means of expansion using a tree-structure topology. Therefore, using a plurality of SAS expanders makes it possible to connect the SAS controller to many storage devices, thus enabling one SAS controller to control many storage devices.

Conventional FC (Fibre Channel) disk array apparatuses generally utilize an FC_AL (FC Arbitrated Loop) topology. In the FC_AL topology, a maximum of 126 FC target devices can be connected to an initiator device. However, according to the SAS standard, the number of target devices to be connected to the initiator device is not limited and, therefore, it is possible to increase the number of target devices that can be controlled by one controller, as compared to the case of the FC.

In order to decrease the number of controller components and increase the number of storage devices in the back-end of a disk array apparatus, it is necessary to configure a large-scale topology for one controller component.

### DISCLOSURE OF THE INVENTION

Since a SATA host and a SATA device are directly linked to each other according to the general SATA standard, the target device for which one SATA host detects a failure and executes necessary processing is limited only to one SATA device. Therefore, it is unnecessary to judge, between the SATA host and the SATA device which are generally directly connected, at which target device a failure has occurred. The SATA host can identify a command that was not completely executed due to the failure, as a timeout of the command. As a result, advanced error processing for detecting and determining an error in the Link layer is not necessary. If the SATA host detects a failure, failure recovery processing can be realized by resetting the only one SATA device to which the SATA host is directly connected.

However, if the above-described failure processing is applied to the SAS topology, there may be a case where the SAS controller cannot identify at which SATA HDD a failure in the link layer has occurred. This is because in the SAS topology a temporary connection is established between the SAS controller and the target device and communications are performed between these devices. Furthermore, if a SAS connection is maintained until a SATA command times out, the SAS controller cannot establish a connection with other normal devices (such as SATA HDDs). Furthermore, the SAS controller cannot send a command to the SAS expander to reset the port for the SAS expander to which a SATA device is connected.

If the connection is terminated after transmission of a write command from the SAS controller to the SATA HDD and then a temporary failure occurs in the link with the SATA HDD, which results in resetting the SATA HDD, the SATA HDD cancels all the commands received from the SAS controller, but the SAS controller cannot identify that all the commands have been canceled. So, the SAS controller establishes a connection with the SATA HDD and transmits write data to the SATA HDD. As a result, the SATA HDD suddenly receives the write data in spite of the cancellation of the write command, and the SATA HDD cannot deal with the situation and then hangs up. When this happens, the SAS controller has a problem of being incapable of accessing other hard disk devices until the frame transfer of write data is completed.

In order to realize a large-scale back-end topology in a disk array apparatus as described above, it is necessary to keep other storage devices of the same topology unaffected by a failure at the time of occurrence of the failure and during execution of the failure processing. However, if the location where the failure occurred cannot be identified, there is a possibility that the range for executing the failure processing may be expanded. If the failure processing that might influence the entire large-scale back-end topology is carried out at the time of occurrence of a failure, processing for an input/output request from the host will stop for a long period of time. Therefore, in order to realize the large-scale back-end topology, it is favorable that the controller can properly identify the failure location at the back end when a failure has occurred.

On the other hand, the conventional disk array apparatuses have a problem of inability to distinguish between the situation where hot-line insertion or removal of a SATA HDD causes a change in the state of link between the SAS expander and the SATA HDD, the situation where the occurrence of some kind of failure in the link between the SAS expander and the SATA HDD causes a change in the link state, the situation where the link is reset in order to discard a command from another redundant device, and the situation where the link is reset in order to discard a command. As a result, what caused a change in the link state cannot be distinguished, whether the controller gave an instruction to change the link state, whether the change was caused by a failure, or whether the change was made by an administrator of the storage apparatus.

Furthermore, a SATA device port does not have a SAS address that is a Port identifier which can be interpreted by the SAS controller. Therefore, conventionally, the SAS expander is equipped with a bridge called “STP/SATA Bridge” for converting an STP port to a SATA port. Since the SAS expander has a SAS address for a STP Target Port, it assigns the identifier of the STP target port to each SATA HDD. As a result, replacement of the SAS expander would cause a change of all the SATA HDD addresses, which makes the SAS address management for devices complicated. Furthermore, if a faulty SATA HDD is replaced with a good SATA HDD, the SATA address will not change; and, therefore, it is impossible to tell whether or not the current SATA HDD is different from the previous SATA HDD only by referring to the SAS address information.

The present invention was devised in light of the above-described circumstances. It is an object of the invention to solve the above-described problems and provide a storage apparatus capable of improving the reliability of a large-scale storage system, and a method for controlling such a storage apparatus.

In order to solve the above-described problems, a storage apparatus according to an aspect of the present invention includes: a storage device for storing data; and a multiplexer for multiplexing a port for the storage device, the multiplexer being connected to one or more host controllers; wherein the multiplexer judges whether a command sent from the host controller to the storage device is proper or not; and if the command is improper, the multiplexer discards the command without transferring it to the storage device and sends to the host controller a response to the error detected by the multiplexer.

Furthermore, according to another aspect of the invention, a method for controlling a storage apparatus including a storage device for storing data, and a multiplexer for multiplexing a port for the storage device, the multiplexer being connected to one or more host controllers, is provided; wherein the storage apparatus control method includes: a first step executed by the multiplexer of judging whether a command sent from the host controller to the storage device is proper or not; and a second step executed by the multiplexer of discarding the command without transferring it to the storage device, and sending an error response from the multiplexer to the host controller if the command is improper.

As a result, by using the storage apparatus according to the present invention as a storage device when constructing a large-scale back-end topology for a storage system, a host controller can easily identify the failure location at the time of occurrence of a failure caused by inconsistency between the state of the host controller and the state of the storage apparatus.

According to the present invention, it is possible to expedite the processing for dealing with the situation where a failure caused by state inconsistency between the host controller and the storage apparatus has occurred, and to keep the affected range of the failure as small as possible. Therefore, it is possible to prevent the occurrence of a situation where the processing for an input/output request from the host is stopped for a long period of time. As a result, the reliability of the large-scale storage system can be improved.

### BRIEF DESCRIPTION OF THE DRAWINGS

FIG. 1 is a block diagram illustrating the entire configuration of a host system according to the first embodiment.

FIG. 2 is a block diagram illustrating the configuration of a SATA canister.

FIG. 3 is a block diagram illustrating the configuration of an STP active multiplexer.

FIG. 4 is a block diagram illustrating the configuration of an STP target port.

FIG. 5 is a block diagram illustrating the configuration of a SATA port.

FIG. 6 is a block diagram illustrating the configuration of a control block.

FIG. 7 is a block diagram illustrating the configuration of an STP target upper layer.

FIG. 8 is a block diagram illustrating the configuration of a SATA Host Upper Layer.

FIG. 9 is a block diagram illustrating the configuration of a multiplexer controller block.

FIG. 10 is a schematic diagram illustrating the configuration of a host command queue.

FIG. 11 is a schematic diagram illustrating the configuration of a SATA address table.

FIG. 12 is a diagram illustrating the frame format of an error response FIS.

FIG. 13 is a schematic diagram illustrating the configuration of a port status table.

FIG. 14 is a schematic diagram illustrating a state machine of the link state of the STP active multiplexer.

FIG. 15 is a flowchart illustrating a processing sequence for port state monitoring processing.

FIG. 16A is a flowchart illustrating a processing sequence executed when a SATA FIS is transferred from a SAS controller to an STP active multiplexer.

FIG. 16B is a flowchart illustrating a processing sequence for FIS reception processing.

FIG. 16C is a flowchart illustrating a processing sequence for FIS analysis/transfer processing.

FIG. 17A is a flowchart illustrating a processing sequence executed when a SATA FIS is transferred from a SATA HDD or the STP active multiplexer to the SAS controller.

FIG. 17B is a flowchart illustrating a processing sequence for FIS transfer preparation processing.

FIG. 17C is a flowchart illustrating a processing sequence for FIS transfer processing.

FIG. 18 is a flowchart illustrating a processing sequence for recovering from link-down during FIS transfer.

FIG. 19 is a flowchart illustrating a processing sequence for the link-down recovery processing executed when a connection is not established yet.

FIG. 20 is a ladder chart illustrating a flow of read sequence.

FIG. 21 is a ladder chart illustrating a flow of write sequence.

FIG. 22 is a ladder chart illustrating a processing sequence executed when the link-down occurs at the SATA port during execution of the write sequence.

FIG. 23 is a ladder chart illustrating a processing sequence executed when the link-down occurs at the STP target port during execution of the FIS transfer sequence.

FIG. 24 is a ladder chart illustrating a processing sequence executed when the link-down occurs at the STP target port while the STP active multiplexer is in a connection idle state.

FIG. 25 is a ladder chart illustrating a processing sequence executed when the link-down occurs at the STP target port while the STP active multiplexer is in the connection idle state.

FIG. 26 is a ladder chart illustrating a processing sequence executed when the STP active multiplexer performs hard reset.

FIG. 27 is a ladder chart illustrating a processing sequence executed when the SATA canister or the SAS expander is replaced.

FIG. 28 is a ladder chart illustrating a processing sequence for spinup control of the SATA HDD.

FIG. 29 is a ladder chart illustrating a processing sequence executed when the SAS address table lacks resources.

FIG. 30 is a ladder chart illustrating a processing sequence executed when a failure occurs between the SAS controller and a SAS expander 130.

FIG. 31 is a ladder chart illustrating a processing sequence executed when a host driver issues a soft reset command.

FIG. 32 is a ladder chart illustrating a processing sequence executed when the STP target port receives a power control signal from the SAS expander.

FIG. 33 is a block diagram illustrating the configuration of an STP target upper layer according to the second embodiment.

FIG. 34 is a block diagram illustrating the configuration of a SATA Host Upper Layer according to the second embodiment.

FIG. 35 is a ladder chart illustrating a flow of read sequence using a data buffer according to the second embodiment.

FIG. 36 is a ladder chart illustrating a flow of write sequence using the data buffer according to the second embodiment.

FIG. 37 is a block diagram describing another embodiment.

FIG. 38 is a block diagram describing another embodiment.

FIG. 39 is a block diagram describing another embodiment.

FIG. 40 is a chart describing specific examples of Additional Sense Codes.

### BEST MODE FOR CARRYING OUT THE INVENTION

Embodiments of the present invention will be explained below in detail with reference to the attached drawings.

### (1) First Embodiment

### (1-1) Configuration of Host System According to First Embodiment

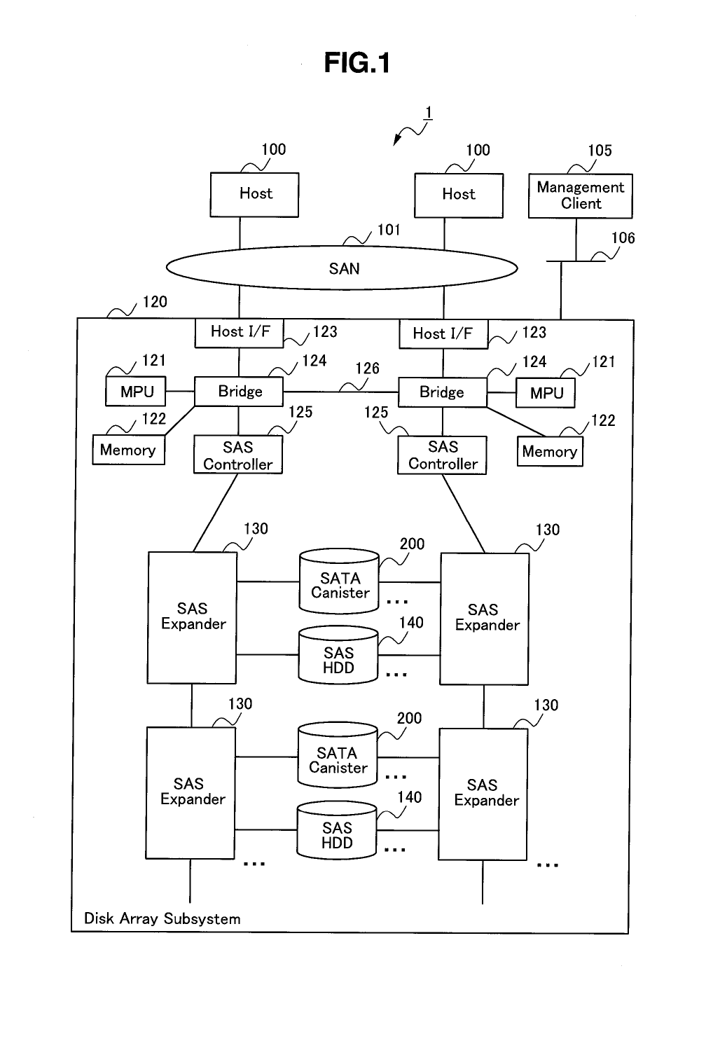

In FIG. 1, reference numeral “1” represents a host system as a whole according to the first embodiment of the present invention. The host system 1 is composed of a plurality of hosts 100, a disk array apparatus 120, and an management client 105.

The host 100 is a computer device equipped with a CPU (Central Processing Unit) and information processing resources such as memory, and is composed of, for example, a personal computer, a workstation, or a main frame. The host 100 is equipped with information input devices (not shown in the drawing) such as a keyboard, a switch, a pointing device and/or a microphone, and information output devices (not shown in the drawing) such as a monitor display or a speaker, and is connected via a SAN (Storage Area Network) 101 to the disk array apparatus 120.

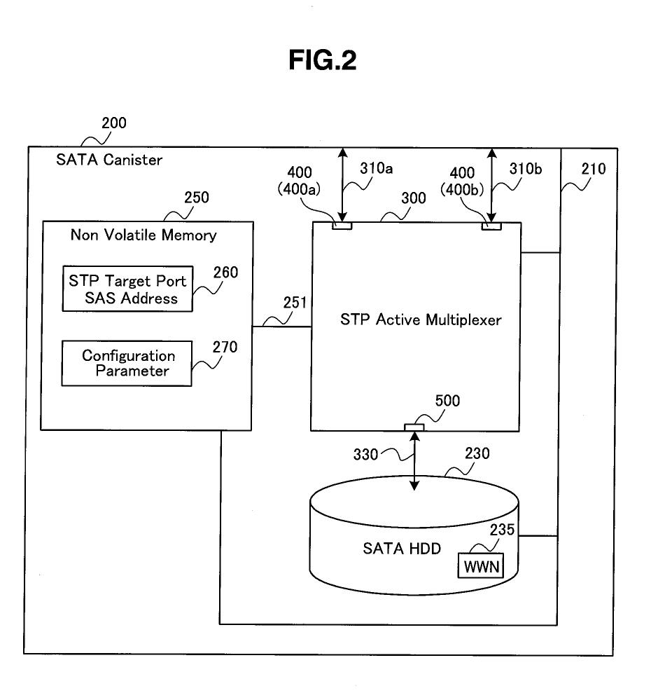

The disk array apparatus 120 is composed of various redundant components such as host interfaces 123, MPUs (Micro Processing Units), 121, memories 122, bridges 124, SAS controllers 125, and SAS expanders 130, as well as a plurality of storage devices 140, 230 (FIG. 2).

The host interface 123 serves as a communication interface for communications with the host 100 and executes processing for converting the format of data and commands sent or received via the SAN 101 to or from the host 100.

The MPU 121 is a processor for controlling data input/output (write access or read access) to/from the storage devices 140, 230 in response to a data input/output request from the host 100; and the MPU 121 controls, for example, the host interface 123, the bridge 124, and the SAS controller 125 by executing microprograms stored in the memory 122.

The memory 122 is used to store, for example, microprograms and control information and temporarily store commands, data, and end responses transferred between the host interface 123 and the SAS controller 125. Also, the memory 122 is used to store a configuration information table that stores a connection relationship with the SAS expanders 130 or the storage devices 140 which are connected under the control of the SAS controller 125, as well as a correspondence relationship between SAS addresses.

The bridge 124 controls data transfer between the host interface 123 and the SAS controller 125 under the control of the MPU 121. The bridge 124 is connected via a bus 126 to the other redundant bridge 124, so that commands and data can be exchanged between the two redundant MPUs 121 via the bridge 124 and the bus 126.

The SAS controller 125 includes: one or more SSP initiators for controlling SCSI commands; and one or more SMP (Serial Management Protocol) for controlling commands to give instructions to the STP initiators and the SAS expanders that control SATA commands.

Each port for the SAS controller 125 is given a SAS address. The SAS address is a Port Identifier used by each protocol initiator port for the SAS controller 125 to specify a Source Port and a Destination Port when transferring frames to the target port. A WWN (World Wide Name) is generally used as this SAS address. The WWN is a unique identifier so that the same WWN is not given to different device ports.

The SAS controller 125 is connected to one or more SAS expanders 130. The SAS expander 130 is a device extended switch for connecting one SAS controller 125 to a plurality of storage devices 140, 230. This SAS expander 130 can be connected to other SAS expanders 130 by means of expansion in a tree-structure topology. As a result, one SAS controller 125 can control many storage devices 140, 230 via a plurality of SAS expanders 130.

There are two types of storage devices 140 and 230 to be connected to the SAS expanders 130: SAS HDDs 140 described below and SATA HDDs 230 described below.

The SAS HDD 140 has two SSP target ports, each of which is connected to one of the two redundant SAS expanders 130 so that one SSP target port is connected to one SAS expander 130, while the other SSP target port is connected to the other SAS expander 130. These two SSP target ports are given separate SAS addresses, respectively. The SAS HDDs 140 are controlled by the SAS controller 125 in accordance with SCSI commands.

On the other hand, each SATA HDD 230 has only one SATA port as described above, so it is necessary to expand this one SATA port to two SATA ports when making the components such as the SAS controller 125 redundant. Therefore, in the case of this embodiment, the port for the SATA HDD 230 is expanded by a SATA canister 200 to two ports.

### (1-2) Configuration of SATA Canister

### (1-2-1) Internal Configuration of SATA Canister

Each SATA canister 200 is composed of an STP active multiplexer 300, a nonvolatile memory 250, and a SATA HDD 230 as shown in FIG. 2. Power is supplied from a power source (not shown in the drawing) via a power supply line 210 to the STP active multiplexer 300, the nonvolatile memory 250, and the SATA HDD 230.

The STP active multiplexer 300 has two STP target ports 400 (400a, 400b), and these two STP target ports 400 are connected via a SAS link 310a or 310b to different SAS expanders 130, respectively. Also, the STP active multiplexer 300 has one SATA port 500, and this SATA port 500 is connected via a SATA link 330 to the SATA HDD 230.

The nonvolatile memory 250 stores SAS addresses 260, each of which is set to each STP target port 400 for the STP active multiplexer 300, and a configuration parameter 270 for the STP active multiplexer 300. This nonvolatile memory 250 is connected via a memory bus 251 to the STP active multiplexer 300.

The SATA HDD 230 stores a WWN 235 that is an identifier of the SATA HDD 230. This WWN 235 is a unique address as a device and/or port identifier.

### (1-2-2) Configuration of STP Active Multiplexer 300

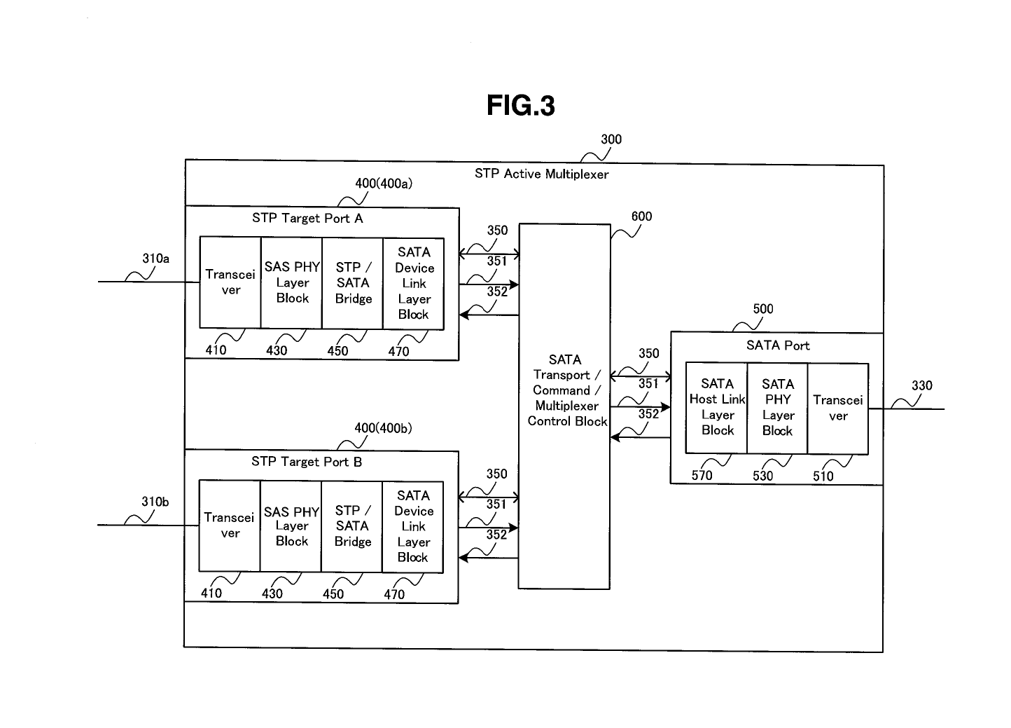

The STP active multiplexer 300, as shown in FIG. 3, includes two STP target ports 400 (400a, 400b), one SATA port 500, and a control block (SATA Transport/Command/Multiplexer Control Block) 600. Each STP target port 400 and the SATA port 500 are respectively connected to the control block 600 via three buses (control bus 350, data bus 351, and data bus 352).

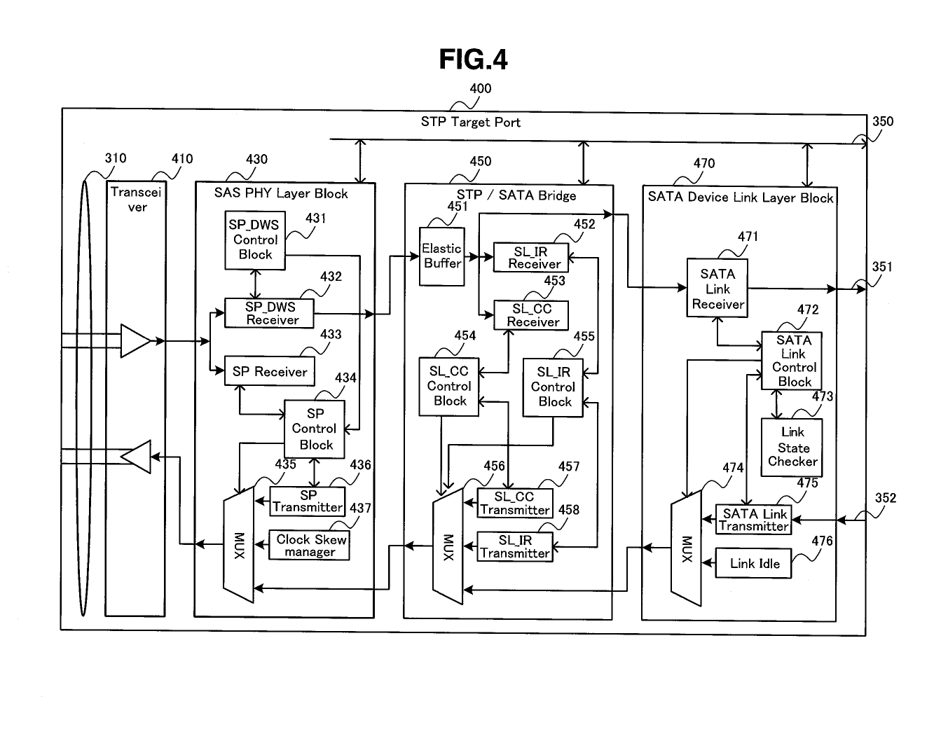

The STP target port 400, as shown in FIG. 4, includes a transceiver 410, a SAS Phy Layer Block 430, an STP/SATA Bridge 450, and a SATA Device Link Layer Block 470. These blocks are connected bidirectionally to each other via a data bus. Also, the SAS Phy Layer Block 430, the STP/SATA Bridge 450, and the SATA Device Link Layer Block 470 are connected to the control bus 350.

The transceiver 410 is an analog circuit equipped with a serializer/deserializer for serial transfer according to the SAS protocol and internal parallel transfer. Specifically speaking, the transceiver 410 performs parallel conversion of, for example, commands and host data received from the SAS controller 125 (FIG. 1) via the SAS expander 130 (FIG. 1) and then transfers the converted commands and data to the SAS Phy Layer Block (hereinafter referred to as the “SP block”) 430, while the transceiver 410 performs serial conversion of, for example, commands and host data received from the SP block 430 and then transfers the converted commands and data via the SAS expander 130 to the SAS controller 125.

The SP block 430 is a block that sends and receives signals to and from another SP layer block, using a low-speed signal called “Out of Band (OOB) signal” (hereinafter referred to as the “OOB signal”). The SP block 430 includes: an SP_DWS (SAS Phy Double Word Synchronization) control block 431 and an SP control block 434 as a control circuit for controlling a SAS Phy Layer; and an SP_DWS receiver 432, an SP receiver 433, a multiplexer 435, an SP transmitter 436, and a clock skew manager 437 as a transmission/reception circuit.

The SP_DWS receiver 432 and the SP receiver 433 process signals transmitted by the transceiver 410. The multiplexer 435 is a selector circuit for selecting one signal from signals sent respectively from the SP transmitter 436, the clock skew manager 437, and the STP/SATA Bridge 450, and sends the selected signal to the transceiver 410. This multiplexer 345 is controlled by SP control block 434.

Incidentally, the OOB signal is a signal necessary for a SAS link reset sequence. The link reset sequence is a sequence for exchanging necessary information to establish a physical link to connect two SAS Phys (to enter the “Phy Ready” state), and is composed of three phases: an OOB sequence, a Speed Negotiation sequence, and an Identification sequence.

The OOB sequence is a sequence for judging whether the opponent device is a SAS device or a SATA device. The Speed Negotiation sequence is a sequence following the OOB sequence, for selecting the highest Link Rate, at which a physical link can be established between the initiator and the target device, and controlling the transmission and reception of information about, for example, whether SSC (Spectrum Spread Clocking) can be supported or not. Furthermore, the Identification sequence is a sequence following the Speed Negotiation sequence, for sending and receiving Identify frames and exchanging attribute information (such as SAS port initiator/target types) and information such as SAS addresses of the initiator and the target device.

The SP control block 434, the SP receiver 433, and the SP transmitter 436 are blocks that control the SAS OOB sequence and Speed Negotiation sequence.

The SP_DWS receiver 432 and the SP_DWS control block 431 are synchronous circuits for detecting appropriate DW (Data Word), and transfers the DW to the upper layer.

The STP/SATA Bridge 450 has a function controlling the SAS address for the STP target port 400 and a connection between the source port and the destination port, and includes an Elastic Buffer 451, an SL_IR (SAS Link layer Identification and hard Reset) receiver 452, an SL_CC (SAS Link layer Connection Control) receiver 453, an SL_CC control block 454, an SL_IR control block 455, a multiplexer 456, an SL_CC transmitter 457, and an SL_IR transmitter 458.

The SL_CC receiver 453 and the SL_IR receiver 452 process signals sent from the SP block 430. The multiplexer 456 is a selector circuit for selecting one signal from signals sent from the SL_CC transmitter 457, the SL_IR transmitter 458, and the SATA Device Link Layer Block 470 and sending the selected signal to the SP block 430. This multiplexer 456 is controlled by the SL_CC control block 454 and the SL IR control block 455.

The Elastic Buffer 451 is used as a buffer to absorb a difference between a clock on the serial transfer side and a clock for the internal circuit and thereby synchronize them.

The SL_IR receiver 452, the SL_IR control block 455, and the SL_IR transmitter 458 serve as a control circuit for processing the Identification sequence in the SAS link reset sequence. When the SL_IR transmitter 458 sends an Identify frame to the connected SAS expander 130, the SAS expander 130 registers connected device information based on information contained in the Identify frame. The connected device information registered with the SAS expander 130 is used in a device search process described later. The SL_IR receiver 452 receives Identify frames from the SAS expander and a HARD_RESET primitive and notifies the SL_IR control block 455 of such reception. If the STP active multiplexer 300 receives a HARD_RESET primitive before completion of the Identification sequence of the SAS link reset sequence, it performs hard reset. When the STP active multiplexer 300 performs the hard reset, various pieces of information in the STP active multiplexer 300 are reset and the state of the SATA HDD 230 connected to the SATA port is reset by carrying out reset or soft reset of the link with the SATA HDD 230.

The SL_CC receiver 453, the SL_CC control block 454, and the SL_CC transmitter 457 serve as a control circuit for determining, establishing or terminating a SAS connection by sending/receiving a connection request to/from the STP initiator port for the SAS controller 125. There are two types of SAS connections: a connection in a connection request sending direction and a connection request receiving direction.

When the SL_CC receiver 453 receives a connection request (OPEN address frame) from the SAS controller, the SL_CC control block 454 judges whether a connection should be established or rejected. If the SL_CC control block 454 permits establishment of the connection, the SL_CC transmitter 457 returns an OPEN ACCEPT primitive to the SAS controller 125. As a result, the STP target port 400 informs the STP initiator port that a connection has been established. If the SL_CC control block 454 receives an improper connection request, the SL_CC transmitter 457 returns an OPEN_REJECT primitive corresponding to the content of the frame to the SAS controller 125. As a result, the STP target port 400 informs the STP initiator port that the connection request has been rejected.

When the STP target port 400 is to establish a connection with the SAS controller 125 in accordance with a SATA FIS (SATA Frame Information Structure) transfer request instruction from the SATA Device Link Layer Block 470, the SL_CC control block 454 first gives an instruction to send a connection request (OPEN address frame) to the SL_CC transmitter 457. Subsequently, when the SL_CC transmitter 457 sends a connection request to the STP initiator port for the SAS controller 125, the STP initiator port for the SAS controller 125 returns a connection response. If the STP initiator port for the SAS controller 125 returns an OPEN_ACCEPT as a connection response, a connection will be established between the STP target port 400 and the SAS controller 125. On the other hand, if the STP initiator port for the SAS controller 125 returns an OPEN_REJECT as a connection response, a connection will not be established. The SL_CC control block 454 judges whether retry should be performed or error processing should be executed, depending on the type of the OPEN_REJECT received from the SAS controller 125.

If the SAS connection is established, the SATA Device Link Layer Block 470 which is the layer for frame transfer executes frame transfer processing. After completion of the SATA FIS transfer request from the SATA Device Link Layer Block 470, the SL_CC control block 454 terminates the established connection by receiving or sending a CLOSE primitive.

The SATA Device Link Layer Block 470 includes a circuit for controlling reception/transmission of SATA frames, and this circuit is composed of a SATA link receiver 471, a SATA link control block 472, a link state checker 473, a multiplexer 474, and a SATA link transmitter 475.

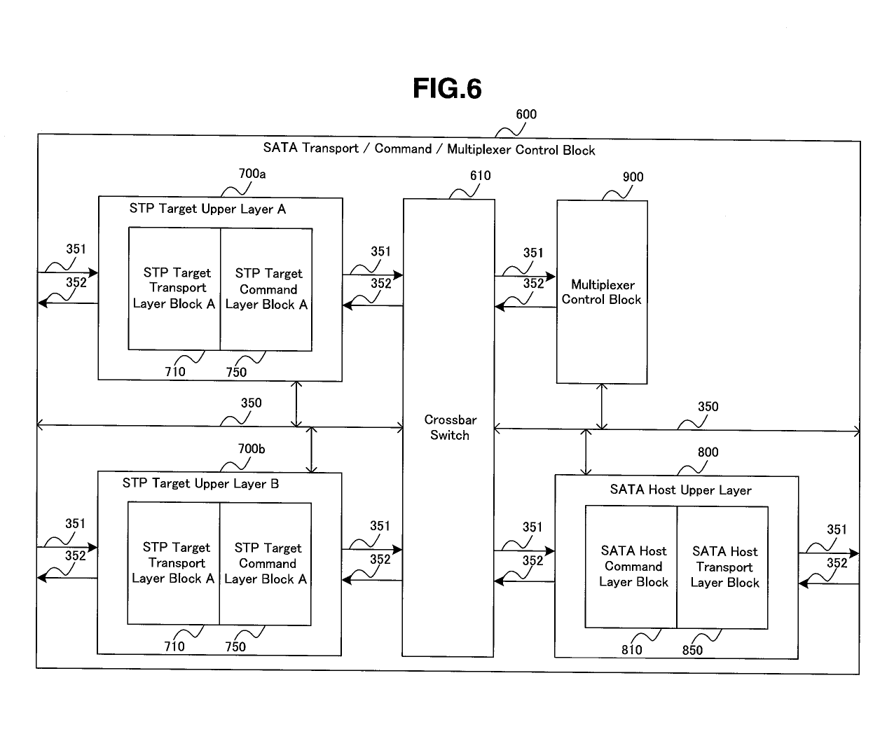

The SATA link receiver 471 processes signals sent from the STP/SATA Bridge 450. The multiplexer 474 is a selector circuit for selecting one signal from signals sent from the SATA link transmitter 475, a link idle 476, and a SATA protocol upper layer control block described later with reference to FIG. 6 and other following drawings, and sends the selected signal to the STP/SATA Bridge 450. This multiplexer 474 is controlled by the SATA link control block 472.

The SATA Device Link Layer Block 470 is a block for controlling the link layer defined in the above-mentioned reference document “1697D: AT Attachment-8-Serial Transport (ATA8-AST),” p 128-146 [online], [searched on Dec. 23, 2008], on the Internet at http://www.t13.org/Documents/UploadedDocuments/docs2005/d1697r0c-ATA8-AST.pdf. The SATA link layer is a layer for sending or receiving a SATA FIS (SATA Frame Information Structure). The SATA FIS is a frame structure including a SOF (Start Of Frame), Data DW, flow control, CRC (Cycle Redundancy Check) that is a footer for checking consistency of the Data DW, and EOF (End Of Frame). The SATA FIS will be hereinafter simply referred to as the “frame.”

The case where the STP target port 400 receives a SATA frame will be described below. The SAS controller 125 first issues a connection request, and the STP/SATA Bridge 450 returns a connection response about establishment of the connection to the SAS controller 125. Next, the SATA link receiver 471 for the SATA Device Link Layer Block 470 receives a SATA FIS from the STP initiator for the SAS controller 125. The SATA device link control block 472 controls the reception of SATA FIS by the SATA link receiver 471. The SATA Link control block 472 transfers the Data DW received by the SATA link receiver 471 to the SATA protocol upper layer control block described in FIG. 6 and other following drawings.

Next, the case where the STP target port 400 sends a SATA frame will be described below. The SATA Device Link Layer Block 470 first receives a Data DW from the SATA protocol upper layer control block described with reference to FIG. 6 and other following drawings. the SATA link control block 472 controls the STP/SATA Bridge 450 according to the instruction from the control block for the upper layer, and the STP/SATA Bridge 450 issues a connection request to the SAS controller 125. When a connection is established between the STP/SATA Bridge 450 and the SAS controller 125, the SATA link transmitter 475 generates a SATA FIS from the Data DW received, and transfers the SAT FIS to the STP initiator port for the SAS controller 125. After the SATA FIS transfer is completed, the SATA link control block 472 gives an instruction the STP/SATA Bridge 450 to terminate the connection between the STP/SATA Bridge 450 and the SAS controller 125.

The link idle 476 is a block for sending to the SAS controller 125 a SYNC primitive before and after the SATA FIS transmission. The link idle 476 transfers the SYNC primitive to the SAS controller immediately after establishment of the connection and at the time of termination of the connection after completing the SATA FIS transfer.

The link state checker 473 is a control circuit for monitoring the state of the SATA link control block 472. While a SATA FIS is sent and received between the SAS controller 125 and the STP target port 400, the link state checker 473 detects protocol violations between the STP initiator port for the SAS controller 125 and the STP target port 400.

Representative examples of the protocol violations detected by the link state checker 473 will be described below. The first example is the case where a hand shake is not performed in accordance with a sequence for transferring a SATA FIS and another primitive is received. In this case, the state transition is made and then the same state continues longer than the specified period of time, and the state transition to another sequence is not conducted within the set timeout time, so that the SATA FIS transfer is not completed within the set timeout time. The second example is the case where after the SATA link control block 472 gives whatever instruction to its upper layer, no response to the instruction is made from the upper layer within the specified period of time, which results in time-out. The third example is the case where while a connection between the SAS controller 125 and the STP target port 400 is established, the state transition is made to the state different from that expected by the SAS controller 125 or the STP target port 400, which results in the situation where both of them cannot issue a connection termination request and, therefore, the established connection cannot be terminated.

The link state checker 473 is a mechanism for detecting and thereby avoiding the problems described in the above examples. The link state checker 473 gives an instruction to the STP/SATA Bridge 450 to report an error to the upper layer described later with reference to FIG. 6 and other following drawings and to carry out forced termination of the connection so that the SAS controller 125 can identify the occurrence of the error.

The above-described example includes possible errors other than those which may occur in the processing selected for the link layer according to the SATA protocol as described in the aforementioned reference document “1697D: AT Attachment-8-Serial Transport (ATA8-AST),” p 128-146, [online], [searched on Dec. 23, 2008], on the internet at http://www.t13.org/Documents/UploadedDocuments/docs2005/d1697r0c-ATA8-AST.pdf. This is because a SATA host and a SATA device are connected to each other via a direct link according to the general SATA standard, so that the error range is limited to one STA device. As a result, regarding the general configuration where the SATA host and the SATA device are directly attached to each other, the SATA host is not required to promptly identify an error in the link layer or the transport layer; and it is only necessary to reset one SATA device when a command time-out is found.

However, if the above-described failure processing is applied, like in this embodiment, according to the SAS topology, there may be a case where the SAS controller 125 cannot promptly identify at which SATA HDD 230 a failure in the link layer or the transport layer has occurred. Furthermore, if the SAS connection is maintained until the SATA command times out, the SAS controller 125 cannot establish a connection with other normal devices. What is more, the SAS controller 125 cannot send to the SAS expander 130 a command to reset the port for the SAS expander 130 to which the SATA device is connected.

Therefore, it is necessary to expand the error identification range in the SATA protocol link layer and carry out an error check that will be completed within the time-out time that is set from the start of frame transfer to the end of the frame transfer, so that the connection between the SAS controller and the SATA device would not be maintained for an improperly long period of time.

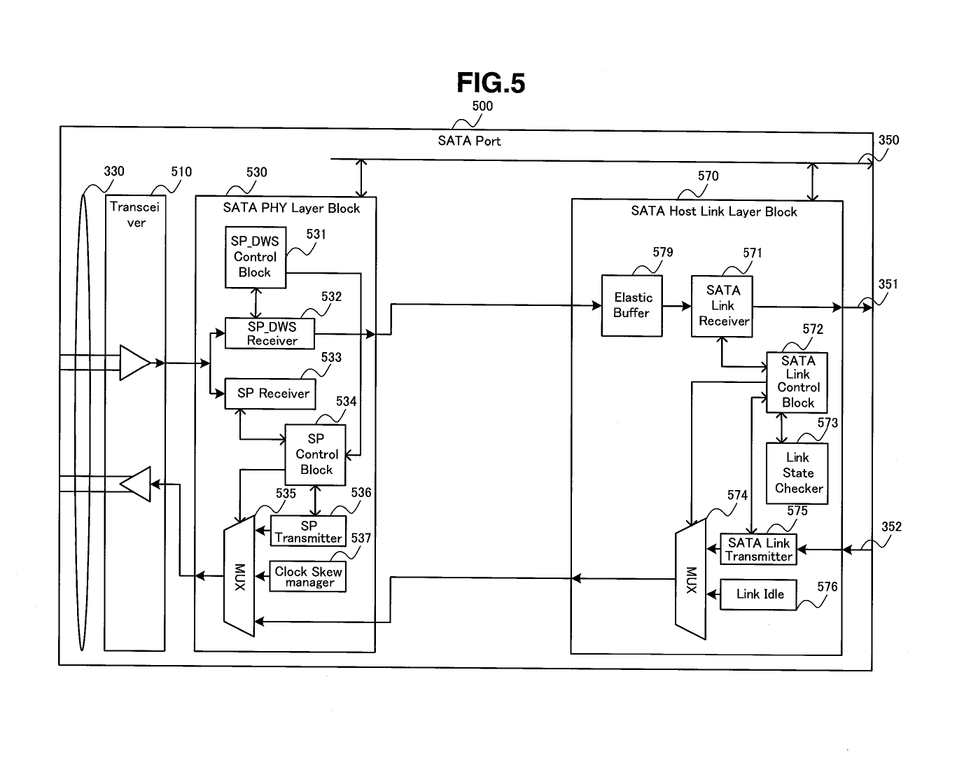

Now, FIG. 5 is a diagram illustrating internal blocks of the SATA port 500 that is a port connected to the SATA HDD 230.

The SATA port 500 includes a transceiver 510, a SATA Phy Layer Block 530, and a SATA Host Link Layer block 570. Since the SATA port 500 does not need to be connected to a SAS device, it is configured like the configuration of the STP target port 400 without the STP/SATA Bridge 450.

The transceiver 510, the SATA Phy Layer Block 530, and the SATA Host Link Layer block 570 correspond to the transceiver 410, the SAS Phy Layer Block 430, and the SATA Device Link Layer Block 470, respectively.

The SATA Phy Layer Block 530 may have the same functions as those of the SP block 430. Alternatively, since the SATA Phy Layer Block 530 does not need to be connected to a SAS device, the SATA Phy Layer Block 530 may be configured so that it can send or receive only the OOB signal which can be identified by a SATA device.

The SATA Host Link Layer block 570 is configured by adding an Elastic Buffer 579 to the SATA Device Link Layer Block 470 for the STP target port 400 as described with reference to FIG. 4.

Other internal blocks for the SATA Phy Layer Block 530 and the SATA Host Link Layer block 570 have the same functions as those of the SAS Phy Layer Block 430 and the SATA Device Link Layer Block 470, and any detailed description of them has been omitted.

Now, FIG. 6 shows the internal configuration of the control block 600. The control block 600 includes two STP Target Upper Layers 700, a SATA Host Upper Layer 800, and a multiplexer controller block 900, and a crossbar switch 610. The STP Target Upper Layers 700, SATA Host Upper Layer 800, and multiplexer controller block 900 are respectively connected to the crossbar switch 610 via the control bus 350, the data bus 351, and the data bus 352.

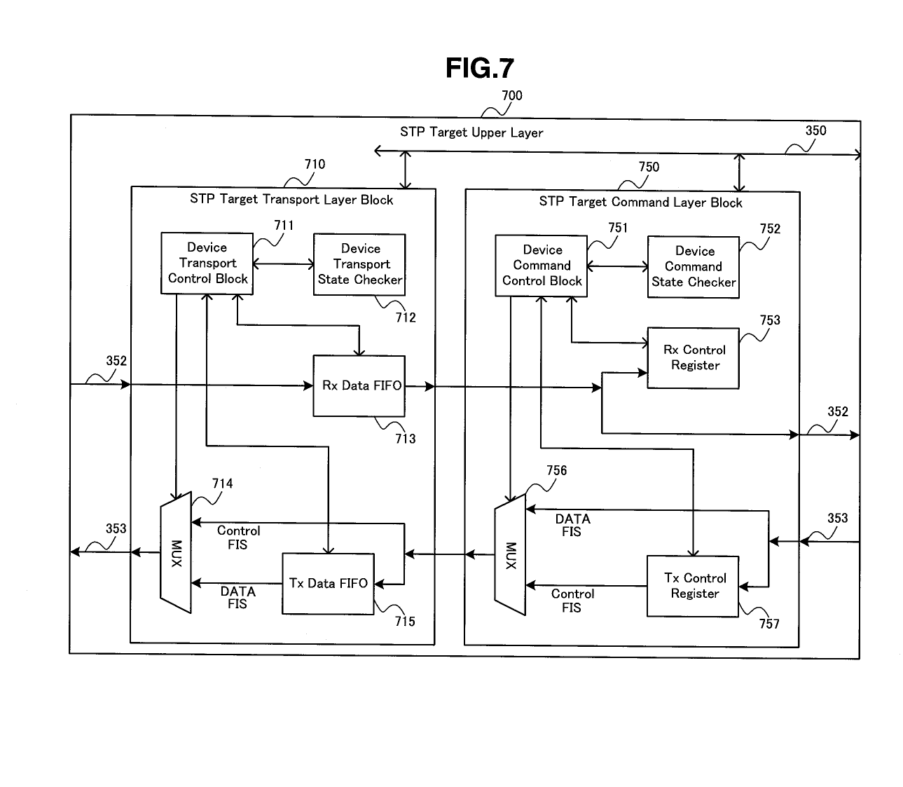

As shown in FIG. 7, the STP Target Upper Layer 700 includes an STP Target Transport Layer Block 710 and an STP Target Command Layer Block 750.

The STP Target Transport Layer Block 710 is a block for controlling the transport layer in the SATA target port 400. This STP Target Transport Layer Block 710 includes a Device Transport control block 711, a Device Transport state checker 712, an Rx data FIFO 713, a multiplexer 714, and a Tx data FIFO 715.

The Device Transport control block 711 identifies the FIS type of a SATA FIS sent or received and controls the transmission or reception of the SATA FIS between the SAS controller 125 and the STP active multiplexer 300. For example, the STP active multiplexer 300 sends to the SAS controller 125 a DMA_SETUP that represents a request for transfer by means of DMA (Direct Memory Access), one of SATA-standard transfer protocols. Also, the STP active multiplexer 300 sends to the SAS controller a DMA_ACTIVATE FIS for requesting the transmission of a Write DATA FIS. Furthermore, the STP active multiplexer 300 receives a Read Data FIS from the SAS controller. For the above-described transmission and reception of SATA FIS, the order of transmission and reception is set depending on the FIS types, and the Device Transport control block 711 is a block for controlling the transmission and reception of SATA FIS in accordance with the proper transfer control according to the SATA standard.

The Device Transport state checker 712 is a control circuit for monitoring the state of the Device Transport control block 711. The Device Transport state checker 712 performs the same error processing as that specified according to the SATA standard and further checks the case where a SATA FIS is received in an improper transfer order. If the Device Transport state checker 712 receives an improper FIS Type, it discards the SATA FIS and reports it to the upper layer to that effect. The Device Transport state checker 712 reports the error to the upper layer and then reports an error response to the SAS controller 125, using a control program 913 described later in detail so that the SAS controller 125 can promptly detect the occurrence of the error. If the SATA FIS transfer ends abnormally as notified by the error report from the SATA Device Link Layer Block 470, the Device Transport state checker 712 stops the SATA FIS transfer processing. In this way, the relevant SATA HDD is prevented from falling into the state of contradictory control and the operation of the SATA HDD is prevented from hanging up.

The Rx data FIFO 713 and the Tx data FIFO 715 are used to temporarily store all or part of SATA DATA FIS. The multiplexer 714 is a selector for selecting a DATA FIS and a control FIS. This multiplexer 714 is controlled by the Device Transport control block 711.

The STP Target Command Layer Block 750 is a block for controlling the command layer at the SATA target port 400. The SATA protocol command layer described in the aforementioned reference document “1697D: AT Attachment-8-Serial Transport (ATA8-AST),” p 128-146 and p 170-234, [online], [searched on Dec. 23, 2008], on the internet at http://www.t13.org/Documents/UploadedDocuments/docs2005/d1697r0c-ATA8-AST.pdf, is a layer for controlling a series of sequences (command reception, handshake for data transmission, and response transmission) necessary to process one command. This block includes a device command control block 751, a device command state checker 752, an Rx control register 753, a multiplexer 756, and a Tx control register 757.

The device command state checker 752 is a control circuit for monitoring the state of the device command control block 751.

The SATA protocol defines a Non-Data Transfer Protocol, a PIO transfer protocol (Processor 10 transfer Protocol), a DMA transfer protocol (Direct Memory Access Transfer Protocol), an FPDMA transfer protocol (FirST Party DMA transfer Protocol), and a soft reset protocol. According to any protocol, control register transfer and data transfer are implemented by means of handshakes between the SAS controller 125 and the SATA device. Depending on the direction of SATA FIS transfer between the SAS controller 125 and the SATA device, there are a case where the SAS controller 125 issues a connection request, and a case where the STP target port 400 issues a connection request. Therefore, in one sequence of command processing, the SAS controller 125 or the STP target port 400 establishes and terminates a plurality of connections.

After a SATA FIS is sent and received between the SAS controller 125 and the STP target port 400, the connection is terminated in order for the SAS controller 125 to switch the connection to another device port. If a failure occurs before a connection is established again between the same SAS controller 125 and the same STP target port 400, inconsistency between the state of the SAS controller 125 and the state of the STP target port 400 might have occurred.

As an example, the case where after the SATA drive sends a DMA_ACTIVATE FIS to the SAS controller 125, the SATA drive is reset and all the commands queued in the SATA drive are discarded will be considered below.

After the reset of the SATA HDD 230 is completed, the SATA HDD 230 returns to the state capable of receiving a command. However, the SAS controller 125 is not informed that the SATA HDD 230 has been reset. Therefore, despite the fact that the commands queued in the SATA HDD 230 have been discarded by resetting SATA HDD 230, the SAS controller 125 transmits write data to the SATA HDD 230.

If the SAS controller 125 transmits the write data to the SATA HDD 230 under the above-described condition of state inconsistency, the transport layer for the SATA HDD 230 attempts to prepare a buffer for storing the write data, but fails to do so because the relevant command does not exist. No consideration is given to such a failure regarding the SATA protocol transport layer described in the aforementioned reference document “1697D: AT Attachment-8-Serial Transport (ATA8-AST),” p 170-234, [online], [searched on Dec. 23, 2008], on the Internet at http://www.t13.org/Documents/UploadedDocuments/docs2005/d1697r0c-ATA8-AST.pdf, and the SATA protocol transport layer continues to wait until the buffer is ready.

If this problem occurs, the buffer for storing the write data cannot be prepared. Therefore, the reception of the write data is stopped in the link layer by sending a SATA_HOLD primitive for flow control. Since the buffer is not prepared and the SATA_HOLD primitive is sent to the SAS controller 125, both the SAS controller 125 and the STP target port 400 cannot terminate the connection.

If the event of resetting the SATA HDD 230 takes place at the above-described point in time during execution of the write data transfer control, inconsistency between the state of the SATA host (SAS controller 125 in this example) and the state of SATA HDD 230 occurs. However, when the SATA host and the SATA HDD 230 are directly attached to each other, if the SATA HDD 230 is reset due to a failure in the link between the SATA HDD 230 and the SATA host, the SATA host can detect the reset of the SATA HDD 230 by detecting the failure in the link. Therefore, when the SATA host and the SATA HDD 230 are directly attached to each other, the state inconsistency does not occur between the SATA host and the SATA HDD 230. As a result, in the configuration where one SATA host is connected to one SATA HDD 230, the failure detection capability of the program controlling the SATA host can be simplified. As described above, the error detection and the error processing are performed according to the SATA protocol on the condition that the SATA host and the SATA HDD 230 are Directly Attached to each other.

The device command state checker 752 is a mechanism for monitoring the protocol status in order to prevent the occurrence of a deadlock state where the same state continues and the transition to the next expected state cannot be made as described above. Furthermore, if the device command state checker 752 receives an improper SATA FIS type which is not expected in a certain state, the device command state checker 752 is a mechanism for communicating with and controlling the blocks in each layer (the SP block 430, the STP/SATA Bridge 450, the STP Target Transport Layer Block 710, and the STP Target Command Layer Block 750) not to transfer the improper SATA FIS to the SATA HDD 230.

The Rx control register 753 and the Tx control register 757 are registers for storing control FISs other than the DATA FIS type. The Rx control register 753, which is a receiving-end register, stores Command FIS (including Soft Reset). The Tx control register 757, which is a transmitting-end register, stores Response FIS, SET_DEVICE_BIT FIS, DMA_SETUP FIS, DMA_ACTIVATE FIS, and PIO_SETUP FIS.

The multiplexer 756 is a selector for selecting the DATA FIS and the control FIS. This multiplexer 756 is controlled by the device command control block 751.

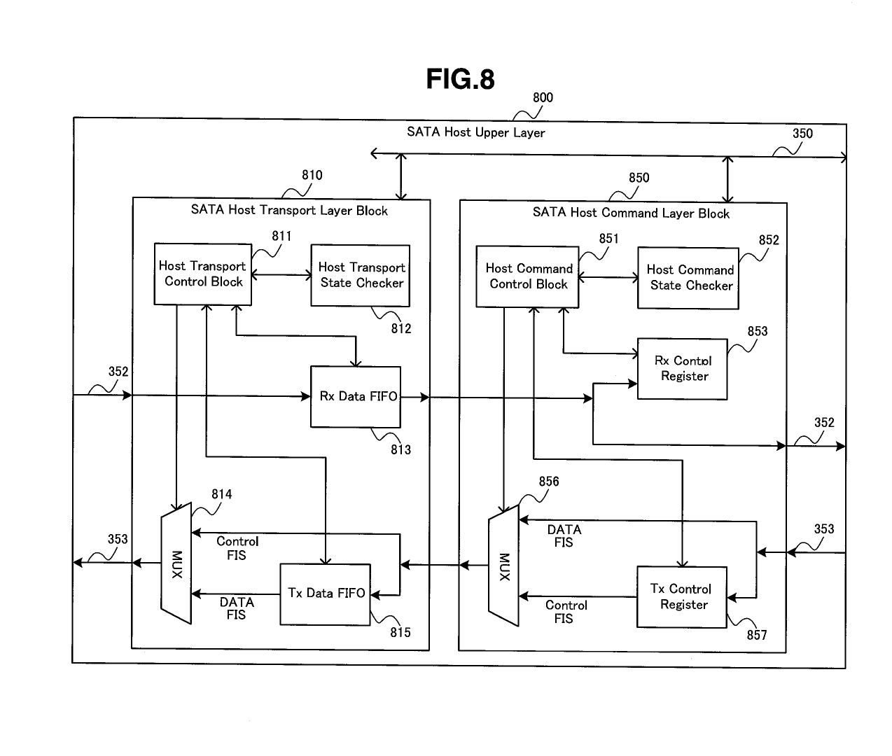

On the other hand, as shown in FIG. 8, the SATA Host Upper Layer 800 includes a SATA Host Transport Layer Block 810 and a SATA Host Command Layer Block 850.

The SATA Host Transport Layer Block 810 is a block for controlling the transport layer at the SATA port 500. This SATA Host Transport Layer Block 810 includes a host transport control block 811, a host transport state checker 812, an Rx data FIFO 813, a multiplexer 814, and a Tx data FIFO 815.

The STP Host Command Layer Block 850 is a block for controlling the command layer at the SATA port 500. This STP Host Command Layer Block 850 includes a host command control block 851, a host command state checker 852, an Rx control register 853, a multiplexer 856, and a Tx control register 857.

Since the SATA Host Transport Layer Block 810 and the STP Host Command Layer Block 850 have configurations similar to those of the SATA Target Transport Layer Block 710 and the STP Target Command Layer Block 750 for the STP Target Upper Layer 700 as described above with reference to FIG. 7, only the differences between the SATA Host Transport Layer Block 810 and the SATA Target Transport Layer Block 710 and between the STP Host Command Layer Block 850 and the STP Target Command Layer Block 750 will be described below, and any description of the same portions has been omitted.

The STP Target Upper Layer 700 described in FIG. 7 is a layer for receiving a command issued by the SAS controller 125 serving as an STP initiator and then processing data transfer and responses. Therefore, the STP Target Upper Layer 700 behaves as an SATA device (STP target).

On the contrary, the SATA Host Upper Layer 800 in FIG. 8 behaves as a SATA host. The SATA Host Upper Layer 800 issues a command to the SATA device (SATA HDD 230). After receiving a data transfer request from the STA HDD 230, the SATA Host Upper Layer 800 executes data transfer between the SATA HDD 230 and the SATA Host Upper Layer 800. The SATA Host Upper Layer 800 receives a RESPONSE FIS that is the result of processing the command at the SATA HDD 230.

The host transport control block 811, the host transport state checker 812, the host command control block 851, and the host command state checker 852 controls the SATA transport layer and command layer on the host side.

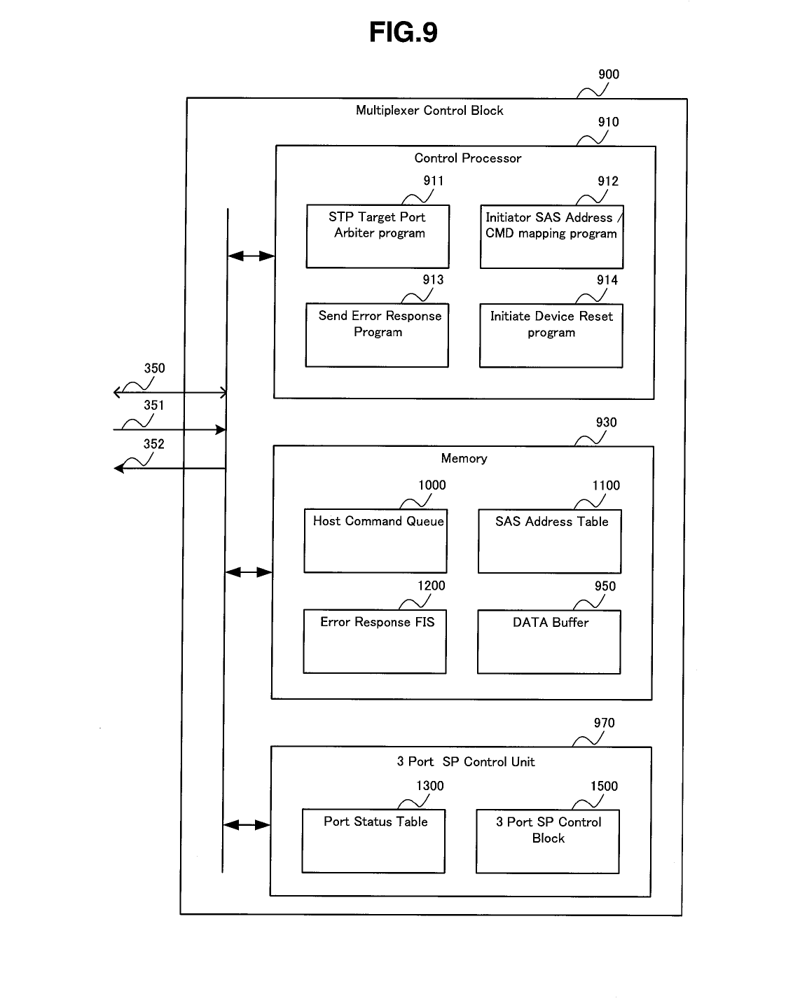

On the other hand, the multiplexer controller block 900, as shown in FIG. 9, includes a control processor 910, a memory area 930, and a 3-port SP control unit 970. Incidentally, the STP active multiplexer 300 is program-controlled by the control processor 910 in this embodiment, but circuit control instead of the program control may be utilized to control the STP active multiplexer 300.

The control processor 910 includes an STP/SATA port arbiter program 911, an initiator SAS address/command mapping program 912, a device reset response program 913, and a device reset instruction program 914. The 3-port SP control unit 970 includes a port status table 1300 and a 3-port SP control block 1500.

The memory area 930 stores a host command queue 1000, a SAS address table 1100, an error response FIS 1200, and a data buffer 950.

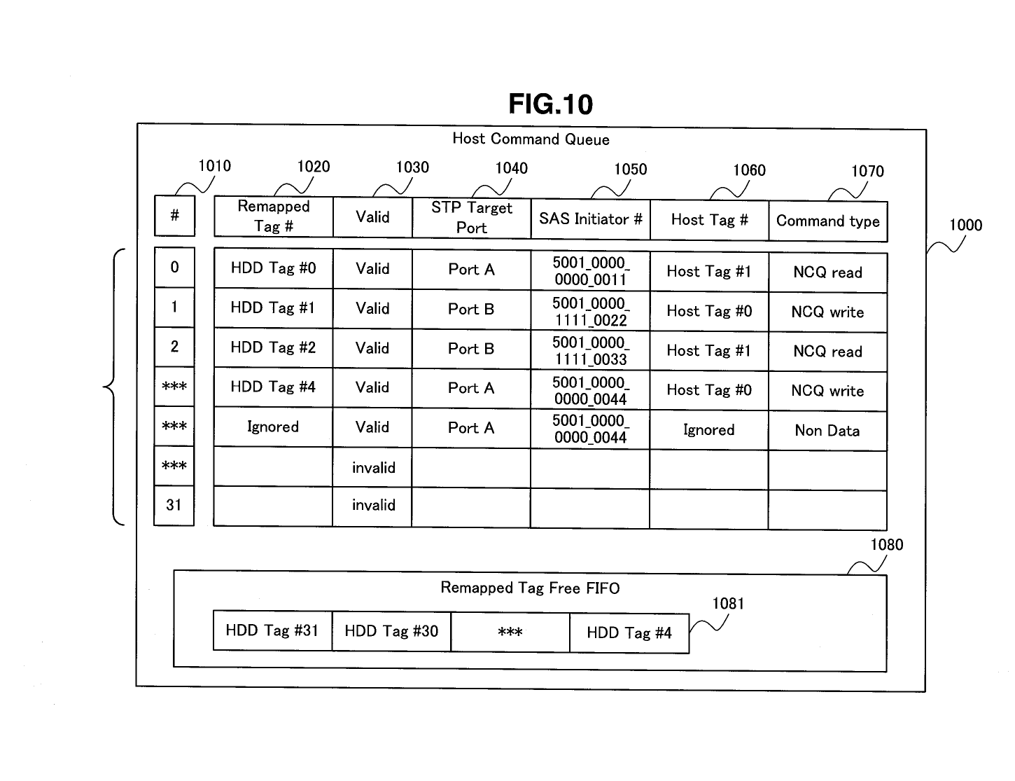

As shown in FIG. 10, the host command queue 1000 is a command queue with entries for converting a tag of a command received from the SAS controller 125 to a tag to be issued to the drive. In FIG. 10, a remapped tag free FIFO 1080 represents a free FIFO that manages a tag number 1081 not issued to the SATA HDD 230.

The host command queue 1000 includes an entry number field 1010, a remapped tag number field 1020, a valid bit field 1030, an STP target port field 1040, an STP initiator address field 1050, a host tag number field 1060, and a command type field 1070.

The entry number field 1010 stores an entry number in the host command queue 1000 table. According to the SATA standard, the maximum number of tags that can be issued according to the FPDMA protocol, which uses NCQ (Native Command Queuing) tags as commands, is 32. Since commands other than the NCQ commands with tags do not have tags, 32 entries, which is the maximum number of tags for NCQ commands in the SATA HDD 230, needs to be prepared as the number of entries for the host command queue 1000

The remapped tag number field 1020 stores a command tag number issued to the SATA HDD 230. If the protocol used is not the FPDMA protocol, the remapped tag number field 1020 is ignored. The valid bit field 1030 is a field that indicates whether the relevant entry is valid or invalid.

The STP target port field 1040 stores information used to identify from which of the two STP target ports 400 (400a, 400b) ports the received command was sent (specifically speaking, the identifier for the STP target port 400 which issued that command).

The STP initiator address field 1050 stores an SAS address for the SAS initiator which issued the relevant command. Incidentally, the STP initiator address field 1050 may be designed to store an identifier corresponding to the STP initiator's SAS address or an index number corresponding to the STP initiator's SAS address that is registered with the SAS address table 1100 as described later.

The host tag number field 1060 stores a tag number (original tag before mapping) of a command issued by the STP initiator. If the protocol used is not the FPDMA protocol, this host tag number field 1060 is ignored.

The command type field 1070 stores the command type and the protocol type. Specifically, the command type field 1070 stores information about each protocol (non-data transfer, PIO, DMA, or FPDMA) and the data transfer direction (Read, Write, or non-data transfer).

The host command queue 1000 may be implemented so that a new command is added by means of a ring queue to the top of the relevant queue, or the host command queue 1000 may be implemented so that invalid entries are managed by the free FIFO and a new command is added to the invalid entries.

Incidentally, the STP active multiplexer 300 is required to have the host command queue 100 manage, in addition to the aforementioned various pieces of information, the order of receiving commands when the STP active multiplexer 300 receives commands from the STP initiator. This is because the STP active multiplexer 300 is required to issue commands to the SATA HDD 230 in the order the commands are received. If both NCQ commands and non-NCQ commands received form a plurality of STP initiators are mixed, the STP active multiplexer 300 needs to execute command issue order control to issue non-NCQ commands to the SATA HDD 230 after completion of all the NCQ commands queued in the SATA HDD 230. An explanation of the order control procedures when issuing the above-mentioned commands is omitted.

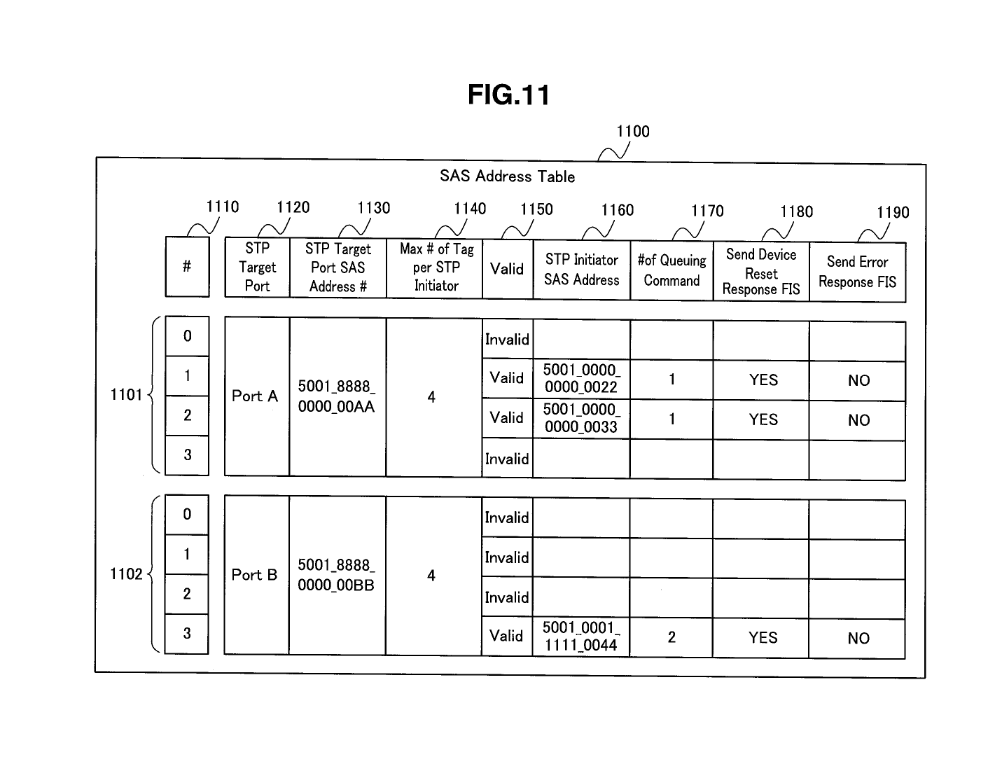

FIG. 11 shows the configuration of the SAS address table 1100. The SAS address table 1100 is a table that stores the SAS addresses for the two STP target ports 400 and the SAS address for the STP initiator port corresponding to the device that issued the received command.

The SAS address table 1100 is divided into two entry groups 1101 and 1102: an entry group 1101 for one STP target port (STP target port 400a) and an entry group 1102 for the other STP target port (STP target port 400b). There is a limitation on the number of STP initiators' SAS addresses that can be stored in these two entry groups 1101, 1102. This means that the total number of STP initiator ports that can issue a plurality of the same commands to one STP target port 400 is limited.

Each entry in this SAS address table 1100 is composed of a SAS initiator number field 1110, an STP target port field 1120, a SAS address field 1130, a maximum-number-of-tags field 1140, a valid bit field 1150, a SAS address field 1160, a number-of-commands field 1170, a device reset response FIS transmission flag field 1180, and an error response FIS transmission flag field 1190.

The SAS initiator number field 1110 stores the index number of the relevant SAS address table 1100. This number is a fixed value that is a unique number composed of a combination of two STP target port numbers and a SAS initiator number that can be stored.

The STP target port field 1120 stores a port number given to the corresponding STP target port 400. This port number is a fixed and unique value. Furthermore, the SAS address field 1130 stores a SAS address for the corresponding STP target port 400. Different SAS addresses are set to different STP target ports 400, respectively.

Incidentally, there are two method for setting the SAS address for the STP target port 400. One method is performed by the STP active multiplexer 300 by setting the SAS addresses for the two STP target ports 400, using the STP target port SAS address 260 information stored in the nonvolatile memory 250 connected to that STP active multiplexer 300 at the time of activation of the STP active multiplexer 300.

The second method is a method for setting the SAS addresses in the following procedures: when a link 330 is established between the active multiplexer 300 and the SATA HDD 230, the STP active multiplexer 300 generates and issues an IDENTIFY DEVICE command to the STP SATA HDD 230. Having received this command, the SATA HDD 230 returns individual identification information about the SATA HDD 230 including the WWN 235 information about the SATA HDD 230, to the STP active multiplexer 300; and finally, the STP active multiplexer 300 uses the identification information received from the SATA HDD 230 to generate the two STP target ports 400 from the WWN 235 of the SATA HDD 230. Incidentally, for example, the upper 4 bits of the identification information about the SATA HDD 230 constitute a field called “NAA” that is a 5 h value and a fixed value; and, therefore, this portion of the NAA field is used to generate new SAS addresses for the two STP target ports 400.

The maximum-number-of-tags field 1140 stores the maximum number of tags that can be issued by one STP target port 400. There are two possible ways of defining the value of the maximum number of tags, that is, the same value may be shared by a plurality of STP initiators or different values may be managed independently.

The first definition is explained as follows: if the STP active multiplexer 300 makes settings so that the maximum number of tags will be shared by a plurality of STP initiators, the number of NCQ commands that can be issued by one STP initiator is limited to the value specified for this field at the maximum. In this case, assuming that a maximum of eight initiators can be connected, the upper limit of the number of the same commands that can be issued by one STP initiator is a value that can be obtained by calculation of “32÷8 initiators=4 tags.”

The second definition is explained as follows: one value is set for the two STP target ports; and if the maximum number of tags is set to “32,” this is the value used to limit the maximum number of tags for commands issued by all the STP initiators to the STP active multiplexer 300. As a result, if one STP target port 400 receives an NCQ command with 32 tags, the other STP target port 400 cannot receive any command at all. Since in this example only 32 tags can be processed at the maximum regarding the number of entries for the host command queue 1000, the STP active multiplexer 300 needs to issue an error response so that it will not receive a command in excess of the 32 tags from a plurality of hosts. Another implementation method is possible whereby the number of entries for the host command queue 1000 is expanded to the number of entries calculated by “the number of STP initiator entries x the number of tags in the maximum-number-of-tags field 1140,” and the STP active multiplexer 300 controls the number of tags to be issued to the SATA HDD 230 to not exceed 32 tags.

Now, an explanation is given about how the STP active multiplexer 300 sets the maximum number of tags in the maximum-number-of-tags field 1140. The STP initiator or the STP active multiplexer 300 issues an IDENTIFY DEVICE command in order to obtain attribute information about the SATA HDD 230 immediately after establishment of a link with the SATA HDD 230. The attribute information returned in response to this command includes the maximum number of NCQ tags that can be processed by the SATA HDD 230. The STP active multiplexer 300 acquires the maximum-number-of-tags information about the SATA HDD 230 by temporarily storing the maximum-number-of-tags information in the data buffer 950. The maximum-number-of-tags information about the SATA HDD 230 is used to specify the upper limit of the number of tags for the entire STP active multiplexer 300 or to specify the upper limit of the number of tags per STP initiator.

The valid bit field 1150 stores a flag that shows whether the STP initiator field is valid or not (hereinafter referred to as the “valid bit”). If the valid bit stored in the valid bit field 1150 indicates “valid,” the SAS address field 1160 stores the SAS address for the STP initiator.

The number-of-commands field 1170 stores the number of commands which are received from the STP initiator and are not queued yet. This number of commands which are not queued is incremented when the STP active multiplexer 300 receives a command, while the number of commands not queued is decremented when the processing is completed.

The case where all the entries in the STP target port in the SAS address table 1100 are valid and the STP target port 400 receives a connection establishment request from another STP initiator will be explained below.

If the number of commands stored in the number-of-commands field 1170 is “0,” the valid bit that is stored once in the valid bit field 1150 for the relevant entry can be nullified. If the number of commands becomes “0” and if the STP target port 400 further receives a connection request from another STP initiator, the STP initiator can be replaced with that other STP initiator, which is then registered. If the number of commands stored in the number-of-commands field 1170 is not “0,” and if a command being executed exists in the host command queue 1000, it is necessary to keep all the entries valid. If the number-of-commands field 1170 for all the SAS initiator entries is not “0,” the connection establishment request from the STP initiator cannot be accepted because of a lack of resources for the SAS address table 1100. Details of the control flow will be described later.

The device reset response FIS transmission flag field 1180 stores a flag to give an instruction to perform procedures, upon reception of the next new command, for returning a device reset response FIS without transferring the command to the SATA HDD 230 (hereinafter referred to as the “device reset response FIS transmission flag”). The purpose of using the device reset response FIS transmission flag in response to a device reset response FIS is to notifies the SAS initiator that all the commands have been discarded, thereby triggering the device driver controlling the SAS initiator to start executing the failure processing. Another purpose of using this device reset response FIS transmission flag is to check if the reset processing is normally terminated after the device driver controlling the SAS controller 125 gave a reset instruction to the STP active multiplexer 300 or the SATA HDD 230. The device reset response FIS described later includes an additional state code described later in addition to a response code defined by the SATA standard. The control flow regarding this the device reset response FIS transmission flag will also be described later in detail.

The error response FIS transmission flag field 1190 stores a flag for giving an instruction to send an error response to the relevant host when various inconsistency detection mechanisms for the STP active multiplexer 300 detect an error during execution of a command and then discards the command being executed (hereinafter referred to as the “error response FIS transmission flag”). The purpose of using this error response FIS transmission flag is to return the error response without fail, thereby triggering the device driver controlling the SAS controller 125 to proceed to the failure processing. The error response FIS described later includes the additional state code in addition to the response code defined by the SATA standard. The control flow regarding this error response FIS transmission flag will be described later in detail.

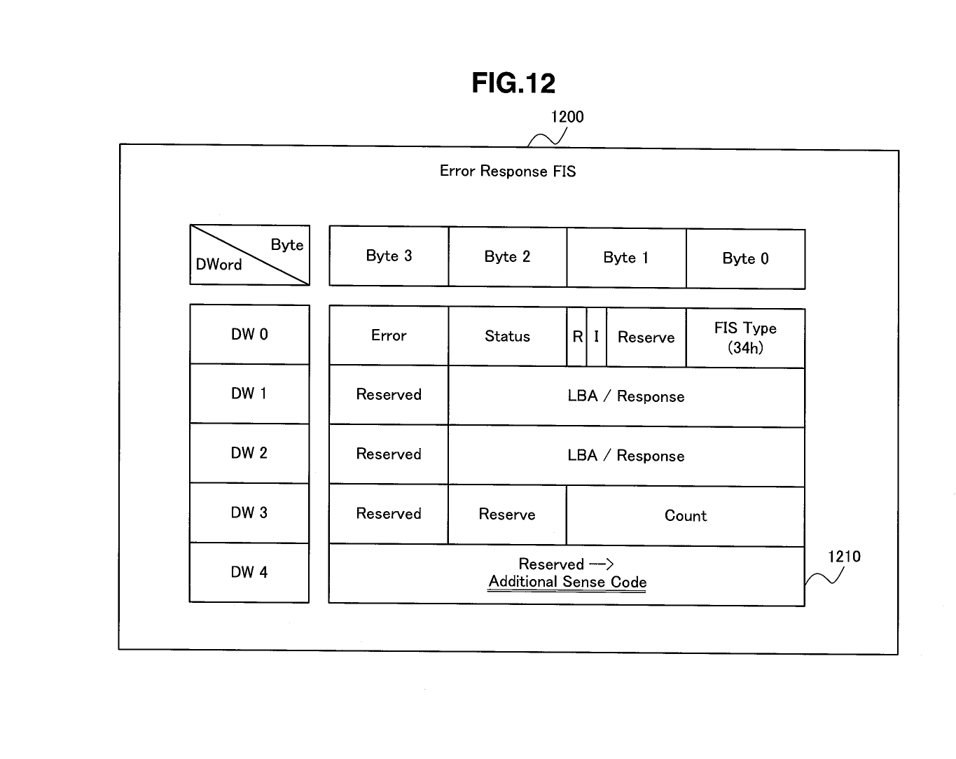

FIG. 12 illustrates the configuration of an error response FIS 1200. Since DW0 to DW4 in FIG. 12 have the same meanings as those of the fields for the RESPONSE FIS defined by the SATA standard, any description thereof has been omitted.

DW4 is a Reserved field; however, in this embodiment, an Additional Sense Code 1210, which is additional information, is added to this field when sending an error response FIS or a device reset response FIS.

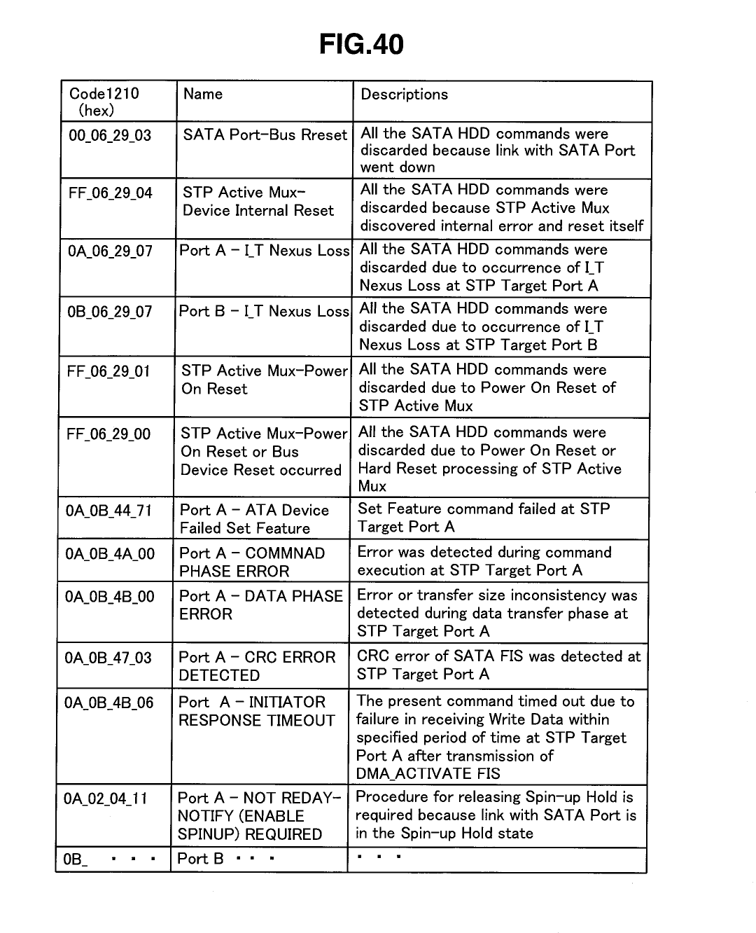

FIG. 40 shows examples of the Additional Sense Code 1210. These codes are just some examples, and it is possible to additionally include errors that can be detected by the STP active multiplexer 300. For example, it is possible to add error definitions by rewriting the error response transmission control program 913 or using the configuration parameter 270.

Regarding the Additional Sense Code 1210, it is favorable for the device driver controlling the SAS controller 125 to use the code names defined by SCSI. It is also favorable to devise the Additional Sense Code 1210 so that the tag number for the relevant NCQ command, the port number for the STP target port, and the factors of the STP active multiplexer 300 can be identified.

Regarding the error response, the Reserved area in the RESPONSE FIS in the SATA FIS is used. According to another embodiment, it is possible to store the Additional Sense Code 1210 shown in FIG. 40 in response data of a Read Log Extended command that is absolutely required to be issued after the occurrence of an NCQ command error in accordance with the NCQ command processing. Since a field indicating an NCQ tag to show the occurrence of an error is previously provided in the response data of the Read Log Extended command, it is not necessary to add the NCQ tag information to the Additional Sense Code 1210 in FIG. 40.

As a naming convention for the Additional Sense Code 1210 in this embodiment, Byte 3 of the upper DW4 is used to identify the relevant port or device, Byte 2 of DW4 is used to specify a SCSI Sense Key defined in the SCSI architecture model, and Byte 1 and Byte 0 of DW4 are used to specify ASC/ASCQ (Additional Sense Code/Additional Sense Code Qualify). However, the same purpose can be achieved by using any naming convention other than the above naming convention.

Further details of the Additional Sense Code 1210 shown in FIG. 40 will be explained below.

First, the meaning of the term “I_T Nexus Loss” used in the Additional Sense Code 1210 “0A_{—}06_{—}29_{—}07” is explained below. When the STP target port sends a connection request to the SAS initiator, if a failure occurs at the SAS initiator or in a path between the STP target and the SAS initiator and the request thereby does not reach the SAS initiator, the STP target port retries issuing the connection request until I_T Nexus Loss timer. If this timer exceeds a time-out value (if the timer has expired), the STP target port determines that the connection request cannot reach the relevant SAS initiator, and then aborts the issuance of the connection request and discards all the commands relating to I_T Nexus. NCQ commands in the SATA HDD 230 cannot be discarded individually. When all the commands in the SATA HDD 230 are discarded, it would be better if the device driver controlling the SATA HDD 230 could identify what kind of failure occurred at which port, so that it becomes easier to specify the cause of failure by the subsequent failure processing. Incidentally, I_T Nexus is a SCSI term indicating a relationship between the initiator port and the target port.

Next, regarding the term “NOTIFY (ENABLE SPINUP) REQUIRED” in “0A_{—}02_{—}04_{—}11,” the purpose of adding this error response will be described below. The media for the SATA HDD 230 do not spin up until the power is supplied and the link is established. The SAS expander 130 has a function called “spinup hold” and thereby provides a means for realizing rotation control of the media for the SATA HDD 230 by not allowing a transition to the state of the link being established and not allowing the completion of a Link Reset sequence. The spinup hold is the function defined by the SAS standard. In the redundant configuration, the link cannot be established unless the spinup hold is released for both the SAS expanders 130. Therefore, there is a problem with the processing necessary for the spinup, wherein the SAS HDD and the SATA HDD 230 may require different sequences of processing necessary for the spinup. In order to deal with this problem, the STP active multiplexer 300 is controlled as described later so that the processing for rotation control of the media for the SATA HDD 230 can be executed in the same manner as the rotation control of the SAS HDD.

The STP active multiplexer 300 has the above-described “spinup hold” function. Two methods by which the SAS controller 125 releases the spinup hold will be described below.

The first method is to issue a command by which the SAS controller 125 gives an instruction to rotate the media for the special SATA HDD 230. Upon receiving this command, the STP active multiplexer 300 resets the link with the SATA HDD 230 again, thereby releasing the spinup hold state. The second method is, in the same manner as in the case of the SAS HDD, to send a Notify (Spinup) primitive defined by the SAS standard, to the STP target port 400, thereby spinning up the SATA HDD 230.

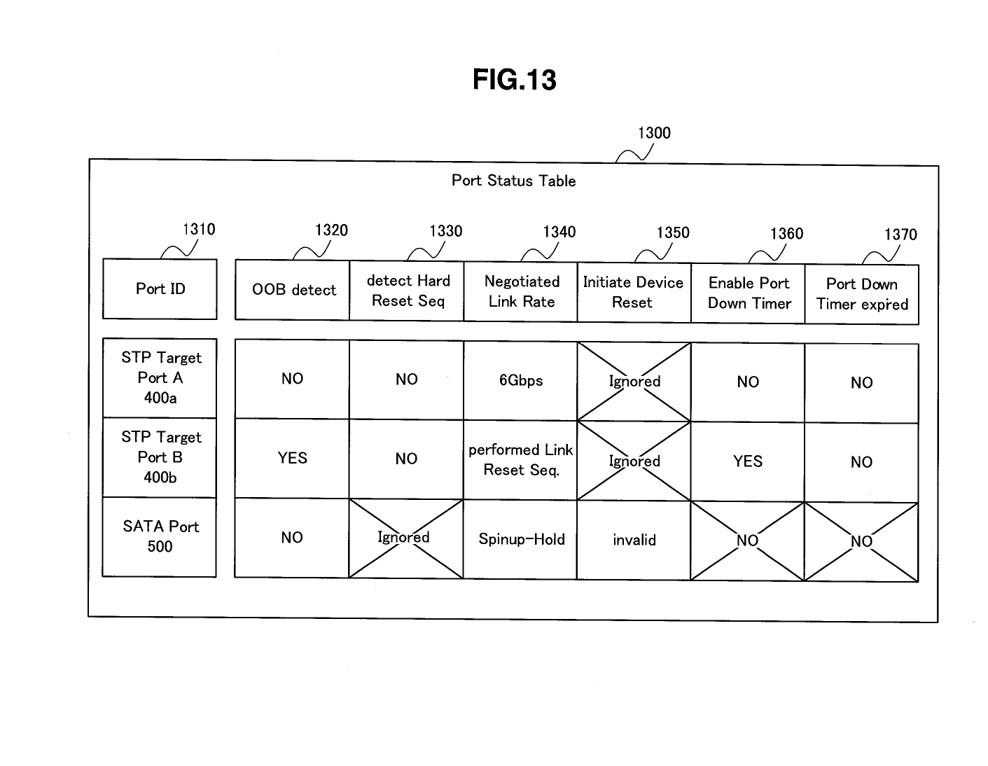

On the other hand, FIG. 13 shows the configuration of a port status table 1300 stored in the 3-port SP control unit 970 (FIG. 9). The port status table 1300 is a table that monitors the status of two STP target ports 400 and a SATA port 500 for the STP active multiplexer 300 and stores the monitoring results. The port status table 1300 has three entries which show the state of one STP target port 400a, the state of the other STP target port 400b, and the state of the SATA port 500.

Each of these entries include a port identifier field 1310, an OOB signal detection flag field 1320, a hard reset sequence detection flag field 1330, a negotiated link rate field 1340, an device reset instruction flag field 1350, a port down timer start flag field 1360, and a timer expiration flag field 1370.

The port identifier field 1310 stores a port identifier of each entry, and the OOB signal detection flag field 1320 stores a flag that indicates whether the OOB signal is detected or not (hereinafter referred to as the “OOB signal detection flag”). If the OOB signal is detected at any of the two STP target ports 400 and one SATA port 500, the 3-port SP control block 1500 described later (FIG. 9) sets the OOB signal detection flag for the entry corresponding to that port to “YES”; or if the link is established, the 3-port SP control block 1500 sets the OOB signal detection flag to “NO.”

The hard reset sequence detection flag field 1330 stores a flag that indicates whether a HARD_RESET primitive is detected in a link reset sequence or not (hereinafter referred to as the “hard reset sequence detection flag”). If the 3-port SP control block 1500 completes an OOB sequence at either of the STP target ports and then detects a HARD-RESET in the subsequent Identification sequence, it recognizes that the hard reset is started and then sets the hard reset sequence detection flag to “YES.” Incidentally, the hard reset sequence detection flag is normally set to “NO.” Since it is unnecessary to detect the HARD_RESET regarding the SATA port 500, this field for the SATA port 500 entry is ignored.

The negotiated link rate field 1340 stores a physical link rate of each port (for example, a link rate such as 3 Gbps or 6 Gbps). Since the link rate is not fixed during the link reset sequence, the negotiated link rate field 1340 stores an identification flag indicating that the link reset sequence is being executed.

The device reset instruction flag field 1350 stores a flag that indicates whether or not it is necessary for the STP active multiplexer 300 to detect a failure and reset all the commands in the SATA HDD 230 (hereinafter referred to as the “device reset instruction flag”). This field is ignored regarding the STP target ports 400.

The port down timer start flag field 1360 stores a flag that is set when the link with the relevant port temporarily goes down due to a signal quality failure (hereinafter referred to as the “port down timer start flag”). The time that elapses before the link with the port which temporarily went down is reestablished is monitored by a timer (hereinafter referred to as the “port down timer”). This field is also ignored regarding the SATA port 500.

The timer expiration flag field 1370 stores a flag that is set if the port temporarily goes down due to a signal quality failure and then the port down timer expires without establishing the link with that port (hereinafter referred to as the “timer expiration flag”). This field is also ignored regarding the SATA port 500.

Incidentally, the port down timer will be explained later in the description of the 3-port SP control block 1500.

### (1-2-3) Connection State Transition

The link state of the STP active multiplexer 300 will be explained below.

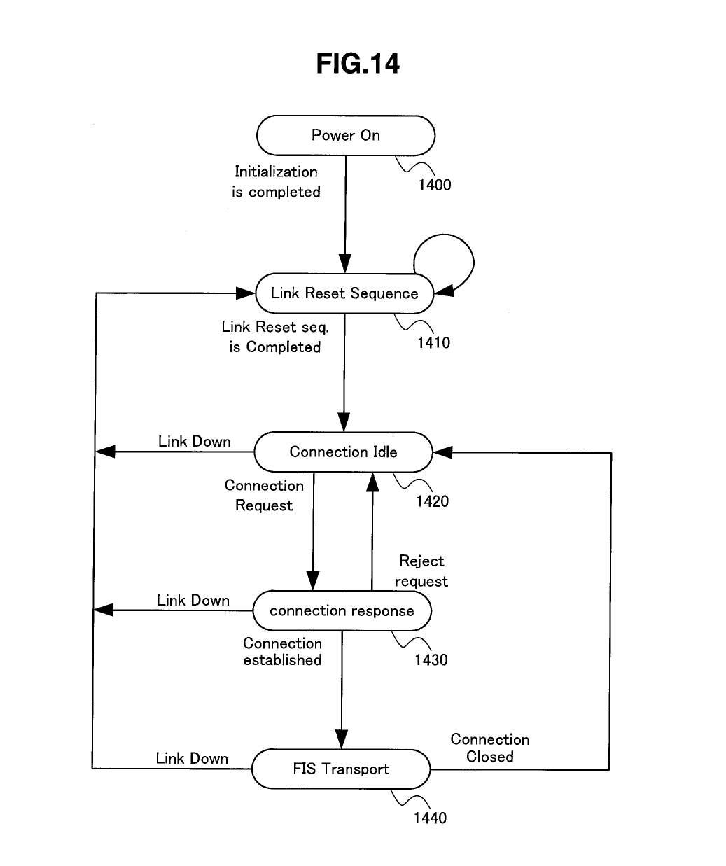

FIG. 14 shows a state machine regarding the link state of the STP active multiplexer 300. As shown in FIG. 14, there are five types of the link state of the STP active multiplexer 300: “Power On,” “Link Reset Sequence,” “Connection Idle,” “connection response,” and “SATA FIS Transport.”

The power-on state 1400 is the state immediately after the power to the STP active multiplexer 300 is turned on. After the activation and initialization of the STP active multiplexer 300 are completed, the link state transition is made to the link reset sequence state 1410 of each port.

The link reset sequence state 1410 is the state where link reset processing is being executed for the STP target port 400 and the SATA port 500. When the link reset sequence is completed normally and a link is established, the link state transition is made from the link reset sequence state 1410 to the connection idle state 1420. If the link reset sequence is not completed, the link reset sequence state 1410 is repeated until the completion of the link reset sequence.

The connection idle state 1420 is the state where a link is established between the STP initiator port and the STP target port 400, but a connection is not established between them. If the STP initiator port issues a connection request and the STP target port 400 receives the request, or if the STP target port 400 issues a connection request, the link state transition is made from the connection idle state 1420 to the connection response state 1430.

The connection response state 1430 is the sate where the following processing is executed. It is the state where when the STP initiator port issues a connection request, and if the STP target port 400 receives the connection request, the STP target port 400 executes connection response issue processing. It is also the state where when the STP target port 400 issues a connection request, the STP target port 400 waits for a connection response from the STP initiator port or the SAS expander 30 located in the connection path between the STP target port 400 and the STP initiator.

When the STP target port 400 rejects the connection request received by the STP target port 400 or when the STP initiator port or SAS expander 130 rejects the connection request issued by the STP target port 400, the link state makes the transition from the connection response state 1430 to the connection idle state 1420. When the STP target port 400 accepts the connection request received by the STP target port 400 or when the STP initiator port accepts the connection request issued by the STP target port 400, a connection is established and, therefore, the link state transition is made from the connection response state 1430 to the SATA FIS transfer state 1440.

The SATA FIS transfer state 1440 is the state where the connection is established between the STP initiator port and the STP target port 400 and a SATA FIS is transferred between these ports. When the SATA FIS transfer is completed normally or terminated abnormally, the link state transition is made from the SATA FIS transfer state 1440 to the connection response state 1430 by termination of the connection by the STP initiator port or the STP target port 400.

If DW synchronization is lost (Loss of DW synchronization) or the link goes down (Link Down) in the connection idle state 1420, the connection response state 1430, or the SATA FIS transfer state 1440, the link state transition is made from that connection idle state 1420, connection response state 1430, or SATA FIS transfer state 1440 to the link reset sequence state 1410.

### (1-2-4) Port State Monitoring Processing

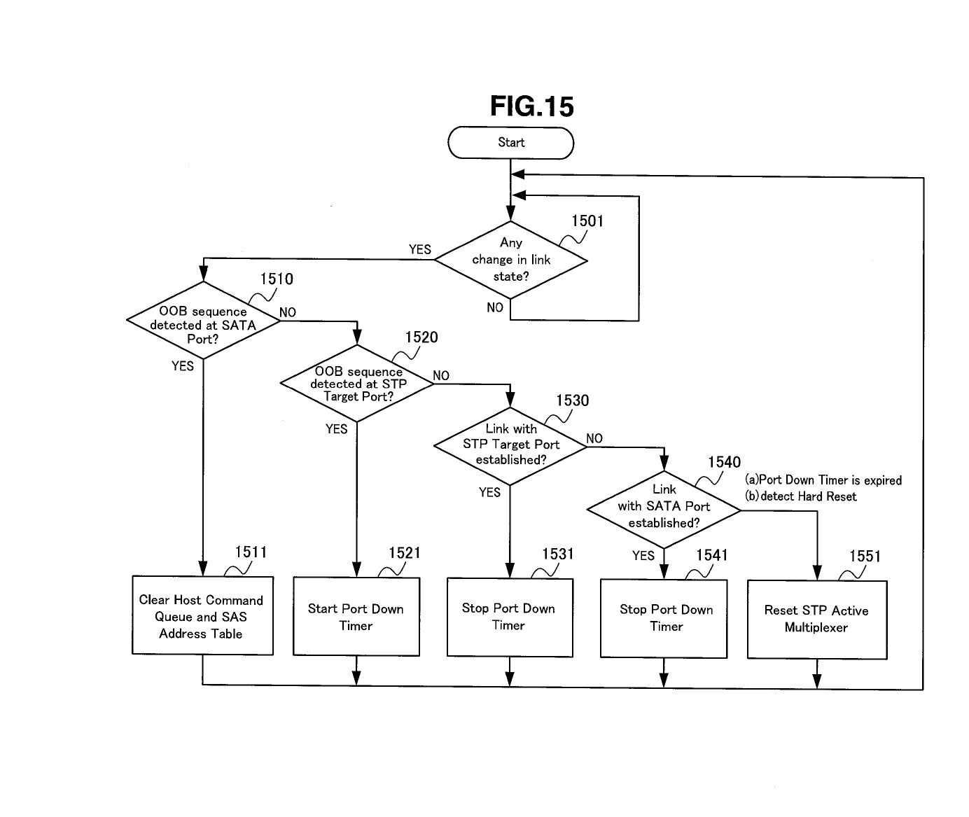

FIG. 15 shows a port state monitoring processing sequence for monitoring each port state of the three ports (two STP target ports 400 and one SATA port 500) as executed by the 3-port SP control block 1500 described with reference to FIG. 9. The 3-port SP control block 1500 monitors the link reset sequence and the link-down at each port and controls the link state based on the monitoring results.

In fact, if the power to the 3-port SP control block 1500 is turned on, or if the STP active multiplexer 300 receives a hard reset, the power to the 3-port SP control block 1500 first waits for the STP active multiplexer 300 to complete initialization processing.

Upon completion of the initialization processing, the 3-port SP control block 1500 monitors the SP block 430 for the STP target port 400 and the SATA port 500 for the SP block 530 belonging to the STP active multiplexer 300 (step 1501).

When this happens, the SP block 430 for the STP target port 400 and the SP block 530 for the SATA port 500 constantly monitor the link state with the STP initiator port or the SATA HDD 230, which is connected to the STP target port 400 or the SATA port 500. If any change in the link state is detected, the relevant SP block 430 or SP block port 530 updates the OOB signal detection flag field 1320, the hard reset sequence detection flag field 1330, the negotiated link rate field 1340, the port down timer start flag field 1360, and/or the timer expiration flag field 1370 in the port status table 1300 in accordance with the details of the change in the link state. Incidentally, the port down timer is provided in each SP block, and the 3-port SP control block 1500 can detect a change in the link state by monitoring the port status table 1300.

If the three ports (two STP target ports 400 and one SATA port 500) are in the state where a link is established respectively, the negotiated link rate field 1340 in the port status table 1300 stores a valid link rate and, therefore, the SP block 430, 530 for each port repeats the same processing (step 1501).

On the other hand, the 3-port SP control block 1500 executes processing described below in step 1501 in any of the following cases: immediately after the power to the STP active multiplexer 300 is turned on or if the STP active multiplexer 300 receives a hard reset; if the SP block 430 or the SP block 530 detects a fault of link termination; if the link reset sequence is completed; if the port down timer has expired; or if the hard reset is detected.

In other words, if the 3-port SP control block 1500 detects the port (SAS target port 400 or SATA port 500) with a change in the link state in step 1501, it judges whether the OOB sequence is detected at the SATA port 500 (step 1510). Specifically speaking, the 3-port SP control block 1500 checks whether or not the OOB signal detection flag stored in the OOB signal detection flag field 1320 for the entry corresponding to the SATA port 500 in the port monitor table 1300 has changed to “YES”; and then the 3-port SP control block 1500 makes the above judgment based on the check result.

If step 1510 returns a negative judgment (step 1510: NO), the 3-port SP control block 1500 judges whether the OOB sequence is detected at the STP target port 400 (step 1520). Specifically speaking, the 3-port SP control block 1500 checks whether or not the OOB signal detection flag stored in the OOB signal detection flag field 1320 for the entry corresponding to the STP target port 400 in the port monitor table 1300 has changed to “YES”; and then the 3-port SP control block 1500 makes the above judgment based on the check result.

If step 1520 returns a negative judgment (step 1520: NO), the 3-port SP control block 1500 judges whether the link reset sequence of the STP target port 400 is completed normally or not (step 1530). Specifically speaking, the 3-port SP control block 1500 checks whether or not the OOB signal detection flag stored in the OOB signal detection flag field 1320 for the entry corresponding to the STP target port 400 in the port monitor table 1300 has changed from “YES” to “NO” and the value stored in the negotiated link rate field 1340 has changed to a value indicating the completion of link reset; and then the 3-port SP control block 1500 makes the above judgment based on the check result.

If step 1530 returns a negative judgment (step 1530: NO), the 3-port SP control block 1500 judges whether or not the link reset sequence is completed normally at the SATA port 500 (step 1540). Specifically speaking, the 3-port SP control block 1500 checks whether or not the OOB signal detection flag stored in the OOB signal detection flag field 1320 for the entry corresponding to the SATA port 500 in the port monitor table 1300 has changed from “YES” to “NO” and the value stored in the negotiated link rate field 1340 has changed to a value indicating the completion of link reset; and then the 3-port SP control block 1500 makes the above judgment based on the check result.

Incidentally, step 1540 by the 3-port SP control block 1500 returns a negative judgment when the 3-port SP control block 1500 detects in step 1501 that the hard reset sequence detection flag stored in the hard reset sequence detection flag field 1330 for the entry corresponding to the STP target port 400 in the port monitor table 1300 has changed to “YES,” or if the timer expiration flag stored in the timer expiration flag field 1370 has changed to “YES.”

If step 1510 returns an affirmative judgment (step 1510: YES) (if the OOB sequence is detected at the SATA port 500), the SATA HDD 230 is reset along with the termination of the link with the SATA port 500, so that the 3-port SP control block 1500 discards all the commands in the host command queue 1000 in the STP active multiplexer 300. Also, the 3-port SP control block 1500 nullifiers the entries for all the STP initiators in the SAS address table 1100 (step 1511).

However, special commands that are processed by the STP active multiplexer 300, but are not processed by the SATA HDD 230 are exceptions and remain registered with the host command queue 1000. Examples of such special commands include a reset command to execute the failure processing of the STP active multiplexer 300. Since only the special commands remain in the host command queue 1000 as a result of the processing in step 1511, the 3-port SP control block 1500 keeps the entries in the SAS address table 1100 valid and reduces the number of the discarded commands from the number of commands being queued 1170 (step 1511). Subsequently, the 3-port SP control block 1500 returns to step 1501.

If step 1520 returns an affirmative judgment (step 1520: YES) (if the OOB sequence is detected at the STP target port 400), the 3-port SP control block 1500 gives an instruction to start the port down timer for the STP target port 400 by setting a port down timer start flag to the port down timer start flag field 1360 in the port status table 1300 (step 1521). Subsequently, after completing the step 1521 processing by the activation of the STP target port 400, the 3-port SP control block 1500 returns to step 1501.

Furthermore, if step 1530 returns an affirmative judgment (step 1530: YES) (if the link reset sequence of the STP target port 400 is completed), the 3-port SP control block 1500 gives an instruction to stop the port down timer for the STP target port 400 by releasing the port down timer start flag stored in the port down timer start flag field 1360 in the port status table 1300 (step 1531). As a result of this processing in step 1531, the STP target port 400 becomes available. After completing the step 1531 processing, the 3-port SP control block 1500 returns to step 1501.

On the contrary, if step 1540 returns an affirmative judgment (step 1540: YES) (if the link reset sequence of the SATA port 500 is completed), the 3-port SP control block 1500 gives an instruction to stop the port down timer for the STP target port 500 by releasing the port down timer start flag stored in the port down timer start flag field 1360 in the port status table 1300 (step 1541). As a result of this processing in step 1541, the STP target port 500 becomes available. After completing the processing in step 1541, the 3-port SP control block 1500 returns to step 1501.

Furthermore, if step 1540 returns a negative judgment (step 1540: NO) (if the port down timer for the STP target port 400 has expired, or if the STP target port detects a hard reset instruction), the 3-port SP control block 1500 resets the STP active multiplexer 300 (step 1551). The state of all the ports registered with the port status table 1300 changes during execution of the link reset. In step 1551, the 3-port SP control block 1500 discards all the commands in the host command queue 1000 and all the fields in the SAS address table 1100 without exceptions. If the hard reset is detected at only one STP target port 400a, commands in the other STP target port 400b are also discarded.

When the step 1551 processing is executed and then the STP active multiplexer 300 is initialized and receives a command from the SAS controller 125, it is necessary to send to the SAS controller a device reset response FIS 1200 indicating that the STP active multiplexer 300 has been reactivated as a result of the hard reset. This is the processing necessary for the device driver controlling the SAS controller 125 to find out why the commands in the STP active multiplexer 300 were discarded.

Consequently, when the STP active multiplexer 300 is reactivated in the step 1551 processing, the error response transmission program 913 (FIG. 9) sets the device reset response FIS transmission flag for the device reset response FIS stored in the device reset response FIS transmission flag field 1180 in the SAS address table 1100 (FIG. 11), to “NO (not transmitted yet).” Subsequently, the STP active multiplexer 300 returns the error response FIS 1200, to which the Additional Sense Code is set, to the SAS controller 125 in response to the first command issued by the SAS controller 125. Also, when the error response transmission program 913 completes the transmission of the error response FIS 1200, it sets the device reset response FIS transmission flag stored in the device reset response FIS transmission flag field 1180 for the corresponding entry in the SAS address table 1100, to “YES (already transmitted).”

After completing the step 1551 processing described above, the 3-port SP control block 1500 returns to step 1501 and monitors the link state again.

### (1-2-5) FIS Transfer from Host to Drive

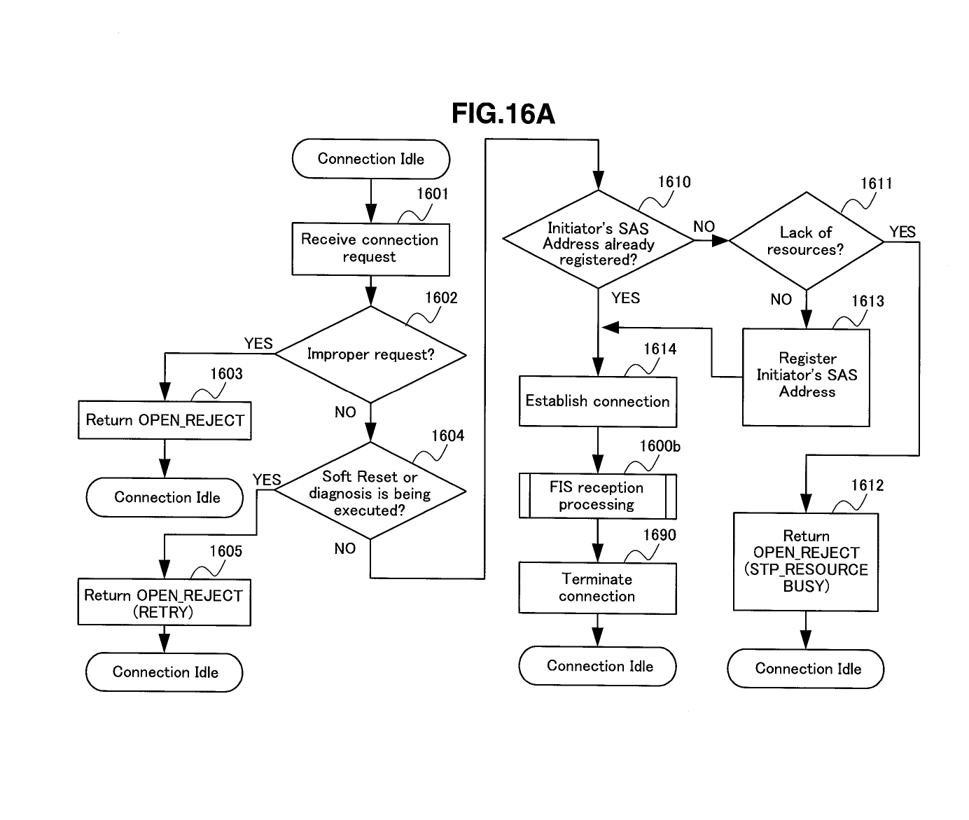

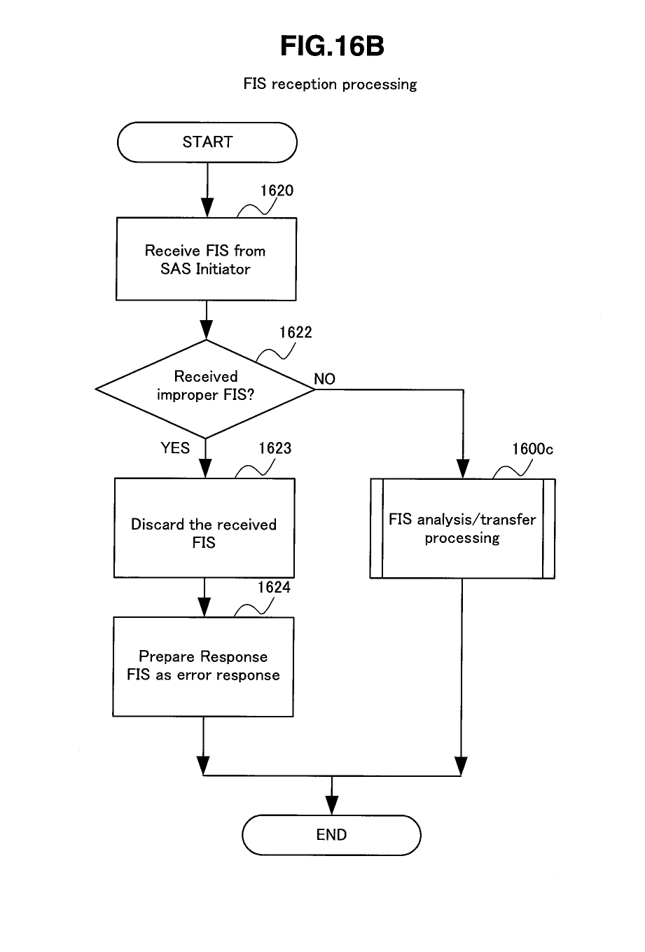

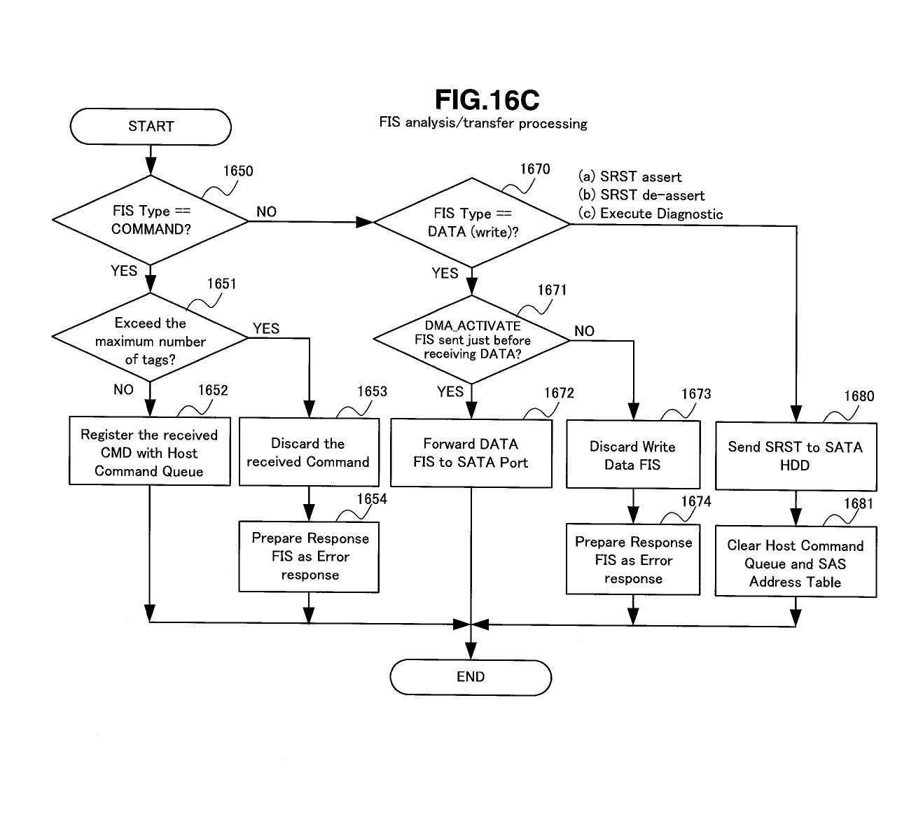

Next, a processing sequence executed by the STP active multiplexer 300 (FIG. 2) to transfer a SATA FIS from the SAS controller 125 to the STP active multiplexer 300 will be explained with reference to FIG. 16A to FIG. 16C.

First, the SAS controller 125 issues a connection request, and the STP active multiplexer 300 receives this connection request. When this happens, the STP active multiplexer 300 judges, by referring to the SAS address table 1100, whether the SAS address for the STP initiator is registered with the SAS address table 1100 or not, and whether the received connection request is a proper connection request or not. If the STP active multiplexer 300 determines that the connection request is proper, it establishes a connection with the SAS controller 125.

Thereafter, when the STP active multiplexer 300 receives a SATA FIS of the DATA type, it transfers the data to the SATA port 500 and sends the data to the SATA HDD 230; and when the data transfer is completed, the STP active multiplexer 300 terminates the connection with the SAS controller 125. On the other hand, if the STP active multiplexer 300 receives a SATA FIS of the command type, it registers this command with the command queuing table 1000 and then terminates the connection with the SAS controller 125.

As the control processor 910 described above with reference to FIG. 9 executes the SAS address/command mapping program 912, the STP active multiplexer 300 assigns an HDD tag to the new command registered with the command queuing table 1000 and transfer the command to the SATA port 500, thereby making the SATA HDD 230 execute the command.

FIG. 16A shows a processing sequence executed by the STP active multiplexer 300 when a SATA FIS is transferred from the SAS controller 125 to the STP target port 400.

In this case, the SL_CC receiver 453 described above in FIG. 4 for the STP active multiplexer 300 receives the connection request issued by the SAS controller 125 (step 1601). Incidentally, in this step 1601, the link state of the STP target port 400 makes the transition to the connection response state 1430 described in FIG. 14.

This connection request is analyzed by the SL_CC control block 454 (FIG. 4), and the SL_CC control block 454 judges whether the connection request is an improper connection request or not (step 1602).

If this connection request is improper (step 1602: YES), the SL_CC transmitter 457 (FIG. 4) returns a response to the SAS controller 125 by means of an OPEN_REJECT primitive (step 1603). Specifically, the SL_CC transmitter 457 sends to the SAS controller 125 an OPEN_REJECT (CONN RATE NOT SUPPORTED), an OPEN_REJECT (PROTOCOL NOT SUPPORTED), or an OPEN_REJECT (WRONG DESTINATION) defined by the SAS standard. In this step 1603, the state of STP target port makes the transition to the connection idle state 1420 described above with regards to FIG. 14.

On the other hand, if the connection request received in step 1601 is proper (step 1602: NO), the SL_CC control block 454 judges whether or not the STP active multiplexer 300 is executing soft reset or an Execute device Diagnostic command (step 1604).

If the STP active multiplexer 300 is executing the soft reset or the Execute device Diagnostic command (step 1604: YES), the SL_CC control block 454 gives an instruction to issue an OPEN_REJECT (RETRY) primitive to the SL_CC transmitter 457. As a result, the SL_CC transmitter 457 transmits the OPEN_REJECT (RETRY) primitive to the STP initiator according to this instruction. Incidentally, when the processing in step 1605 is completed, the link state of the STP target port 400 makes the transition to the connection idle state 1420 (FIG. 14). When the STP initiator receives the OPEN_REJECT (RETRY), it repeats retry. Therefore, when the soft reset or diagnosis is completed, the STP initiator can establish a connection.

On the other hand, when the STP active multiplexer 300 is not executing the soft reset or the Execute device Diagnostic command (step 1604: NO), the SL_CC control block 454 judges, by referring to the SAS address table 1100, whether the SAS address for the STP initiator port which sent the connection request is already registered with the SAS address table 1100 or not (step 1610).

If the SAS address for the STP initiator is not registered with the SAS address table 1100 (step 1610: NO), the SL_CC control block 454 judges, by referring to the SAS address table 1100, whether the SAS address table 1100 lacks resources or not (step 1611). Incidentally, the condition for a lack of resources for the SAS address table 1100 is that all the STP initiator SAS address entries corresponding to the STP target port 400 in the SAS address table 1100 are already made valid by another SAS initiator and one or more commands which are being executed by all the STP initiators exist.

If the SAS address table 1100 lacks resources (step 1611: YES), the SL_CC control block 454 cannot register a connection request from a new STP initiator with the SAS address table 1100. Therefore, in this case, the SL_CC control block 454 rejects the connection request from the SAS controller 125 (step 1612). Specifically speaking, the SL_CC control block 454 controls the SL_CC transmitter 457 (FIG. 4) and makes it send an OPEN_REJECT (STP_RESOURCE_BUSY) primitive to the SAS controller 125. Incidentally, in this step 1612, the link state of the STP target port 400 makes the transition to the connection idle state 1420 (FIG. 14).

On the other hand, if the SAS address table 1100 does not lack resources (step 1611: NO), the SL_CC control block 454 for the STP target port 400 registers the SAS address for the STP initiator with the SAS address table 1100 (step 1613). When this happens, if there is an invalid entry in the SAS address table 1100, the SL_CC control block 454 validates the invalid entry (changes the valid bit to “valid”) and registers the SAS address for the STP initiator in the SAS address field 1160. If all the entries in the SAS address table 1100 are valid, the SL_CC control block 454 searches for an entry whose number of queued commands stored in the number-of-commands field 1170 is “0,” nullifies the entry, and then registers the SAS address for the STP initiator in the SAS address field 1160.

Since the SAS controller 125 does not send a command in this step 1613, the SL_CC control block 454 sets the number-of-commands field 1170 in the SAS address table 1100 to “0.” The SL_CC control block 454 sets the device reset response FIS transmission flag field 1180 to “NO” as the device reset response FIS transmission flag for the SAS controller 125 that has not sent a device reset response and is to be connected for the first time. Furthermore, the SL_CC control block 454 sets the error response FIS transmission flag field 1190 to “NO” as an error response FIS transmission flag.

On the other hand, if the SAS address for the STP initiator is registered with the SAS address table 1100 in step 1610 (step 1610: YES), or if the step 1613 processing is completed, the SL_CC control block 454 sends a connection establishment response to the STP initiator (step 1614). Specifically speaking, the SL_CC control block 454 establishes a connection between its own STP target port 400 and the STP initiator by giving an instruction to the SL_CC transmitter 457 to send an OPEN_ACCEPT primitive to the STP initiator. Incidentally, in this step 1614, the state of the STP target port makes the transition to the FIS transmission state 1440.

Subsequently, when the STP target port 400 receives the SATA FIS from the STP initiator (step 1600b) and the SATA FIS reception processing is completed, the SL_CC control block 454 terminates the connection between its own STP target port 400 and the STP initiator by giving an instruction to the SL_CC transmitter 457 to send a CLOSE (NORMAL) primitive to the STP initiator (step 1690).

FIG. 16B shows a specific processing sequence for the FIS reception processing executed by the STP active multiplexer 300 in step 1600b in FIG. 16A.

In this case, when the STP target port 400 receives the SATA FIS from the SAS controller 125 (step 1620), the Device Transport state checker 712 for the STP Target Transport Layer Block 710 and the device command state checker 752 for the STP Target Command Layer Block 750 described above with reference to FIG. 7 judges whether this SATA FIS is improper FIS or not, as described below. The STP the Device Transport state checker 712 and the device command state checker 752 stores, regarding the processing of one SATA command, the FIS type sent or received last time, the transfer length of the data transfer, etc. and determine what is the next expected operation specified by the SATA protocol. The Device Transport state checker 712 and the device command state checker 752 checks, regarding all the SATA FISs, whether any SATA FIS of the unexpected FIS type is sent or received.

If this SATA FIS is a normal SATA FIS (step 1622: NO), the STP active multiplexer 300 executes the processing corresponding to that SATA FIS (step 1600c).

On the other hand, if the SATA FIS then received is an improper SATA FIS (step 1622: YES), the Device Transport state checker 712 for the STP Target Transport Layer Block 710 and the device command state checker 752 for the STP Target Command Layer Block 750 discard the received SATA FIS (step 1623).

If the received SATA FIS is an improper SATA FIS, the control processor 910 for the multiplexer controller block 900 described above with reference to FIG. 9 prepares for transmission of the error response FIS 1200 (FIG. 12) according to the error response transmission program 913 stored in the memory area 930 in order to send an error response for the reception of the improper FIS to the SAS controller 125 (step 1624).

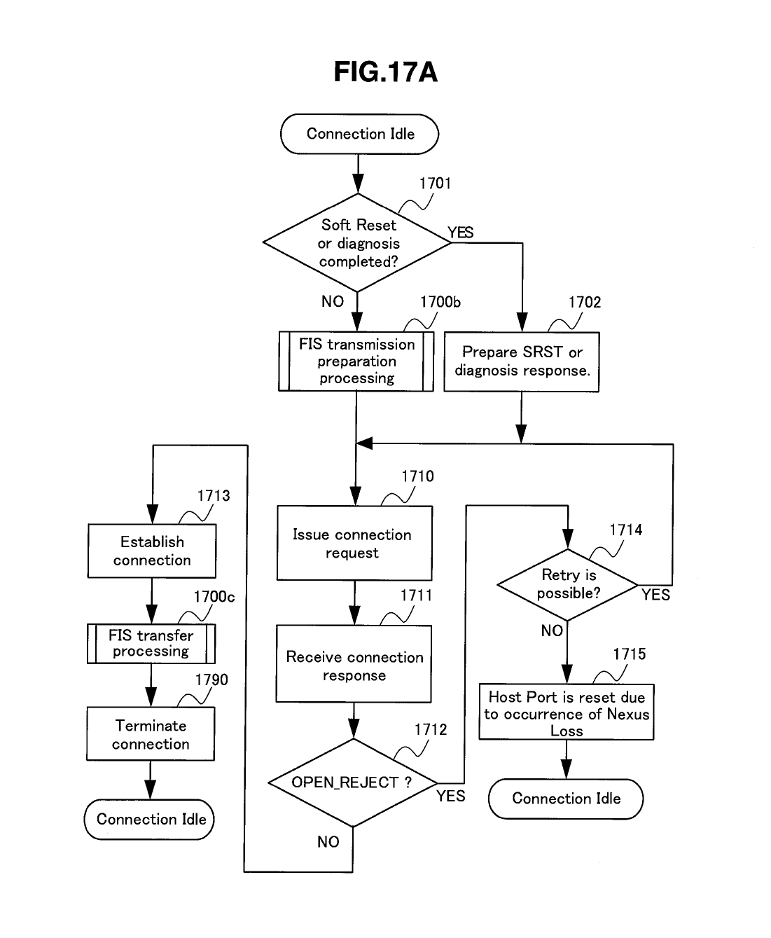

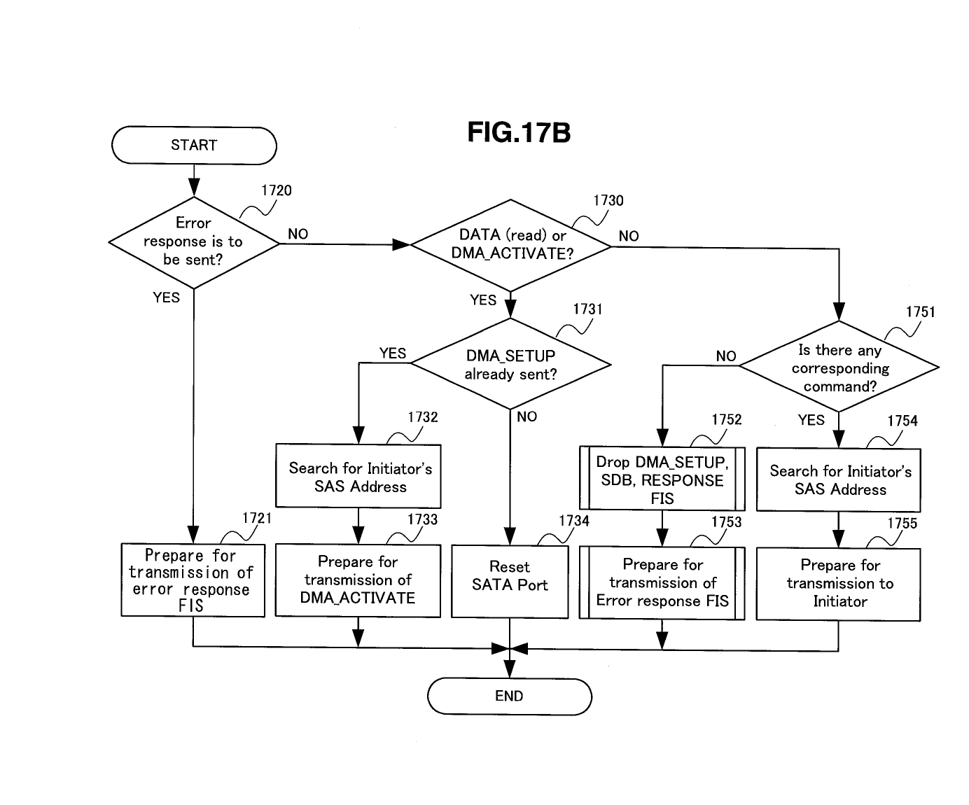

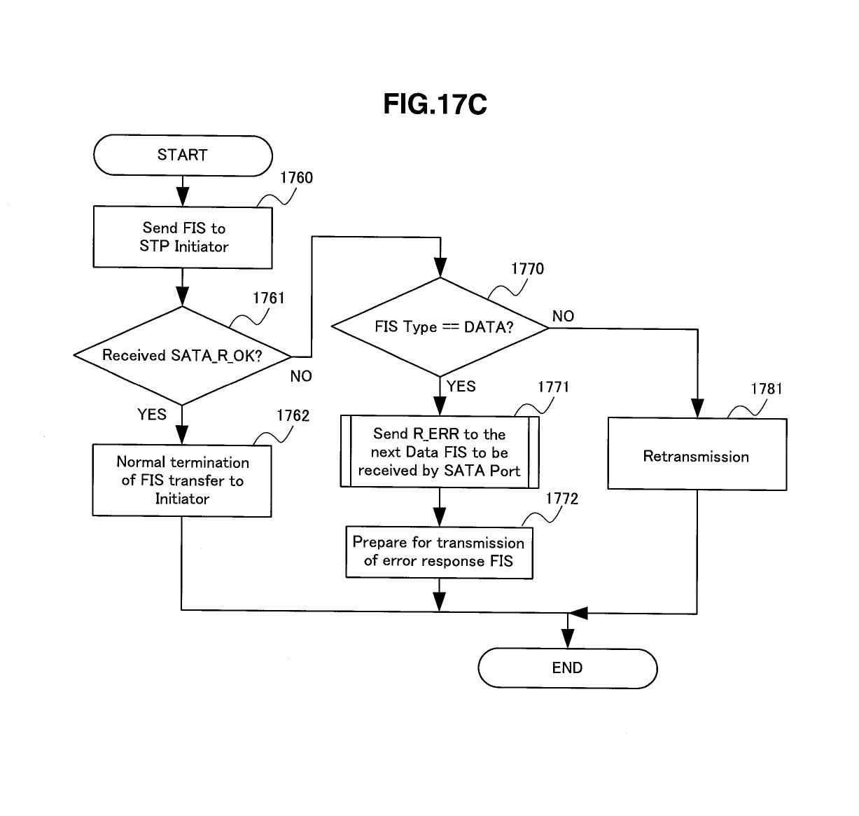

Specifically speaking, the control processor 910 prepares the error response FIS 1200 including an additional code corresponding to the error response which has occurred. Next, the control processor 910 sets the error response FIS transmission flag in the error response FIS transmission flag field 1190 in the SAS address table 1100 to “YES.” After completion of this sequence of processing, the control processor 910 sends the error response to the STP initiator port, to which the error response FIS transmission flag has been set, according to the error response transmission program 913. The procedure for transferring a RESPONSE FIS will be described with reference to FIG. 17.

When the STP active multiplexer 300 completes the step 1624 processing or the step 1600c processing described above, the processing illustrated in FIG. 16B terminates and proceeds to step 1690 in FIG. 16A.

FIG. 16C shows a specific processing sequence for the FIS transfer processing in step 1600c in FIG. 16C. FIG. 16C is a processing flow for executing processing for each type of SATA FIS.

If the SATA FIS received in step 1620 in FIG. 16B is a COMMAND FIS (step 1650: YES), the control processor 910 for the multiplexer controller block 900 described above with reference to FIG. 9 judges according to the SAS address/command mapping program 912 (FIG. 9) whether a new command can be issued or not (step 1651). Specifically speaking, the control processor 910 judges, based on the sum of the number of queued commands stored in the number-of-commands field 1170 in the SAS address table 1100 (FIG. 11) and the maximum number of tags in the maximum-number-of-tags field 1140 in the SAS address table 1100, whether or not the number of tags exceeds the maximum number of tags that can be issued by one STP target port 400.

If the control processor 910 determines that the number of tags does not exceed the maximum number of tags that can be issued by one STP target port 400 (step 1651: NO), it registers a command issued by the SAS controller 125 with an entry of the host command queue 1000 (step 1652).

Specifically speaking, the control processor 910 sets the valid flag in the valid flag field 1030 of one entry in the host command queue 1000 to “valid,” and also stores the identifier for the STP target port 400, which has received the command, in the STP target port field 1040 of that entry. Furthermore, the control processor 910 stores, in the SAS initiator number field 1050 of the relevant entry, the index number 1110 of the SAS address table 1100 for indicating the SAS address for the STP initiator which sent the command; and also stores the tag number assigned by the host to the host tag number field 1060 of the relevant entry. The control processor 910 further registers the corresponding command type in the command type field 1070 of the relevant entry.

Furthermore, the control processor 910 selects one tag number that can be assigned, from the remapped tag free FIFO 1080, assigns the HDD tag number, which is to be issued to the SATA HDD 230, to the command issued by the SAS controller 125, and stores this HDD tag number in the remapped tag number field 1020 for the relevant entry. The above-described processing is executed in order to assign a unique tag number to the same SATA HDD 230 when a command with the same tag number is received from a plurality of hosts.

After the command is registered with the host command queue 1000 as described above, the STP target port adjustment program 911 gives an instruction to issue the command from the SATA port to the SATA HDD 230. As a result, the step 1652 processing terminates, and then the processing proceeds to step 1690 in FIG. 16A.

On the other hand, if the control processor 910 determines in step 1651 that the number of tags exceeds the maximum number of tags that can be issued by one STP target port 400 (step 1651: YES), it discards the then received command (step 1653), and then prepares a response FIS for error response (step 1654). As a result, the step 1654 processing terminates, and then the processing proceeds to step 1690 in FIG. 16A.

On the other hand, if the SATA FIS received in step 1620 in FIG. 16B is write data (YES in step 1650 and YES in step 1670), the device command state checker 752 for the STP Target Command Layer Block 750 (FIG. 7) judges whether or not a DMA_ACTIVATE FIS was sent before receiving the write data (step 1671). Specifically speaking, the device command state checker 752 stores the FIS information sent or received last time. Therefore, the device command state checker 752 can determine that receiving the Write Data FIS after transmission of the DMA_ACTIVATE FIS is the correct sequence.

If the DMA_ACTIVATE FIS was sent before receiving the write data (step 1671: YES), the device command state checker 752 for the STP Target Command Layer Block 750 forwards the then received DATA FIS to the SATA port 500. When the transfer of this write data is completed, the processing proceeds to step 1690 in FIG. 16A.

On the other hand, if the DMA_ACTIVATE FIS was not sent before receiving the write data (step 1671: NO), the device command state checker 752 for the STP Target Command Layer Block 750 discards the write data (step 1673). The write data is discarded because a violation of the SATA protocol was detected, that is, the write data transfer was started, skipping the step of sending the DMA_ACTIVATE. Subsequently, the control processor 910 (FIG. 9) prepares for the error response transmission according to the error response transmission program 913 (step 1674). When this preparation is completed, the processing proceeds to step 1690 in FIG. 16A.

On the other hand, if the SATA FIS received in step 1620 in FIG. 16B is neither a command nor write data (NO in step 1650 and NO in step 1670), this means that the SATA FIS received in step 1620 in FIG. 16A is a special command for resetting the STP active multiplexer 300 and the SATA HDD 230 (a Soft Reset command for asserting/deasserting a soft reset register, or an Executed Diagnostic command during execution of a diagnostic command). Therefore, the control processor 910 (FIG. 9) then issues the received Soft Reset command or Executed Diagnostic command to the SATA HDD 230 according to the device reset instruction program 914 (FIG. 9) (step 1680).

After completion of the processing for the Soft Reset command or the Executed Diagnostic command at the SATA HDD 230, the control processor 910 nullifies each of the entries, excluding the entries which received the Soft Reset command, in the command queue table 1000 (FIG. 10) and the SAS address table 1100 (FIG. 11) according to the device reset instruction program 914 (FIG. 9).

Subsequently, the control processor 910 sends a reset command response to the SAS controller 125, which issued the SATA HDD 230 reset command, according to the device reset instruction program 914. After completion of the transmission of this response, the control processor 910 nullifies the entry for the relevant SAS controller 125 in the SAS address table 1100 according to the device reset instruction program 914. After completion of the nullification of this entry, the processing proceeds to step 1690 in FIG. 16A.

### (1-2-6) Processing for FIS Transfer from Drive to Host

Next, the processing sequence for transferring a SATA FIS from the SATA HDD 230 or the STP active multiplexer 300 to the SAS controller 125 will be explained below with reference to FIGS. 17A to 17C.

In this case, according to the device reset instruction program 914 (FIG. 9) and as shown in FIG. 17A, the control processor 910 (FIG. 9) described above with reference to FIG. 9 first judges, by referring to the host command queue 1000, whether or not the Soft Reset command or the Executed Device Diagnostic command is stored in the host command queue 1000 (step 1701). Incidentally, since the SATA port 500 is reset and all the commands received by the SATA HDD are discarded during the execution of the soft reset or the diagnosis, the SATA port 500 never receives a SATA FIS transfer request related to a Read/Write command from the SATA HDD 230 during the execution of the soft reset or the diagnosis.

If step 1701 returns an affirmative judgment (step 1701: YES), the control processor 910 prepares a RESPONSE FIS for responding to the soft reset or the diagnosis by the STP active multiplexer 300 according to the device reset instruction program 914. At the same time, the control processor 910 searches the SAS address table 1100 and prepares a SAS address for the STP initiator which issued the soft reset or diagnostic command (step 1702).

On the other hand, if step 1701 returns a negative judgment (step 1702: NO), the control processor 910 performs control corresponding to the type of SATA FIS according to the device reset instruction program 914, and then prepares the SATA FIS to be transferred to the SAS initiator (step 1700b).

Subsequently, the control processor 910 gives an instruction to the STP Target Upper Layer 700 to transmit a FIS to the SAS controller. Receiving the instruction of the FIS transfer request from the STP Target Upper Layer 700, the SL_CC control block 454 issues a connection request to the SAS controller 125 (step 1710). In this step 1710, the state of link between the SAS controller 125 and the STP target port 400 makes the transition to the connection response state 1430 described above with reference to FIG. 14.

When a response to the connection request (connection response) is given by the SAS controller 125 (step 1711), the SL_CC control block 454 judges whether this connection response is a rejection response (OPEN_REJECT primitive) or not (step 1712).

If the connection response received by the SL_CC control block 454 is not the rejection response (step 1712: NO), the SL_CC control block 454 establishes a connection with the SAS controller 125 (step 1713). In this step 1710, the state of link between the SAS controller 125 and the STP target port 400 makes the transition to the FIS transfer state 1440 described above with reference to FIG. 14.

Subsequently, the STP Target Upper Layer 700 transfers the FIS to the SAS controller 125 (step 1700c). After completion of the FIS transmission, the SL_CC control block 454 terminates the connection between the SAS controller 125 and the STP target port 400 (step 1790). Incidentally, if the STP initiator port terminates the connection between the SAS controller 125 and the STP target port 400 in response to a CLOSE (CLEAR AFFILIATION) primitive, the SL_CC control block 454 can nullify the relevant entry in the SAS address table 1100 (FIG. 11).

On the other hand, if the connection response received in step 1711 is the rejection response (step 1712: YES), the SL_CC control block 454 judges, according to the types of OPEN_REJECT, whether retry is possible or not (step 1714). For example, OPEN_REJECT (NO DESTINATION), OPEN_REJECT (RETRY), etc. are the types of OPEN_REJECT enabling the SL_CC control block 454 to retry issuing the connection request for a certain period of time (for example, until the threshold value for I_T Nexus Loss timer is reached). If step 1714 returns an affirmative judgment (step 1714: YES), the processing returns to step 1710 and the SL_CC control block 454 issues the connection request to the SAS controller 125 until the count value of the I_T Nexus Loss timer becomes the time-out value.

When the count value of the I_T Nexus Loss timer exceeds the time-out value, the SL_CC control block 454 aborts the issuance of the connection request and discards all the commands relating to I_T Nexus (step 1715).

On the other hand, FIG. 17B shows a specific processing sequence for the FIS transmission preparation processing in step 1700b in FIG. 17A. When the processing proceeds to step 1700b in FIG. 17A, the control processor 910 first judges according to the error response transmission program 913, by referring to the error response FIS transmission flag stored in the error response FIS transmission flag field 1190 in the SAS address table 1100, whether it is necessary to send an error response FIS or not (step 1720).

If step 1720 returns an affirmative judgment (step 1720: YES), the control processor 910 prepares for transmission of the error response FIS to be sent to the SAS controller for the STP Target Upper Layer 700 according to the error response transmission program 913 by referring to the error response FIS transmission flag stored in the error response FIS transmission flag field 1190 in the SAS address table 1100 (step 1721). Subsequently, the processing proceeds to step 1710 in FIG. 17A.

On the contrary, if step 1720 returns a negative judgment (step 1720: NO), the control processor 910 judges according to the error response transmission program 913 whether or not the type of SATA FIS to be sent to the SAS controller 125 is data or DMA_ACTIVATE (step 1730). If the type of the SATA FIS is the data or DMA_ACTIVATE, the device command state checker 752 (FIG. 7) for the STP Target Command Layer Block 750 (FIG. 7) judges whether the STP active multiplexer 300 has already sent a DMA_SETUP to the STP initiator (step 1731). The device command state checker 752 stores the type of the FIS sent or received last time, and can thereby determine what type of FIS to be sent next time. If any FIS other than the FIS which should be sent is to be sent, there is a possibility that the STP active multiplexer 300 program may have fallen into self-contradiction, and it is possible to detect a failure in the STP active multiplexer 300 itself.

If step 1731 returns a negative judgment (step 1731: NO), the control processor 910 searches for the SAS address for the STP initiator corresponding to the tag number of the DMA_SETUP according to the SAS address/command mapping program 912 (step 1732). Also, the control processor 910 prepares for the transmission of the data or DMA_ACTIVATE received from the SATA HDD 230 to the SAS controller 125 (step 1733). Subsequently, the processing proceeds to step 1710 in FIG. 17A.

On the contrary, if step 1731 returns a negative judgment (step 1731: NO), this means that the data or the DMA_ACTIVATE was received in an improper condition from the SATA HDD 230. Therefore, in this case, the device command state checker 752 for the STP Target Command Layer Block 750 (FIG. 7) discards the SATA FIS and resets the SATA port 500 (step 1734). At the same time, the control processor 910 prepares for the transmission of an error response notice to the device which issued the relevant command. Subsequently, the processing proceeds to step 1710 in FIG. 17A.

On the other hand, if the type of the SATA FIS to be sent to the SAS controller 125 is not the data or the DMA_ACTIVATE (step 1730: NO), the control processor 910 judges according to the SAS address/command mapping program 912, by referring to the host command queue 1000, whether there is a command corresponding to the SET_DEVICE_BIT or DMA_SETUP received from the SATA HDD 230 (step 1751).

If step 1751 returns a negative judgment (step 1751: NO), the device command state checker 752 (FIG. 7) for the STP Target Command Layer Block 750 (FIG. 7) discards the improper FIS (step 1752). If the control processor 910 can determine to which command issued by which STP initiator the error corresponds, by referring to the tag of the relevant command and the SAS address for the SAS controller by referring to the SAS address/command mapping program 912 and the host command queue 100, the control processor 910 prepares for the issuance of an error response FIS to the STP initiator corresponding to that command (step 1753). Incidentally, if the tag is improper, it does not match with any entry in the host command queue 1000 table. In this case, the control processor 910 prepares for the issuance of the error response FIS to all the STP initiators registered with the SAS address table 1100 (FIG. 11) (step 1753). Incidentally, it is necessary to repeatedly establish connections, and prepare for the FIS transfer, and execute a request for the FIS transfer and to repeatedly execute the entire sequence until the transmission of the error response FIS to all the SAS controllers is completed. However, such repeated operations described above are not shown in this sequence diagram. Subsequently, the processing proceeds to step 1710 in FIG. 17A.

On the other hand, if step 1751 returns an affirmative judgment (step 1751: YES), the same processing as that for steps 1732 and 1733 is executed in the following steps 1754 and 1755. Subsequently, the processing proceeds to step 1710 in FIG. 17A.

Meanwhile, FIG. 17C shows a specific processing sequence executed in step 1700c in FIG. 17A.

When the processing proceeds to step 1700c in FIG. 17A, the STP target port 400 transfers the FIS received from SATA HDD 230 to the SAS controller 125 (step 1760).

Subsequently, the SATA Device Link Layer Block 470 (FIG. 4) judges whether or not R_OK is received as the result of the FIS transmission (step 1761). If step 1761 returns an affirmative judgment (step 1761: YES), the SATA Device Link Layer Block 470 determines that the FIS transmission to the STP initiator is completed normally and then gives an instruction to the SL_CC control block 454 to terminate the connection (step 1762).

On the contrary, if step 1761 returns a negative judgment as a result of reception of an R_ERR by the SATA Device Link Layer Block 470 (step 1761: NO), the processing branches off depending on the FIS type sent by the SATA Device Link Layer Block 470 (step 1770). If step 1770 returns an affirmative judgment (step 1770: YES), this is the case where the SATA Device Link Layer Block 470 received the R_ERR while sending the DATA FIS. The control processor 910 executes the following operation in response to the R_ERR reception report from the SATA Device Link Layer Block 470. The control processor 910 returns to the SATA port 500 a reception response by means of the R_ERR for the DATA FIS received from the SATA HDD 230. Next, the control processor 910 aborts the reception processing for receiving the DATA FIS from the SATA HDD 230 and the operation of the STP target port to transfer the DATA FIS to the SAS controller (step 1771).

Subsequently, the control processor 910 prepares for transmission of the error response FIS sent from the SATA HDD 230 (step 1772). If a success response is returned from the SATA HDD 230, the control processor 910 discards the success response and prepares for the transmission of the error response FIS 1200, including the additional error code corresponding to the CRC error, to the SAS controller 125 (step 1772). Subsequently, the processing proceeds to step 1700a in FIG. 17A.

On the other hand, if step 1770 returns a negative judgment (if R_ERR is received in response to RESPONSE FIS), this is the case where the SATA Device Link Layer Block 470 received the R_ERR while sending the FIS of the FIS type other than the DATA FIS. In this case, the control processor 910 prepares for retransmission of the RESPONSE in response to the R_ERR reception report from the SATA Device Link Layer Block 470 (step 1781). Subsequently, the processing proceeds to step 1700a in FIG. 17A.

### (1-2-7) Link-Down Recovery Processing During FIS Transfer

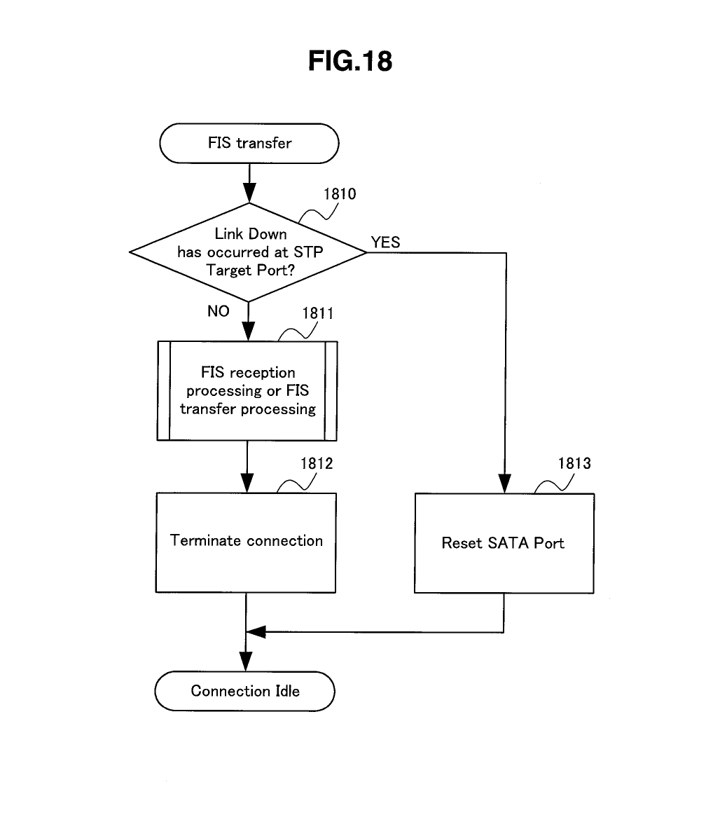

FIG. 18 shows a sequence of processing executed when the link-down occurs at the STP target port 400 while the link state of the STP active multiplexer 300 is the FIS transfer state 1440 described above with reference to FIG. 14.

Since the STP target port 400 updates the port state table 1300 regardless of whichever link state described in FIG. 14 the STP target port 400 is in, the 3-port SP control block 970 can detect, independently from other programs by referring to the port state stable 1300, whether or not the link-down has occurred (step 1810). For example, the following method may be used: when the 3-port SP control block 970 detects a change in the link state, it may give an interrupt to the control processor, so that the control processor 910 will detect the change in the link state in the FIS transfer state. If the link-down is detected while the link state of the STP target port 400 is the FIS transfer state, the processing proceeds to step 1810. If the link-down is not detected (step 1810: NO), the STP target port 400 continues the FIS reception processing described above with reference to FIG. 16B and the FIS transfer processing described above with reference to FIG. 17C (step 1811). After completion of the FIS reception processing or the FIS transfer processing, the connection between the SAS initiator and the STP target port 400 is terminated (step 1812).

On the other hand, if the 3-port SP control unit 970 detects the link-down during the FIS transfer by the STP target port 400 (step 1810: YES), the control processor 910 gives an instruction to reset the SATA port based on the state of the 3-port SP control unit 970. This is because the recovery processing other than reset cannot be executed after the occurrence of the link-down during the FIS transfer and, therefore, it is necessary to reset the SATA port 500 and discard all the commands. However, the SATA port may be separated from the crossbar switch 610 (FIG. 6) without resetting the SATA port 500, an error response requiring the reset processing may be sent to the SAS initiator, and then the SATA port 500 may be reset in accordance with an instruction from the SAS initiator.

### (1-2-8) Link-Down Recovery Processing Where Connection is Not Established

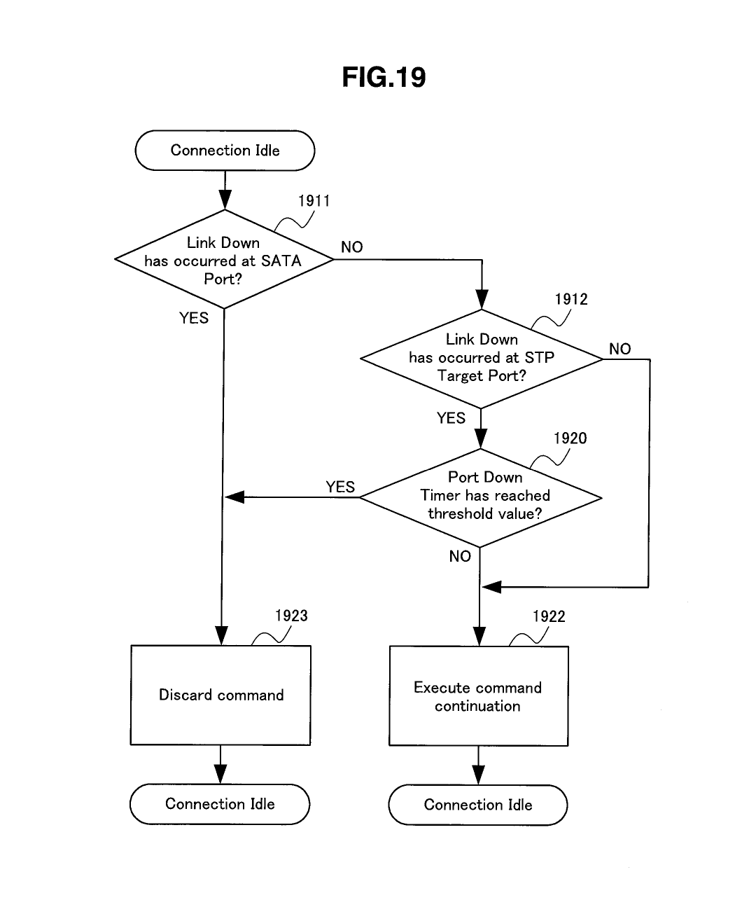

FIG. 19 shows a processing sequence executed when the link-down occurs at the STP target port 400 while the link state of the STP active multiplexer 300 is the connection idle state 1420 described above with reference to FIG. 14.

Since the STP target port 400 updates the port state table 1300 regardless of whichever link state described in FIG. 14 the STP target port 400 is in, the 3-port SP control block 970 can detect, independently from other programs by referring to the port state stable 1300, whether or not the link-down has occurred (step 1810). If the occurrence of the link-down is detected while the link state of the STP target port 400 is the Connection Idle state (step 1911: YES), the processing proceeds to step 1923. If the link-down has not occurred at the SAT port 500, but the link-down has occurred at either the SATA port 500 or the STP target port 400 while the link state of the STP target port 400 is the Connection Idle state (step 1912: YES), the processing proceeds to step 1920. If the link-down has not occurred at either the SATA port 500 or the STP target port 400 while the link state of the STP target port 400 is the Connection Idle state (step 1912: NO), the processing proceeds to step 1922.

If the occurrence of the link-down is detected at the SATA port 500 (step 1911: YES), the SATA HDD is reset along with the link-down at the SATA port 500 and, therefore, the SATA discards all the commands stored in the SATA HDD (step 1923). If the link-down has not occurred at the SATA port 500, but the link-down has occurred at the STP target port 400 while the link state of the STP target port 400 is the Connection Idle state (step 1912: YES), the 3-port SP control unit 970 activates the port down timer in accordance with the state machine 1500 and judges whether the count value of the port down timer has reached the threshold value or not (step 1920). If the count value of the port down timer has reached the threshold value (step 1920: YES), the 3-port SP control unit 970 resets the SATA port 500 and then discards all the commands (step 1923).

On the contrary, If the link-down has not occurred at either the SATA port 500 or the STP target port 400 while the link state of the STP target port 400 is the Connection Idle state (NO in 1911 and NO in step 1912), or if the link with the STP target port 400 is established before the count value of the port down timer reaches the threshold value (step 1920: NO), the following operation will be performed. Since the SL_CC control block 454 can issue the connection request to the SAS controller 125 again, the SL_CC control block 454 issues the connection request and continues execution of the command (step 1922).

### (1-2-9) Various Types of Processing Sequences

Next, the processing sequence for exchanging frames and primitives between the SAS controller 125, SAS expander 130 (FIG. 1), the STP target port 500 and STP target port 400 for the STP active multiplexer 300 (FIG. 3), and the SATA HDD 230 will be explained.

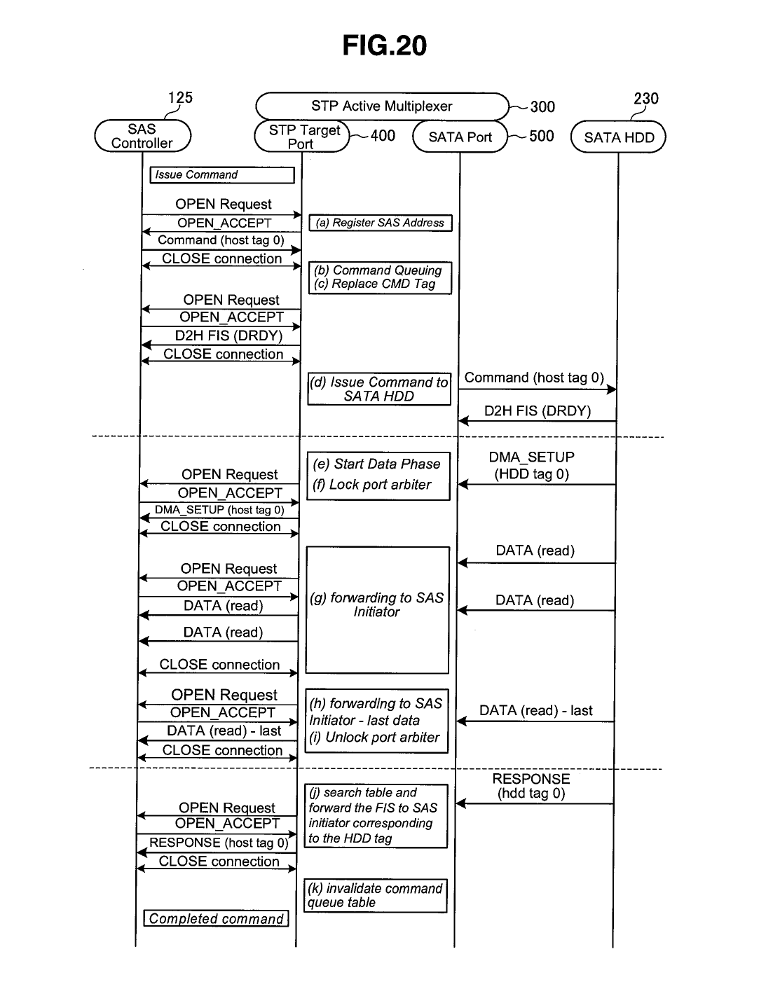

FIG. 20 shows a processing sequence from the issuance of a read command from the SAS controller 125 to the normal completion of the read processing. The STP active multiplexer 300 executes processing (a) to (k).

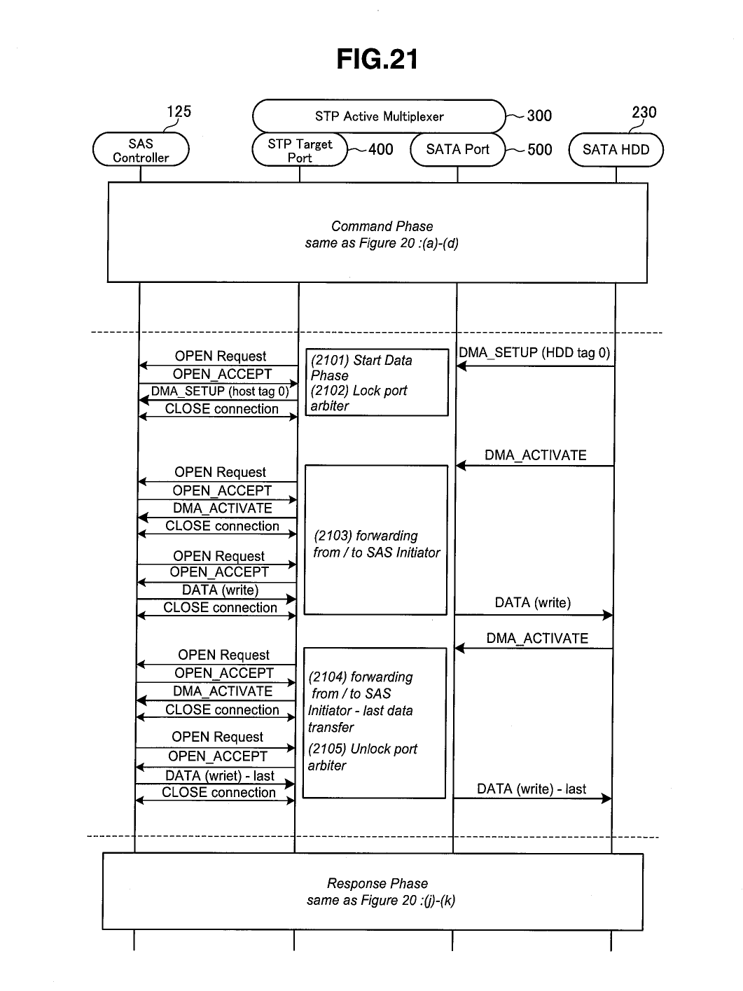

FIG. 21 shows a processing sequence from the issuance of a write command from the SAS controller 125 to the normal completion of the write processing. The STP active multiplexer 300 executes processing from steps 2100 to 2105 in the write data transmission phase.

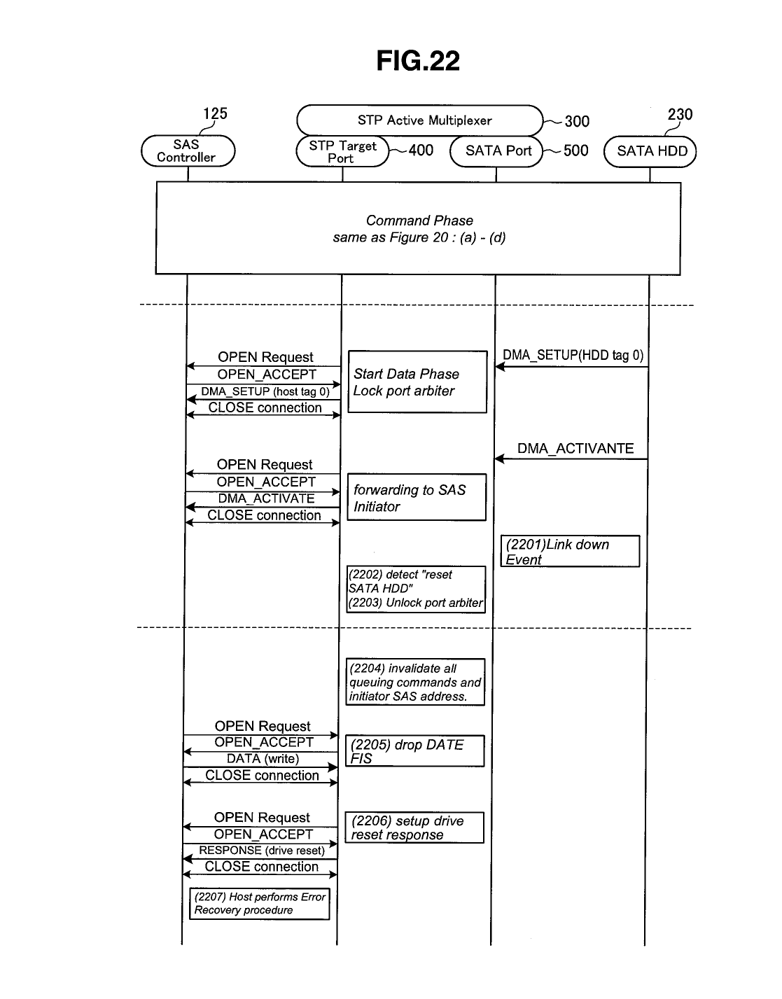

FIG. 22 shows a processing sequence when the link-down occurs at the SATA port 500 during execution of a write command. After the link-down occurs in step 2201, the STP active multiplexer 300 executes processing from step 2202 to step 2206. Since the SAS controller 125 can recognize a response about resetting of the SATA HDD 230, the device driver controlling the SAS controller 125 can perform error recovery 2207 at arbitrary timing or sequence for the device driver in response to the reset of the SATA HDD 230.

Incidentally, If the link between the STP active multiplexer 300 and the SATA HDD 230 is temporarily terminated whether or not a command is being executed, and if the STP active multiplexer 300 receives a new command from the SAS controller 125, the STP active multiplexer 300 notifies all the connected SAS controllers 125 that the SATA HDD 230 has been reset (“RESPONSE (drive reset)” in FIG. 22).

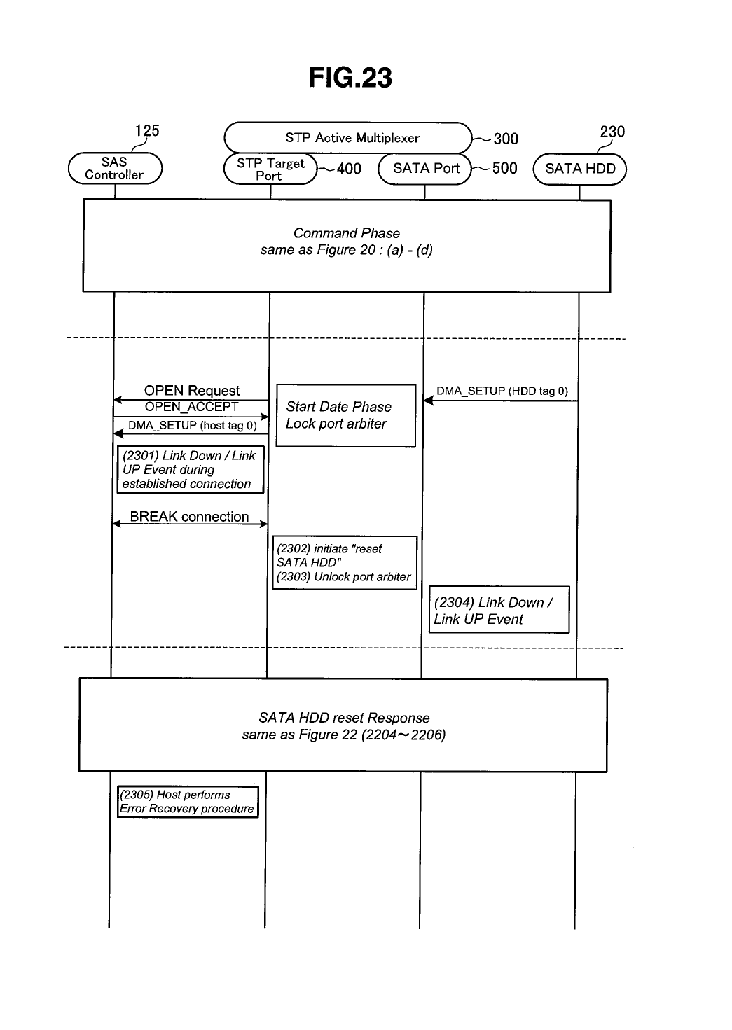

FIG. 23 shows a processing sequence executed when the link-down occurs at the STP target port 400 during FIS transfer. If the link-down occurs at the STP target port 400 in step 2301, the STP active multiplexer 300 executes processing from step 2302 to step 2303. This embodiment describes the case where the STP active multiplexer 300 automatically resets the SATA port 500, but there is another possible method whereby the STP active multiplexer 300 issues an error response to the host 100 and the host gives a reset instruction.

Incidentally, if the STP active multiplexer 300 detects the termination of link with the SAS controller 125 where the connection between the STP active multiplexer 300 and the SAS controller 125 is established, the STP active multiplexer 300 does not terminate the link with another redundant SAS controller 125, and notifies that other SAS controller 125 that the SATA HDD 230 has been reset.

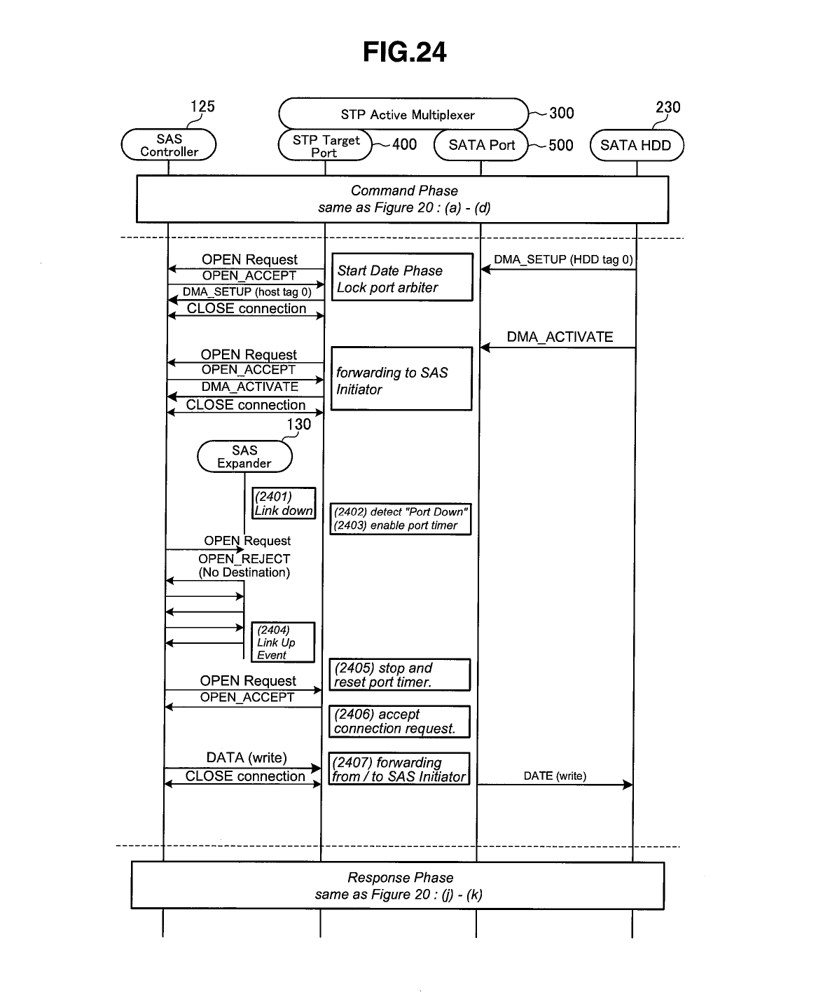

FIG. 24 shows a processing sequence executed when the link-down occurs at the STP target port 400 in the connection idle state 1420 (FIG. 14). In this example, the link-down occurs in step 2401 and the port down timer is activated in step 2403. This is the case where the port down timer does not expire when the link is established in the following step 2404. Subsequently, the connection is normally established (step 2406) and the data transfer is carried out in the ordinary manner (step 2407).

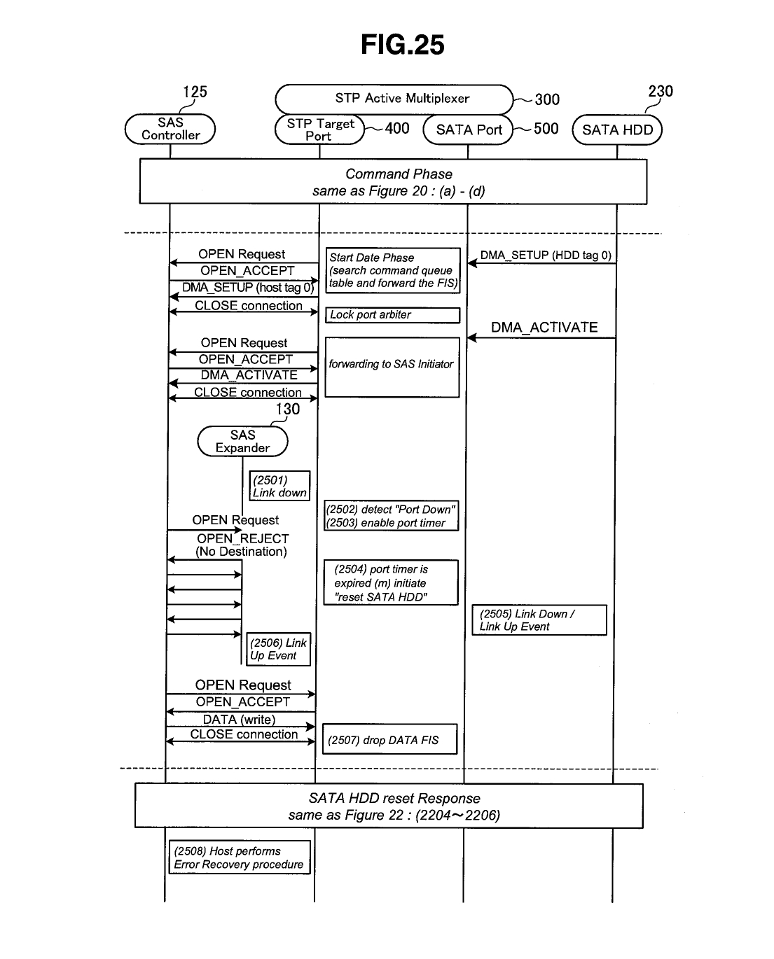

FIG. 25 shows a processing sequence executed when the link-down occurs at the STP target port 400 in the connection idle state 1420. In this example, the link-down occurs in step 2502 and the port down timer is activated in step 2503. This is the case where the port down timer then expires (step 2504) before the link is established in step 2506.

If the inaccessible state of the port for another redundant device is maintained for a long period of time in the above-described example, the port for that other redundant device remains locked and the state where another redundant SAS controller 125 cannot be access will continue. In conventional storage apparatuses, there is no mechanism for recognizing this problem. Therefore, the command is aborted and the SATA port 500 is reset (step 2504), and improper frames from the SAS controller 125 are discarded (step 2507). A notice of reset of the SATA HDD 230 (or instruction requiring reset control) is sent to the SAS controller 125, and the host 100 performs error recovery in response to the above reset notice (step 2508).

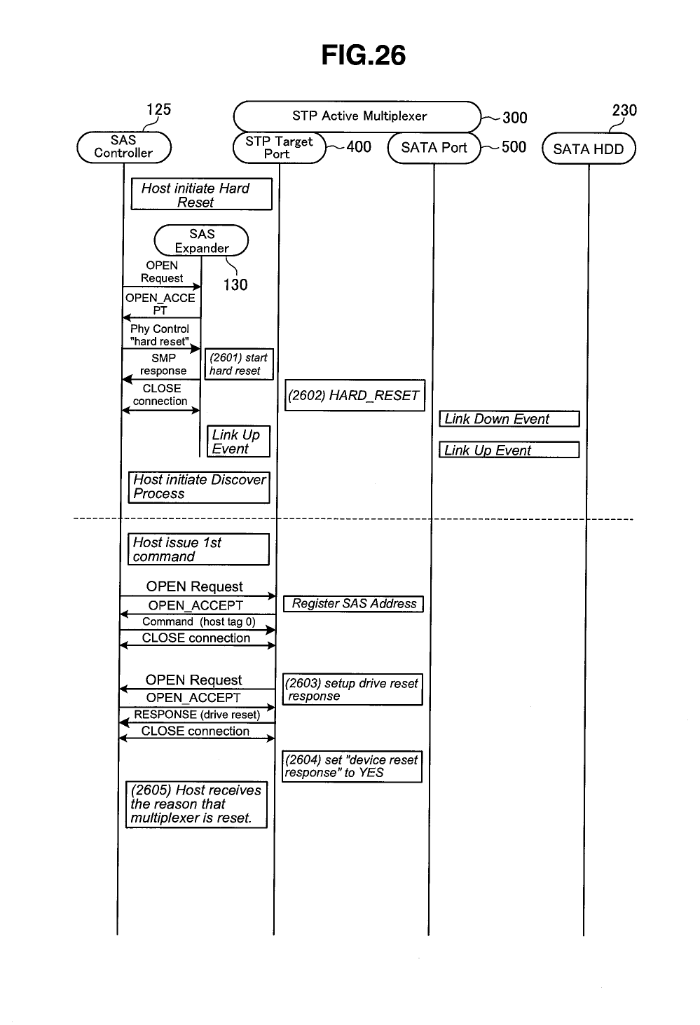

FIG. 26 shows a processing sequence executed when the host driver performs hard reset. The SAS expander 130 performs the hard reset of the requested port in response to a request from the SAS controller 125 (step 2601). When detecting the OOB signal of the hard reset sequence, the STP active multiplexer 300 also performs the hard reset of the STP active multiplexer 300 (step 2602). A command issued for the first time after the completion of the hard reset of the STP active multiplexer 300 is not executed and a reset completion response is returned (from step 2603 to step 2604). Upon reception of the response indicating the normal completion of the hard reset (step 2605), the host driver can execute normal I/O by retrying the command. The advantage of this sequence is that if the hard reset has terminated abnormally, the host driver can easily recognize it.

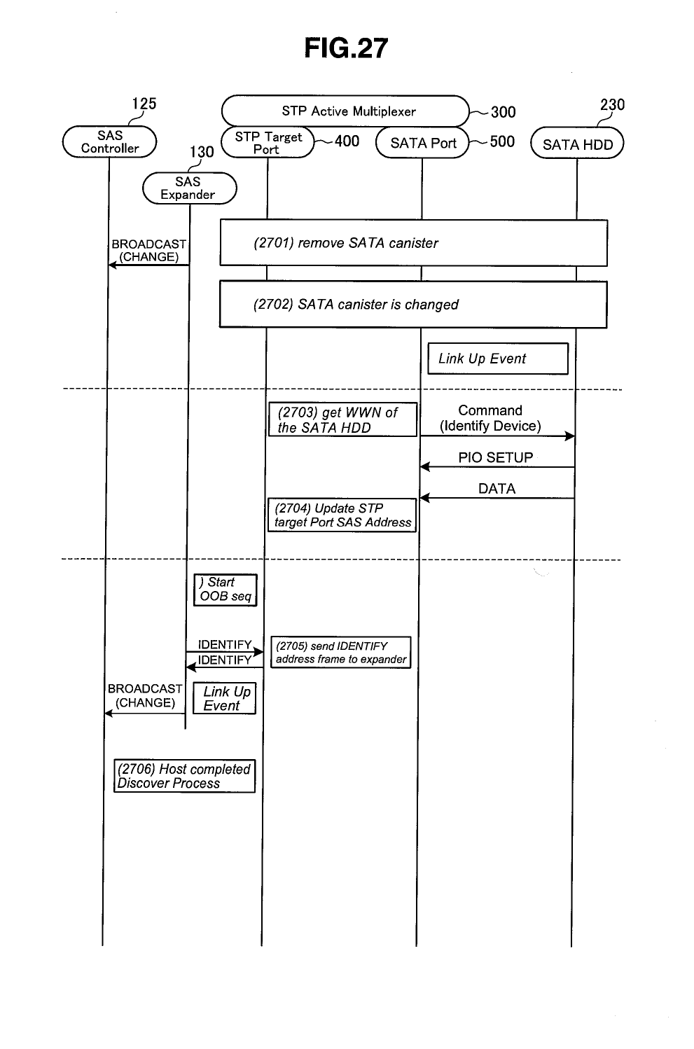

FIG. 27 shows a processing sequence executed when the SATA canister 200 or the SAS expander 130 is replaced. If the SATA canister 200 is replaced, the WWN of the SATA HDD 230 changes. Also, if the SAS expander 130 is replaced, the SAS address for the SAS expander 130 changes. A problem of conventional examples is that replacement of the SAS expander 130 causes a change of the address for the STP/SATA Bridge included in the SAS expander 130 and, therefore, the SAS address even for the same SATA HDD 230 may change.

When the power to the STP active multiplexer 300 or the SATA HDD 230 is turned on, the address for the SATA HDD 230 is read (step 2703) and the address for the STP target port 400 is updated (step 2704) in this sequence. Therefore, even if the SAS expander 130 is replaced, the unique address for the STP target port 400 is decided at the time of power-on. As an Identification sequence is executed between the SAS expander 130 and the STP active multiplexer 300 (step 2705), the SAS expander 130 acquires the SAS address for the STP target port 400. As a result, when the host driver performs discovery process (step 2706), the SAS address for the STP target port 400 will not change unless the SATA HDD 230 is replaced with another SATA HDD with a different identification number, so that the address management with storage control programs is facilitated.

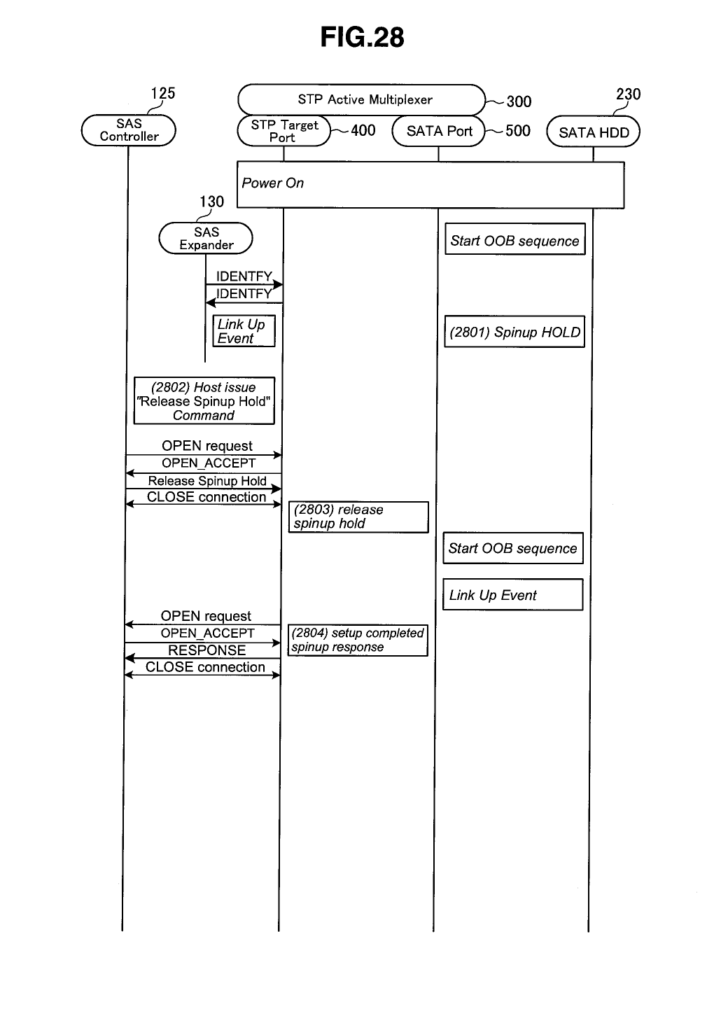

FIG. 28 shows a processing sequence for spinup control of the SATA HDD 230. After the link is established, the SATA HDD 230 aborts the link reset sequence in a Spinup HOLD state where the spinup of the SATA HDD 230 is temporarily aborted (step 2801). After the host driver issues a command for releasing the spinup hold to the STP active multiplexer 300 (step 2802), the STP active multiplexer 300 gives an instruction to restart the link reset sequence at the SATA port 500 (step 2803), thereby completing the spinup of the SATA HDD 230 and the link reset sequence. Subsequently, the STP active multiplexer 300 returns a response to the command for releasing the spinup hold (step 2804).

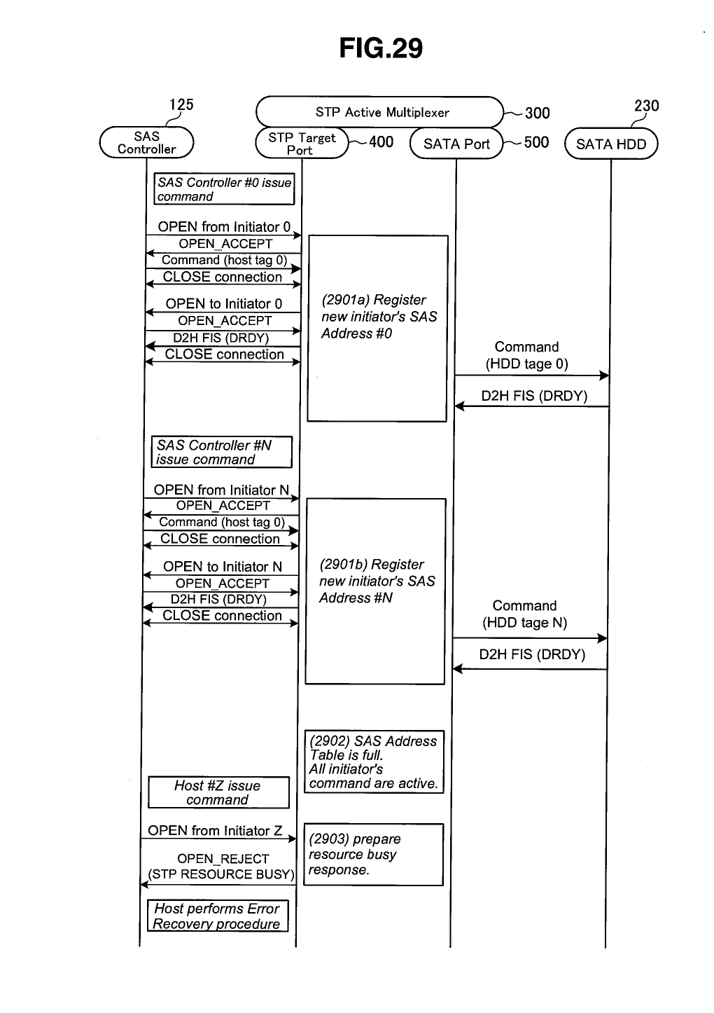

FIG. 29 shows a processing sequence executed when the SAS address table 1100 (FIG. 11) lacks resources. After the SAS controller 125 issues a command, the STP active multiplexer 300 registers the SAS address for the STP initiator with SAS address table 1100 and increments the number of queued commands (step 2901a). When four SAS initiators issue commands successively, all the entries in the SAS address table 1100 become valid and one or more commands are being executed (step 2902). In this situation, additional entries cannot be registered with the SAS address table 1100 and a connection request from the next different SAS controller 125 cannot be accepted. As a result, the STP target port 400 returns the OPEN_REJECT (STP_RESOURCE_BUSY) primitive (step 2903).

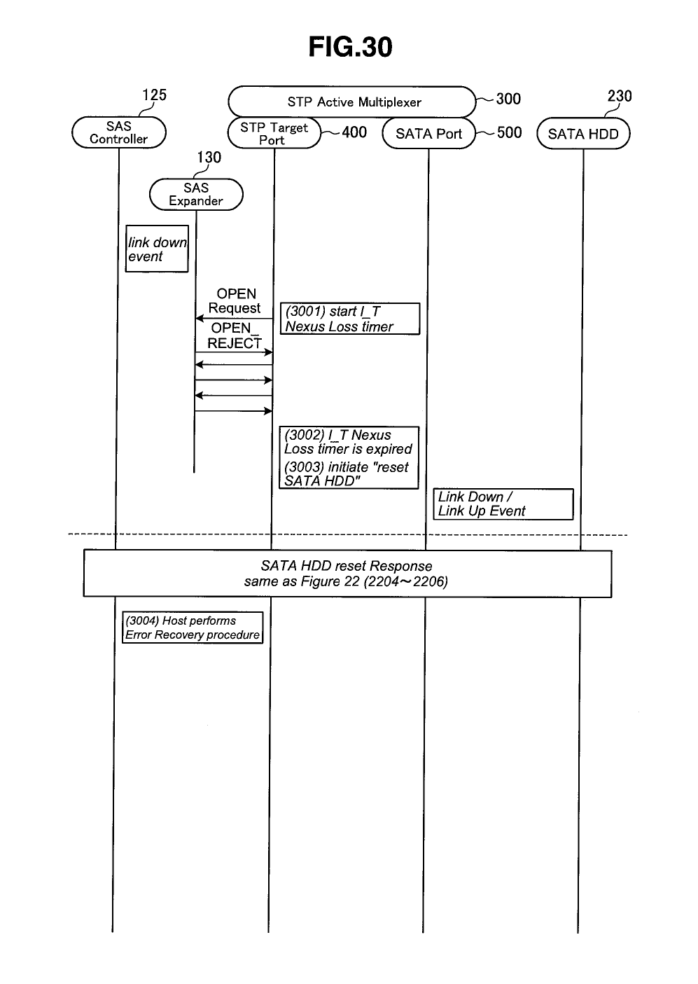

FIG. 30 shows a processing sequence executed when a failure occurs between the SAS controller 125 and the SAS expander 130 and a connection request issued by the STP target port 400 does not reach the SAS controller 125. If the link-down occurs between the SAS controller 125 and the SAS expander 130, the SAS expander 130 returns an OPEN_REJECT (NO DESTINATION) primitive as a response to the connection request issued by the STP target port.

When the STP target port 400 receives this response, the I_T Nexus Loss timer is started at the STP active multiplexer 300 (step 3001). When this timer expires (step 3002), the STP active multiplexer 300 discards the commands then stored therein. This is done in order to avoid the situation where a command to the STP target port 400 for another redundant device cannot be executed, because the STP target port 400 for another redundant device cannot transfer a FIS to the SATA port 500 while the STP target port 400 for the STP active multiplexer 300 retries issuing the connection request. When this happens, the STP active multiplexer 300 may reset the SATA port 500 (step 3003), or the host driver may give an instruction to control the reset of the SATA port 500 after sending the error response indicating the occurrence of I_T Nexus Loss to the SAS controller. By returning the response to all the host drivers, for which SATA HDD 230 the host driver should perform the recovery control becomes apparent.

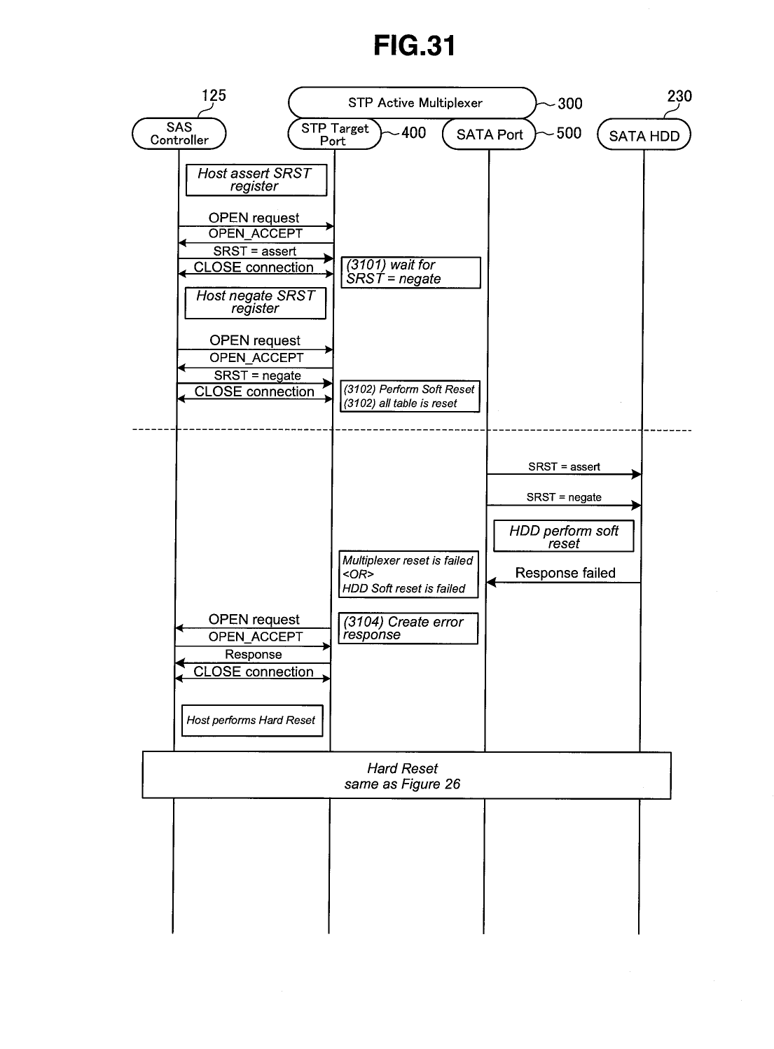

FIG. 31 shows a processing sequence executed when the host driver issues a soft reset command. The host driver asserts an SRST register for soft reset, and the STP active multiplexer 300 waits for deassertion (step 3101). Subsequently, after deasserting the SRST register, the STP active multiplexer 300 performs soft reset (step 3102) and resets all the tables in the STP active multiplexer 300 (FIGS. 11 to 13) (step 3103). When this happens, only the SAS address for the STP initiator which controls the soft reset remains valid. Subsequently, the STP active multiplexer 300 also issues the soft reset to the SATA HDD 230. If the soft reset of the SATA HDD 230 fails, the STP active multiplexer 300 generates an error response (step 3104), and reports the error to the STP initiator that issued the soft reset.

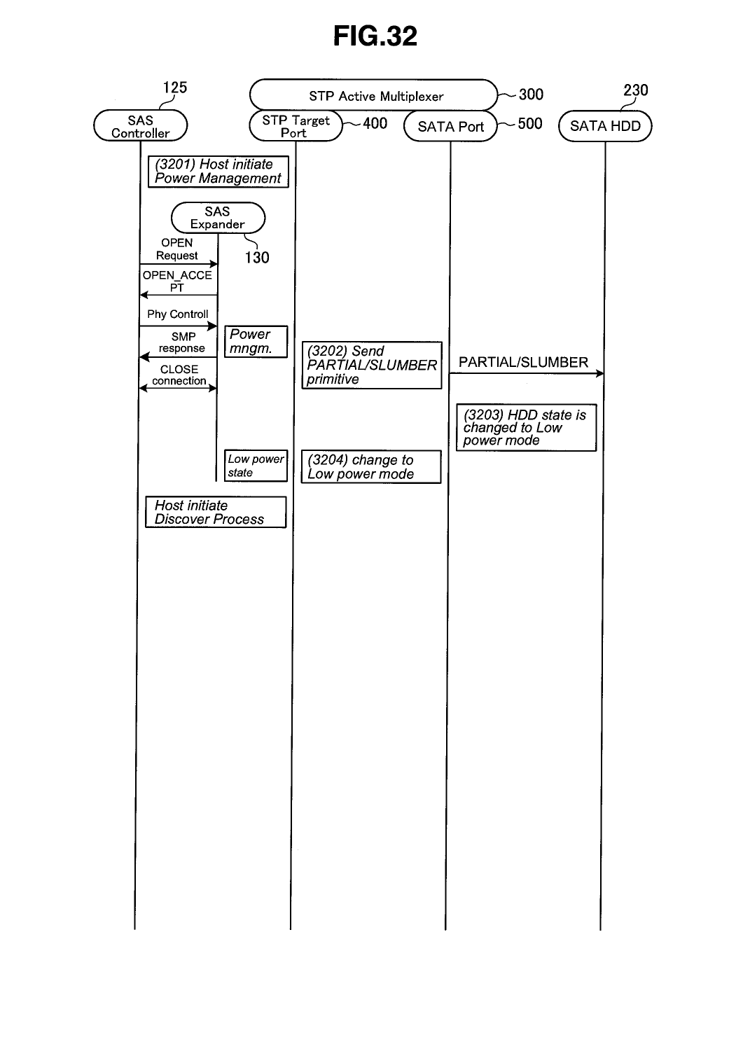

FIG. 32 shows a processing sequence executed when the STP target port 400 receives a PM_PARTIAL primitive or PM_SLUMBER primitive for power supply control from the SAS expander 130. After the host driver issues a power supply control command to the SAS expander 130 (step 3201), the STP active multiplexer 300 controls the power supply to the SATA HDD 230 (step 3202). If the power supply state of the SATA HDD 230 changes later (step 3203), the power supply state of the STP active multiplexer 300 makes the transition to a low power consumption state (step 3204).

### (1-3) Advantageous Effects of this Embodiment

The host system 1 according to this embodiment described above is configured so that the STP active multiplexer 300 has the function judging whether a frame of whatever type from the SAS controller 125 is proper or not; and if the frame of whatever type is improper, the STP active multiplexer 300 discards the frame without transferring it to the SATA HDD 230, and at the same time, the STP active multiplexer 300 sends the corresponding error response to the SAS controller 125. Therefore, if a failure caused by inconsistency between the state of the SAS controller 125 and the state of the SATA HDD 230 occurs, the SAS controller 125 can easily identify the location where the relevant failure occurred. As a result, the host system 1 can minimize the area affected by the failure and prevent the situation where the processing for an input/output request from the host would remain stopped for a long period of time. Therefore, because of the failure processing completed in a short period time, the reliability of the entire host system 1 having even a large-scale configuration can be improved.

### (2) Second Embodiment

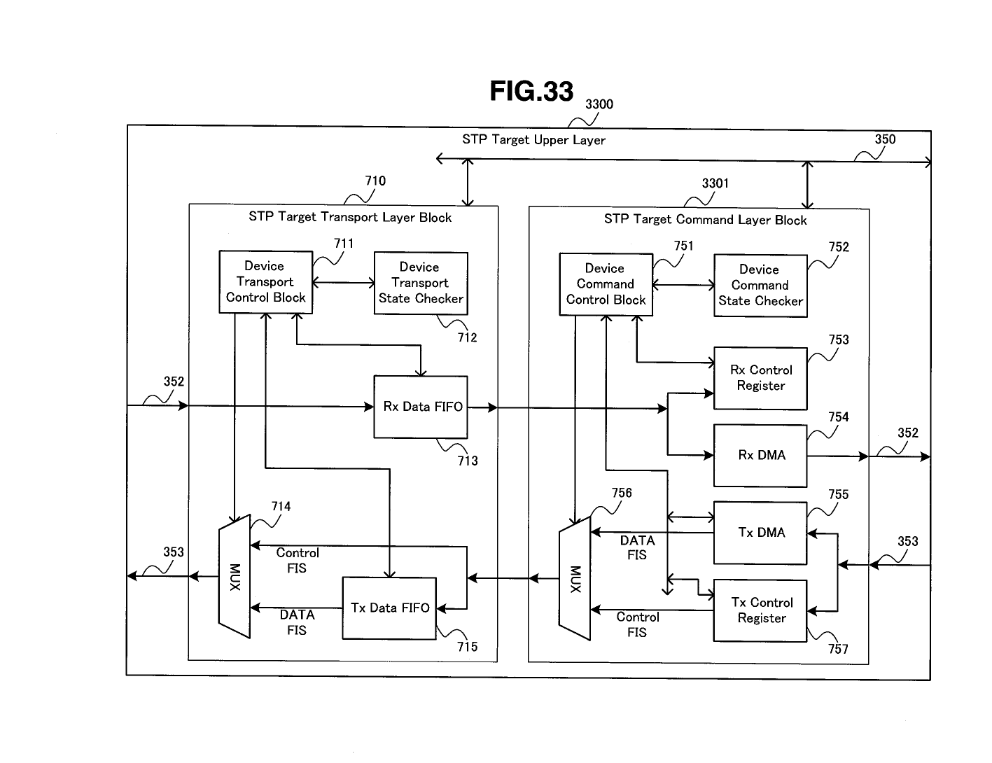

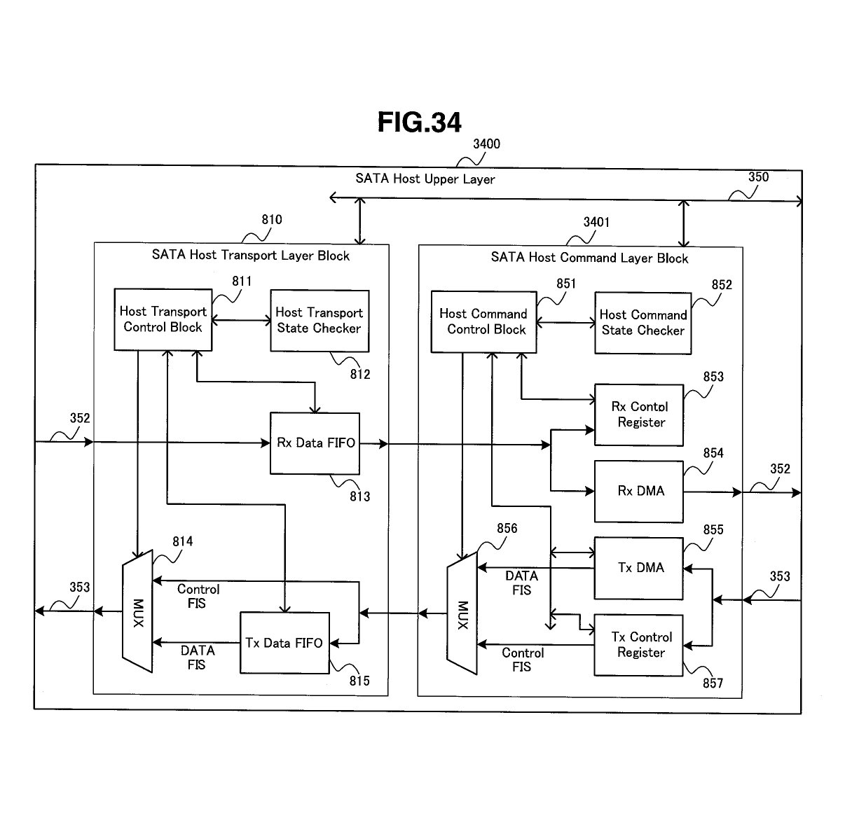

FIG. 33 shows an STP Target Upper Layer 3300 according to the second embodiment, wherein the elements corresponding to those in FIG. 7 are given the same reference numerals as in FIG. 7. FIG. 34 shows a SATA Host Upper Layer 3400 according to the second embodiment wherein the elements corresponding to those in FIG. 8 are given the same reference numerals as in FIG. 8.

The difference between the STP Target Upper Layer 3300 according to the second embodiment and the STP Target Upper Layer 700 (FIG. 7) according to the first embodiment is that in the STP Target Upper Layer 700, an Rx DMA 754 and a Tx DMA 755 are added to a data transfer path in a SATA host command layer block 3301 for the STP Target Upper Layer 3300. Similarly, the difference between the SATA Host Upper Layer 3400 according to the second embodiment and the SATA Host Upper Layer 800 (FIG. 8) according to the first embodiment is that an Rx DMA 854 and a Tx DMA 855 are added to a data transfer path in a SATA host command layer block 3401 for the SATA Host Upper Layer 3400.

In the STP target upper layer 700 and the SATA Host Upper Layer 800 according to the first embodiment, a SATA DATA FIS is directly transferred between the STP target port 400 and the SATA port 500.

On the contrary, in this embodiment, the STP target upper layer 3300 and the SATA Host Upper Layer 3400 stores the SATA DATA FIS once in the data buffer 950 (FIG. 9) for the multiplexer controller block 900 (FIG. 9). As a result, since the SATA DATA FIS is stored once in the data buffer 950, even if the link rate on the SATA port 500 side is low, the SAS controller 125 does not have to transfer the SATA DATA FIS at the low link speed on the SATA port 500 side, thereby improving the performance.

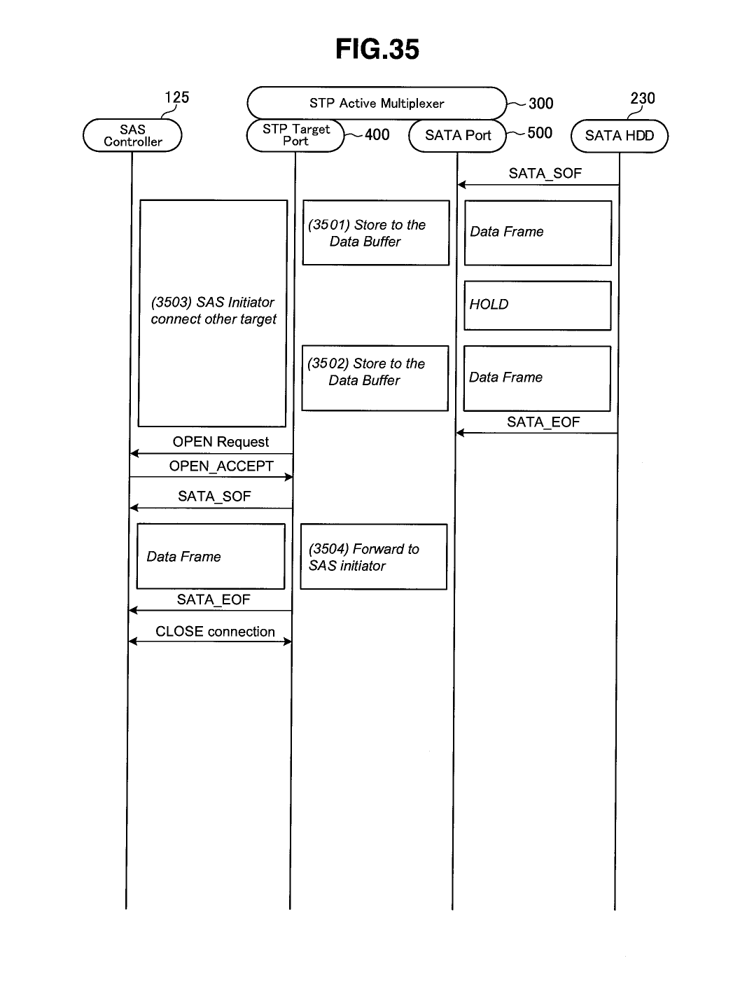

FIG. 35 shows a processing sequence executed when read data is transferred using the data buffer 950. After receiving read data from the SATA HDD 230, an STP active multiplexer 3500 according to this embodiment equipped with the above-described STP target upper layer 3300 (FIG. 33) and SATA Host Upper Layer 3400 (FIG. 34) stores the received data in the data buffer 950 for the multiplexer controller block 900 (step 3501, step 3502). Meanwhile, the SAS controller 125 can establish a connection with another device (step 3503). Subsequently, when the transmission of the read data stored in the data buffer 950 between the SAS controller 125 and the STP target port 400 is ready, a connection is established between the SAS controller 125 and the STP target port 400. Subsequently, the STP active multiplexer 300 transfers the data to the SAS controller 125 at high speed (step 3504).

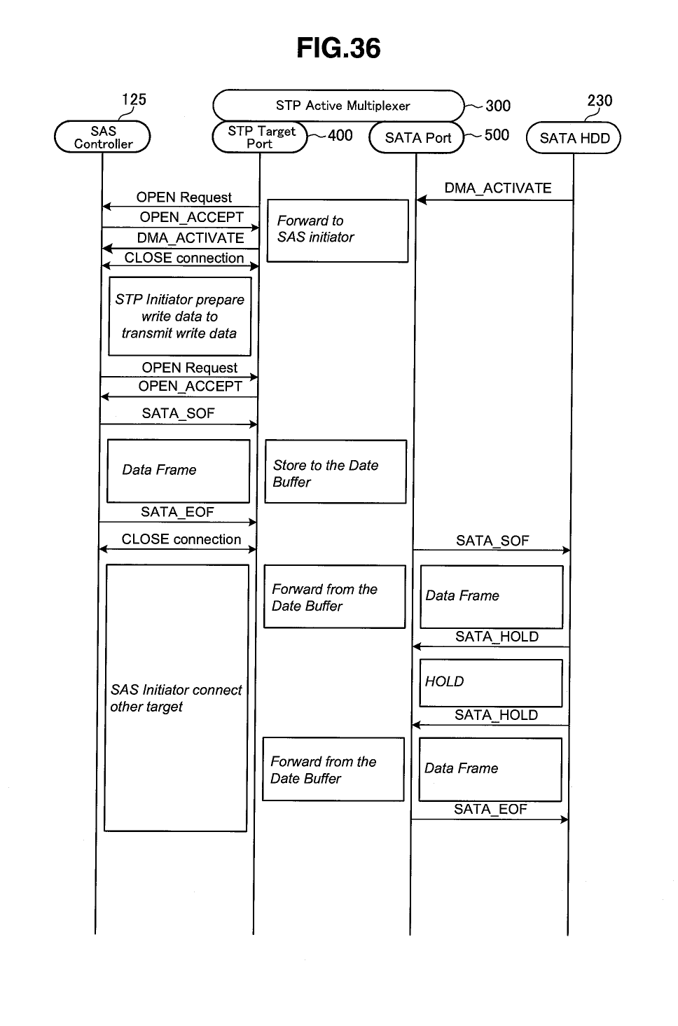

FIG. 36 shows a processing sequence executed when write data is transferred using the data buffer 950. The STP active multiplexer 3500 stores the write data received from the SAS controller 125 in the data buffer 950 for the multiplexer controller block 900 and terminates the connection with the SAS controller 125. As a result, while the STP active multiplexer 3500 transfers the data to the SATA HDD 230 at low speed, the SAS controller 125 can transfer the data to another device at high speed.

According to this embodiment described above, data sent and received between the SAS controller 125 and the SATA HDD 230 is buffered using the data buffer 950. As a result, the SAS controller 125 can be utilized effectively and the advantageous effect of improving the performance of the entire disk array apparatus 120 can be achieved in addition to the advantageous effects of the first embodiment.

### (3) Other Embodiments

The aforementioned first and second embodiments describe the case where the SATA HDD 230 is used as a storage device for storing data. However, the invention is not limited to this example; and, for example, a semiconductor memory or an optical disk device may be used as the storage device.

Moreover, the aforementioned first and second embodiments describe the case where the multiplexer (STP active multiplexer 300) for multiplexing ports for the storage device is configured as shown in FIGS. 3 to 13. However, the configurations of the multiplexer are not limited to such configurations, and a wide variety of other configurations can be used.

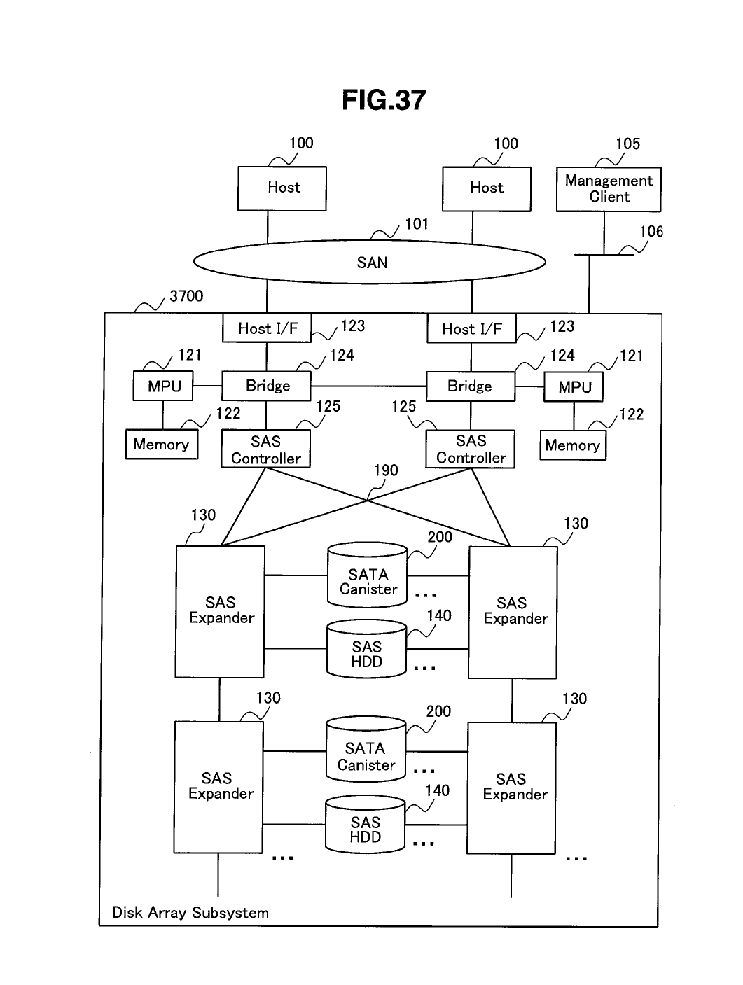

Furthermore, the first and second embodiments describe the case where one SAS controller 125 is connected to one SAS expander 130. However, the invention is not limited to this example; and, for example, as shown in FIG. 37 in which the corresponding parts are given the same reference numerals as in FIG. 1, the respective SAS controllers 125 and SAS expanders 130 that are made redundant in a disk array apparatus 3700 may be connected to each other via alternate paths 190.

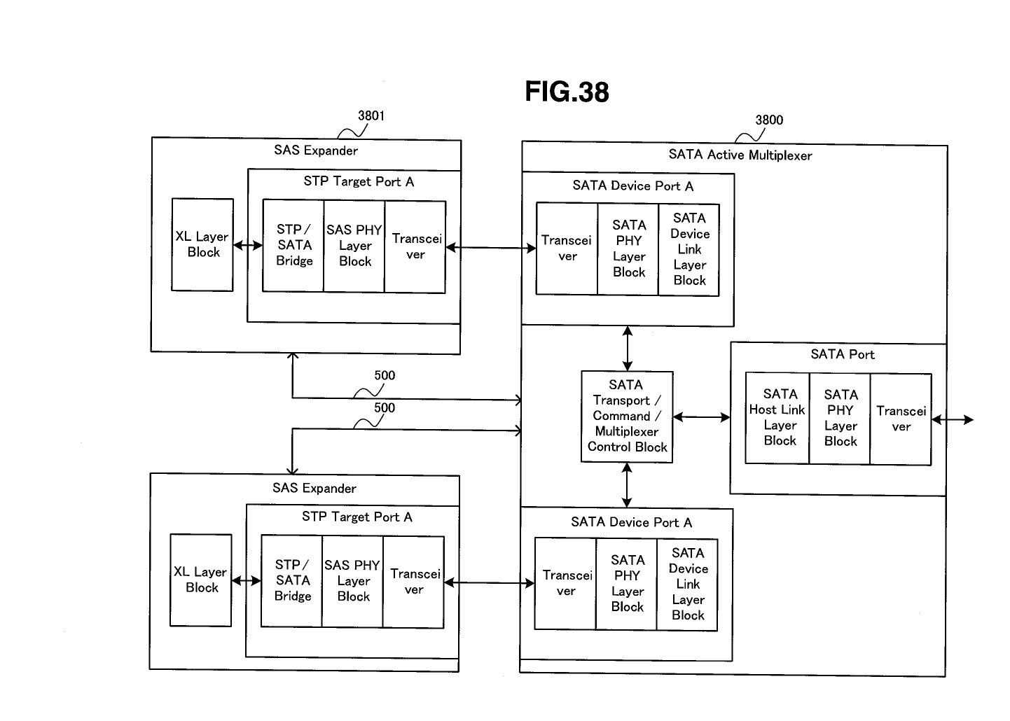

Furthermore, the first and second embodiments describe the case where communications between the SAS expander 130 and the SATA canister 200 are performed according to the SAS protocol. However, the invention is not limited to this example; and, for example, a SATA active multiplexer 3800 having the configuration shown in FIG. 38, instead of the STP active multiplexer 300 described above with reference to FIG. 2, may be provided in the SATA canister 200, and a SAS expander 3801 may be formed as shown in FIG. 38 to perform communications between the SATA active multiplexer 3800 and the SAS expander 3801 according to SATA protocol. This is the embodiment in which the same failure detection function as that of the STP active multiplexer 300 is realized by communicating the failure detection function and the connection management function described about the STP active multiplexer 300, using sideband signals.

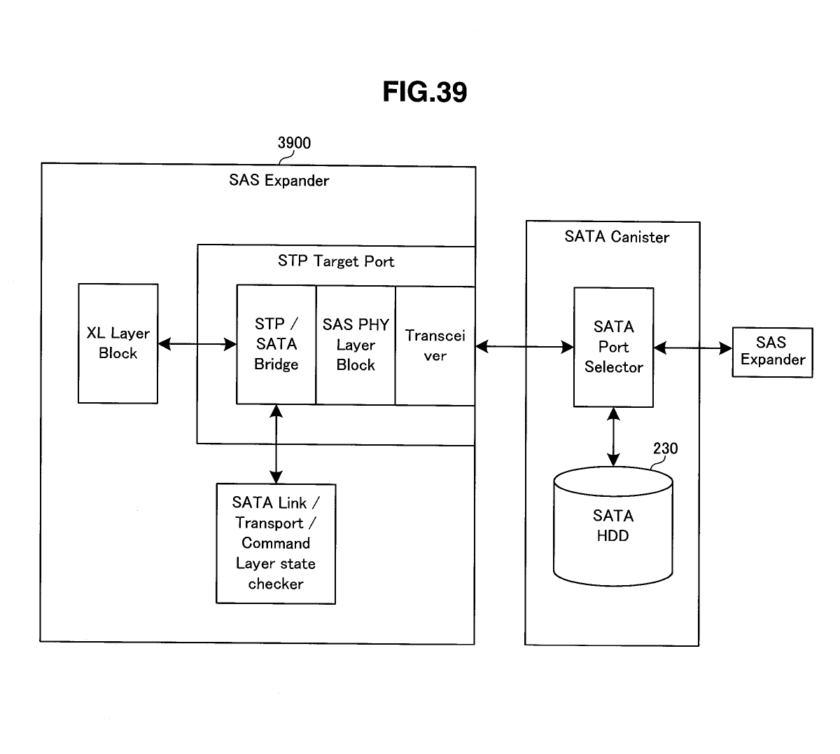

Incidentally, FIG. 39 shows an example of another configuration of the SAS expander 130. The same failure detection function as that of the STP active multiplexer 300 can be realized by performing the failure detection function and the connection management function in the SAS expander 130.

### INDUSTRIAL APPLICABILITY

The present invention can be widely used in storage apparatuses with various configurations mounted on a storage system with a large-scale back-end topology.

What is claimed is:

1. A storage apparatus comprising:
a storage device for storing data; and
a multiplexer for multiplexing a port for the storage device, the multiplexer being connected to one or more host controllers;
wherein the multiplexer judges whether a command sent from the host controller to the storage device is proper or not; and if the command is improper, the multiplexer discards the command without transferring it to the storage device and sends an error response to the host controller.

2. The storage apparatus according to claim 1, wherein the multiplexer monitors the state of link between the multiplexer and the host controller and the state of connection between the multiplexer and the host controller and also monitors the state of link between the multiplexer and the storage device, and then executes specified failure processing based on the monitoring results.

3. The storage apparatus according to claim 2, wherein when the multiplexer detects termination of the link with the host controller in the state where the connection between the host controller and the multiplexer is not established, the multiplexer does not execute the specified failure processing if the link remains terminated within a specified period of time; or the multiplexer executes the specified failure processing if the link remains terminated longer than the specified period of time.

4. The storage apparatus according to claim 2, wherein when the multiplexer detects termination of the link with the host controller in the state where the connection between the host controller and the multiplexer is established, the multiplexer resets the storage device, while it does not terminate the link with another host controller and notifies that other host controller that the storage device has been reset.

5. The storage apparatus according to claim 2, wherein when the link between the storage device and the multiplexer is terminated, the storage device resets a command from the host controller; and
wherein when the link between the multiplexer and the storage device is temporarily terminated and the multiplexer receives a new command from the host controller, the multiplexer notifies all the connected host controllers that the command has been reset.

6. The storage apparatus according to claim 1, wherein the multiplexer manages an address for each port connected to the host controller and terminates the connection with the host controller as necessary.

7. The storage apparatus according to claim 1, wherein the multiplexer includes a buffer for temporarily storing data sent from the host controller; and the multiplexer transfers the data sent from the host controller via the buffer to the storage device, while it terminates the connection with the host controller when the data is stored in the buffer.

8. A method for controlling a storage apparatus including a storage device for storing data, and a multiplexer for multiplexing a port for the storage device, the multiplexer being connected to one or more host controllers,
the method comprising:
a first step executed by the multiplexer of judging whether a command sent from the host controller to the storage device is proper or not; and
a second step executed by the multiplexer of discarding the command without transferring it to the storage device, and sending an error response from the multiplexer to the host controller if the command is improper.

9. The storage apparatus control method according to claim 8, wherein the multiplexer monitors the state of link between the multiplexer and the host controller and the state of connection between the multiplexer and the host controller and also monitors the state of link between the multiplexer and the storage device; and
the multiplexer executes specified failure processing based on the monitoring results.

10. The storage apparatus control method according to claim 9, wherein when the multiplexer detects termination of the link with the host controller in the state where the connection between the host controller and the multiplexer is not established, the multiplexer does not execute the specified failure processing if the link remains terminated within a specified period of time; or the multiplexer executes the specified failure processing if the link remains terminated longer than the specified period of time.

11. The storage apparatus control method according to claim 9, wherein when the multiplexer detects termination of the link with the host controller in the state where the connection between the host controller and the multiplexer is established, the multiplexer resets the storage device, while it does not terminate the link with another host controller and notifies that other host controller that the storage device has been reset.

12. The storage apparatus control method according to claim 9, wherein when the link between the storage device and the multiplexer is terminated, the storage device resets a command from the host controller; and
wherein when the link between the multiplexer and the storage device is temporarily terminated and the multiplexer receives a new command from the host controller, the multiplexer notifies all the connected host controllers that the command has been reset.

13. The storage apparatus control method according to claim 8, wherein the multiplexer manages an address for each port connected to the host controller and
the multiplexer terminates the connection with the host controller as necessary.

14. The storage apparatus control method according to claim 8, wherein the multiplexer includes a buffer for temporarily storing data sent from the host controller; and
the multiplexer transfers the data sent from the host controller via the buffer to the storage device, while it terminates the connection with the host controller when the data is stored in the buffer.
